(19) United States
(12) Patent Application Publication
(10) Pub. No.: US 2002/0120462 A1
(43) Pub. Date: Aug. 29, 2002

(54) Systems and methods for contact management and campaign management

(76) Inventor: Earl W. Good, Draper, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/900,694

(22) Filed: Jul. 6, 2001

Related U.S. Application Data
(60) Provisional application No. 60/216,441, filed on Jul. 6, 2000.
(60) Provisional application No. 60/275,187, filed on Mar. 12, 2001.

(51) Int. Cl. G06F 17/60

(52) U.S. Cl. 705/1

(57) ABSTRACT

Systems and methods for implementing contact management and campaign management by users with respect to contact groups. A data interface module is provided which includes a scheduler module, an info sheet module, a database maintenance module, and a search module. The present invention also provides an address bundling module, hierarchical information structure, an advanced messaging module, a worksheet module, and action button module. The present invention further provides for campaign management strategies including a campaign editor for creating campaigns, a campaign wizard for executing campaigns, and a campaign manager for separating contact groups based on predetermined criteria in order to perform further contact management or campaign management actions.

### CROSS-REFERENCE TO RELATED APPLICATIONS

This application claims the benefit of U.S. Provisional Application No. 60/216,441 filed Jul. 6, 2000 and entitled “Method and System for Database Management and Messaging,” which is incorporated herein by reference. This application also claims the benefit of U.S. Provisional Application No. 60/275/187 filed Mar. 12, 2001 and entitled “Database Management and Messaging Training,” which is incorporated herein by reference.

### REFERENCE TO A COMPUTER PROGRAM LISTING APPENDIX

This application includes 2 (two) identical compact discs: copy 1 and copy 2. The computer program listing appendix contained on each disc is hereby incorporated by reference. The files contained on the compact discs, their dates of creation, and their sizes in bytes are included in the attached appendix.

### BACKGROUND OF THE INVENTION

1. The Field of the Invention

The present invention relates to systems and methods for implementing marketing strategies. More particularly, the present invention relates to systems and methods for implementing contact management and campaign management. 2. Background and Related Art

Marketing strategies have existed for a number of years. Most computer-enhanced marketing strategies, however, simply automate existing marketing strategies. Computer-enhanced marketing strategies have allowed salespersons to store significant amounts of information about people or individuals. However, salespersons are unable to effectively use the stored information because they do not have tools permitting them to efficiently and effectively access and share the stored data.

In general, existing marketing systems store data that would assist salespersons in making sales, but cannot adequately present the data to the salesperson. Sometimes the right information is not presented. Often, too much information is presented and the sales-person must wade through it to obtain the needed information. In short, existing systems provide basic tools for allowing salespersons to access data and make sales, but they lack many advanced tools that would enhance the efficiency of the marketing process.

Another problem in the art is that most marketing methods do not translate well to other marketing situations. There exists a need in the art for a method which is flexible enough to handle simple marketing methods (e.g., telemarketers) as well as extremely complex and detailed marketing (e.g., stockbrokers).

Furthermore, many marketing strategies or methods require support staff. These staff members may require some of the same information that is required by a salesperson in order to fulfill their different tasks. At the same time, all of the people involved in a marketing strategy need to be able to communicate their actions to each other in an organized manner. This becomes especially important as the sales force becomes larger and extends beyond a single sales office.

Another problem with automated marketing methods is that they are generally targeted towards mass sales marketing (i.e., mass mailings, mass phone calls, etc.). However, these types of marketing methods do not translate well into conducting business on a one-to-one basis and vice versa. A good marketing technique needs both the ability to draw clients using mass marketing techniques and the ability to deal with clients on a group and individual basis.

One problem in marketing is handling the mobile nature of people. Some have multiple residences. Others spend significant amounts of time on extended vacations where they can be reached temporarily. Some families have children living away from home. Naturally, a sales representative trying to send a simple birthday card to a child of the family living away from home would not want to override the main contact address with that child's address. On the other hand, it is time consuming for sales representatives to hand-address envelopes and it detracts from their ability to pursue additional sales. Furthermore, some people are more easily reached by e-mail or by fax. Previous methods for overriding addresses have been inadequate in allowing sales representatives to indicate which phone number and/or addresses are active and which are not active at a given time, let alone indicating when or in what situations the should be used.

Additionally, because marketing methods may be addressed to a wide variety of situations, salespersons need flexibility in deciding what type of information is necessary and required for a particular situation. Many marketing methods do not allow salespersons to manipulate the database where customer information is stored.

Finally, in any given marketing or sales system, the salesperson is faced with similar types of responses or situations. For any particular situation, certain known actions are required to meet the requirements of that situation. It would be an advantage in the art if the salesperson could ensure that the same appropriate actions are taken in similar situations so that the client is effectively handled. Furthermore, it would be advantageous if a system were provided so that no actions required to handle a situation are forgotten, especially if multiple users may be handling a particular client and even more so if multiple users are handling multiple clients.

### SUMMARY OF THE INVENTION

These and other problems have been successfully overcome by the present invention, which is directed to systems and methods for implementing contact management and campaign management. Advantageously, the present invention provides improved systems and methods of presenting information that facilitates the ability of a user to implement contact management actions. The present invention provides functionality to assist in the performance of contact and/or campaign management actions. The systems and methods described herein, while often discussed with reference to either contact management or campaign management, are intended to apply to both contact management and campaign management.

These and other advantages are implemented through modules that enhance the ability of a user to implement contact management and/or campaign management on a contact group or a collection of contact groups. A contact group is defined as the basic unit for which contact management and campaign management are performed.

The ability of a user to access data about a contact group is an important aspect of contact management and campaign management. Access to this data is achieved through a data interface that allows access to the data in multiple ways, thus enhancing a salesperson or staffer's ability to access and use the information on a contact group that is stored in a database. The data interface includes, but is not limited to, a search module, a scheduler module, an info sheet module, and a database maintenance module. Each module of the data interface provides a user with access to the data of one or more contact groups. Often, the same data may be retrieved from each module, but each module may access or refer to the data in a different way. Each user of the various modules included in the data interface often has responsibilities that are different from other users of these modules. As a result, each module can be focused to the duties of a particular user, while providing an overview of the actions that are assigned to other users.

The search module tool allows the user to maneuver around the contact and/or campaign management system and search for a contact group or for information about the contact group or individuals in the contact group, while the info sheet module provides basic information on a particular contact group. The database maintenance module permits updating the data associated with or stored for an individual contact group or a collection of contact groups.

Advantageously, the contact and/or campaign management actions are context sensitive and can be viewed by a user from different perspectives. These perspectives provide a user with an immediate knowledge of which contact management actions have been performed and which contact management actions have not been performed for any particular contact group. This allows a user, for example, who may not have any prior knowledge of the contact group to efficiently address any concerns that may be raised by the contact group.

Within a contact group, an unlimited number of individuals, mailing addresses, email addresses, voice/telephone numbers, facsimile number, and the like can be store. The address module permits a user to associate individuals within a contact group with different addresses, including e-mail addresses, telephone numbers, and fax numbers. The messaging module allows a user to select a preferred channel of communication (printed letter, e-mail, or fax for example) for all messages sent to a contact group.

The user can also automate or initiate a sequence of contact management actions through use of an action module. The action module addresses situations where similar responses are required and ensures, in many cases, that these situations will be handled in a consistent manner. The action module also ensures that all of the contact management actions that should be performed for a given situation are performed. A worksheet module is also provided that allows the user to utilize the data stored for a contact group in a way that may be undefined. In other words, the worksheet module allows a user to effectively customize the stored data. In addition, the worksheet module is able to incorporate data that may not be stored in the database where the contact group data is maintained.

Campaign management is similar to contact management, but is directed to more than one contact group and the present invention also addresses those situations that are specific to campaigns. Thus, many of the systems and methods described herein apply to both campaign management and contact management. A user, for example, is able to create and/or modify campaigns. The user is also able to execute instances of a campaign. As each campaign is executed or performed, the user is able to monitor and govern the campaign. In one example, contact groups within a campaign are on tracks. The campaign management actions that are performed for any set or subset of contact groups within a campaign is dependent on the track of those contact groups.

These and other features and advantages of the present invention will be set forth in the description which follows, and in part will be more apparent from the detailed description of a preferred embodiment, and/or from the appended claims, or may be learned by actual practice of the invention.

### BRIEF DESCRIPTION OF THE DRAWINGS

In order that the manner in which the above-recited and other advantages and features of the invention are obtained may be understood, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram that represents an exemplary relationship among users and contact groups;

FIG. 3A illustrates an address module;

FIG. 3B is an exemplary screenshot of the address module;

FIG. 4 is a block diagram that represents an exemplary relationship among users and a data interface module;

FIG. 5 is an exemplary screenshot of a search module;

FIG. 6 is an exemplary screenshot of a scheduler module;

FIG. 7 is an exemplary screenshot of an info sheet module;

FIG. 8 is an exemplary screenshot of a data maintenance module;

FIG. 9 is another screenshot of the info sheet module, illustrating a tree or hierarchal history view;

FIG. 10 is a screenshot of the messaging module;

FIG. 11 illustrates an action module that includes a number of discrete functions;

FIG. 12 is a screenshot of a worksheet module;

FIG. 13A is a block diagram that represents an exemplary relationship between a user and a contact group in contact management;

FIG. 13B is a block diagram that represents an exemplary relationship between a user and multiple contact groups in campaign management;

FIG. 13C is a block diagram that represents an exemplary relationship among users and a campaign management data interface module;

FIG. 14 is a screenshot of a campaign editor;

FIG. 15A is a screenshot of a campaign wizard;

FIG. 15B is a screenshot of another feature of the campaign wizard;

FIG. 15C is a screenshot of yet another feature of the campaign wizard;

FIG. 15D is a screenshot of still another feature of the campaign wizard;

FIG. 16A is a screenshot of the campaign manager in contact group view; and

FIG. 16B is a screenshot of the campaign manager in campaign step view.

### DETAILED DESCRIPTION OF THE PREFERRED EMBODIMENTS

The present invention provides systems and methods for contact management and campaign management. Those who practice the systems and methods of contact management described herein and who perform contact management actions are referred to as “users.” As used herein, a “contact group” is a basic unit and comprises one or more individuals. A contact group further includes one or more individuals who are united in the achievement of common goals or who may be directly affected by the success or failure of achieving those goals. For example, if the user of the contact and/or campaign management systems and methods described herein is a financial advisor, the contact group's financial goals will be of interest to both the financial advisor and the individuals in the contact group.

A contact group is designed to fully recognize the diversity that exists in families and other social or business groups. For example, a family contact group may comprise a husband, a wife, and children. This family contact group may also contain siblings, grandparents, or other extended relatives. Alternatively, a family contact group could be two individuals of the same sex, whether or not related by kinship. A business contact group, in contrast, may be the owner of a sole proprietorship, the officers and several key employees of a corporation, the partners of a partnership, or the like. More generally, family contact groups contemplate any combination of individuals who are associated together, typically but not necessarily in a common dwelling, while business contact groups contemplate the other situations in which people associate with each other, for example, work, church, and other social institutions (e.g., country clubs). A user can create a contact group for as few as one individual and up to an unlimited number of individuals, e.g., a professional or organized group of people. Any existing contact group can be divided into two or more groups whenever appropriate, e.g., when a child matures and sets up his or her own household. Furthermore, individuals are not limited to membership in one contact group but may be part of two or more contact groups, e.g., a family group and a business group, among other possibilities.

For each contact group, a sales profile can be recorded, comprising the goals that the user can help it achieve and their preferred means of realization. This enables the user to periodically offer appropriate products and/or services that are of interest to the contact group. The sales profile of a particular contact group is often dependent on the user. For example, a financial adviser would record financial interests, investment types, and some specific investments.

Associations between individuals that are not reflected by their membership(s) in one or more contact groups can also be recorded and stored. For many users, the most prominent among such associations will be referrals, but associations also contemplate, for example, family relationships among individuals in business contact groups and vice versa. These associations identify other individuals to a user who may be in another individual's sphere of influence.

Contact management is defined herein as the systems and methods that a user applies in communicating and interacting with contact groups and/or in performing or implementing contact management actions. Contact management is also defined as the rules and procedures for collecting, recording, using, and safeguarding data about contact groups. The purpose of contact management is to achieve an objective or opportunity. That is, the user is attempting to accomplish an objective or take advantage of a future opportunity.

An objective is a desired result requiring one or more contact management actions to achieve. Exemplary objectives include, but are not limited to, generating goodwill, retaining clients, and creating business now and in the future. An opportunity is, for example, an event with the potential of generating revenue for the user, such as (for a user who is a financial adviser) that a contact group's CD will mature in 6 months and require appropriate reinvestment.

For each objective and/or opportunity, the relevant contact management actions to be taken are stored. A history is created as these actions are performed and marked done. Contact management actions include assignments, notes, letters, and the like. An assignment is a task that needs to be done by a particular user and that will appear on that particular user's scheduler (discussed below). A note indicates what has already taken place with regard to the contact management actions. After a contact management action is performed (a letter is sent, or an assignment is executed, for example), the contact management action is recorded in the history of the contact group. The user can define other contact management actions that she may use during contact management.

Environment

By way of example and not limitation, the present invention is described by making reference to figures illustrating the general computing environment in which the invention may be implemented, and to functional and flow diagrams that illustrate either the structure or processing flow of embodiments used to implement the system and method. The diagrams should not be construed as limiting of the present invention's scope, but as illustrating an example of a presently understood preferred embodiment of the invention.

The embodiments of the present invention may comprise a special purpose or general purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data that cause a general purpose computer, special purpose computer, or special purpose processing device to perform a certain function or group of functions.

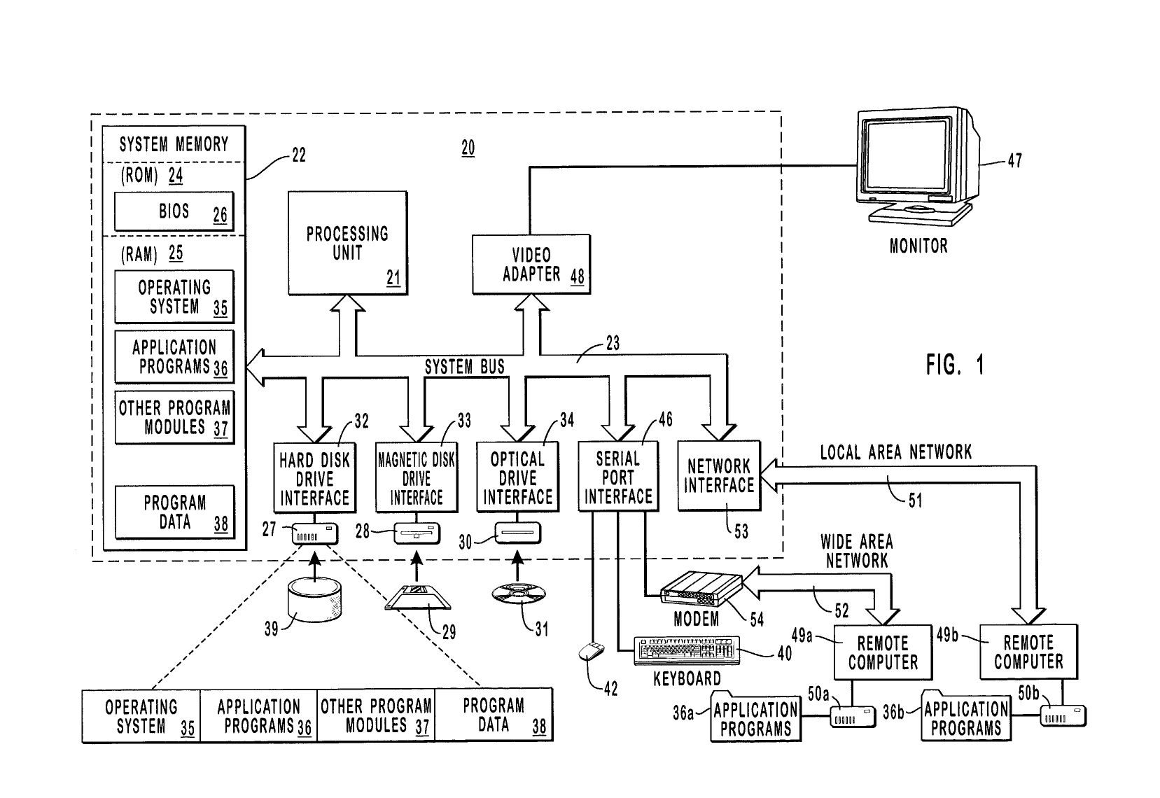

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc., that perform particular tasks or implement particular abstract data types. Computer-executable instructions, associated data structures, and program modules represent examples of the program code means for executing steps of the methods disclosed herein. The particular sequences of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer-readable media for storing data can be used, including magnetic cassettes, flash memory cards, digital video disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets, and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

Contact Management

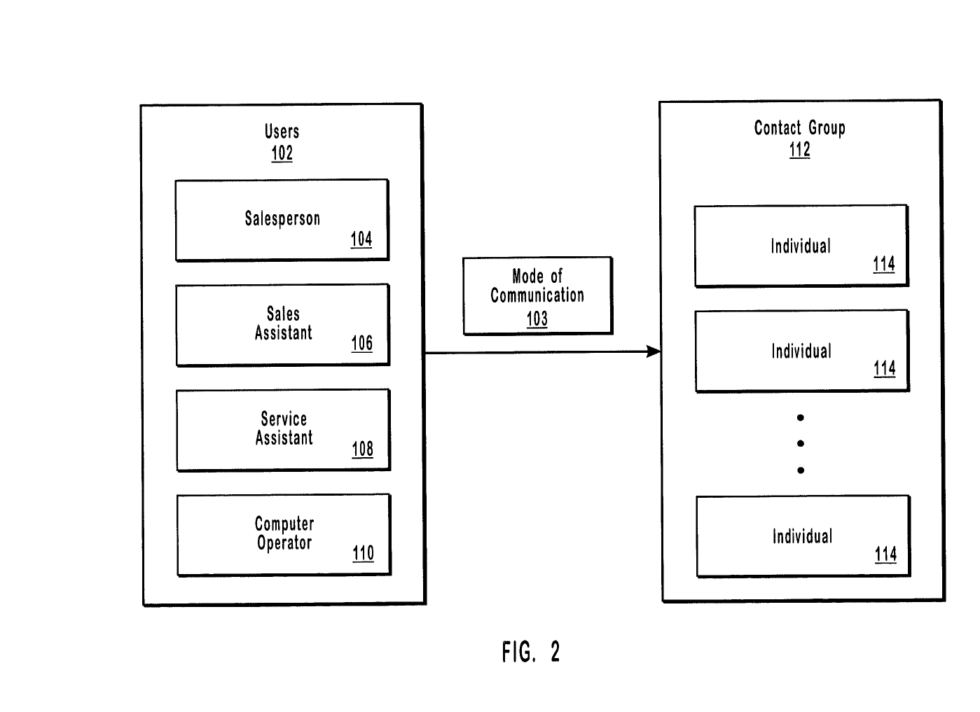

In one example, contact management is the series of contact management actions a user takes with respect to a contact group to achieve a particular purpose. In accordance with this aspect of the invention, there is shown in FIG. 2 a relationship between exemplary users 102 and a contact group 112. The users 102 will implement or perform contact management actions with respect to the contact group 112 through various modes of communication (103) such as personal conversations, telephone, fax, e-mail, letters, and the like.

As shown in FIG. 2, a contact group 112 comprises one or more individuals 114. The term contact group 112 may comprise contacts, prospects, and clients with whom user 102 is establishing or has established a relationship. Contacts are contact groups who have been or may be solicited by the user but have not yet responded. Clients and prospects are those contact groups who have responded to solicitations by the user, respectively those who have purchased or contracted for the user's products and/or services and those who have not yet done so.

Data for a contact group is preferably kept in a database system such as system memory 22 or storage device 96. Data that is generally kept about contact groups and individuals within contact groups is data that can be used to implement contact management, assists in the creation of goodwill, can be used to make a sale, or may prove that a conversation occurred for compliance or legal reasons. Examples of data that may be collected for a particular contact group or for individuals in a contact group includes, but is not limited to: data that applies to all individuals in the group, data about each individual, mailing addresses, phone and fax numbers, e-mail addresses, important dates, financial information, and the like.

The present invention provides distinct advantages to both the contact group 112 and the users 102. An address module, for example, is a feature that provides the user 102 with the flexibility to send communications to certain individuals within the contact group, to a temporary location, etc., without affecting other addresses. A context-sensitive history that can be displayed from different perspectives allows the user to examine data either organized by the user's particular objectives for the group or sorted by other characteristics of the history items, e.g., grouped by type of item (messages sent, notes added by the user, etc.), by date, etc.

A messaging module selects an optimal channel of communication between a users and a contact group. The messaging module is typically associated with a contact group and determines, for example, how a communication is preferably sent to a contact group. For example, the messaging module may indicate that a particular group prefers email while another contact group may prefer to receive their communications via facsimile. Thus, the same communication may be sent to different contact groups over different communication channels. The messaging module is usually not associated directly with individuals within a contact group.

Action modules to initiate a series of contact management actions. These are of two basic types: series of actions that the user applies to records in the database, taking effect immediately, and series of contact management actions that the user sets up to be applied to the contact group over time. Both types of series can be applied by a single action module. For example, when a prospect contact group purchases or contracts for one of the user's products or services and thus becomes a client, an action module designed for that situation can both change the contact group's status and also initiate an appropriate series of follow-up contacts and other actions. This insures that all of the necessary database and/or contact management actions are completed and that none of the contact management actions are skipped.

Further, a user can design and create worksheets that display information that is particularly applicable to a specific contact group. The worksheets are able to combine data that may already be present in the database with data that is not present in the database. The worksheets, in effect, enable the user to enhance contact management by customizing the data that can be associated with one or more contact groups. Each of these features and advantages will now be described in further detail.

Address Modules

The address module is useful because each contact group can potentially include an unlimited number of different individuals. Thus, an unlimited number of mailing addresses, email addresses, voice/telephone numbers, facsimile numbers, and the like can be stored and associated with a particular contact group. Each address module usually includes two individuals (addressees), one mailing address, one email address, one voice/telephone number, and one facsimile number (referred to generally as addresses). The specific addresses included in an address module can be selected in any combination from the addresses that are stored for the contact group and a given address can be included in more than one address module.

By default, the address module also includes title usage that assembles the names of the individual or individuals in the address module into conventional forms. This includes stringing an individual's title (Ms., Dr., Prof., etc.), first name, middle name and/or last name to produce the first line of the envelope address, and assembling the title and last name to be inserted after “Dear” at the beginning of a letter as a salutation. If there is an extension (M.D., Jr., etc.) it is added after a comma in the address line only. The address module correctly handles combingin two persons as individuals (Mr. Orville Wright and Mr. Wilbur Wright) or as a married couple (President & Mrs. John Adams) at the user's option, dropping “Dr.” when used with “M.D.” but not when used with “D.D.S.” and various combinations thereof. If the user chooses the option of using nicknames in the salutation, these are also correctly assembled. If the user desires to use other than the default conventional forms, the module permits storing any modification or replacement.

Each contact group has both a primary home address module and a primary business address module, one of which is designated as a default address module. Alternate address modules can be created and stored for the contact group, but the alternate address modules are only used in certain situations. For example, the alternate address modules can be specifically chosen by a user or an alternate address module can become the default address module during certain time periods. In addition, certain objectives, such as birthday procedures, can be set to use one of the alternate address modules.

Even though each contact group has a default address module, one advantage of address modules is that an alternative address module can be easily selected for the contact group. Another advantage of the address modules is that a contact management action can be directed to a particular individual instead of to the entire contact group. This is especially advantageous if the individual has a different address than other individuals in the contact group.

When performing a contact management action with respect to multiple groups, the user can use the default module of each group. If the contact management action is a letter, for example, the letter will be sent using the home address module of one contact group and to the business address module of another contact group. Alternatively, the user can override the default address module and select an alternative address module or simply select one or more addresses and one or more individuals within the contact group.

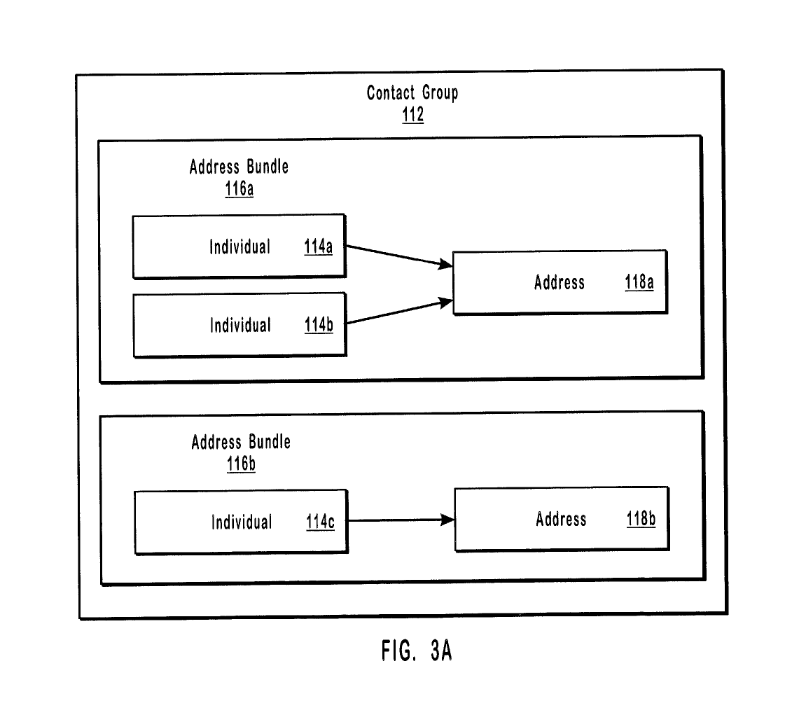

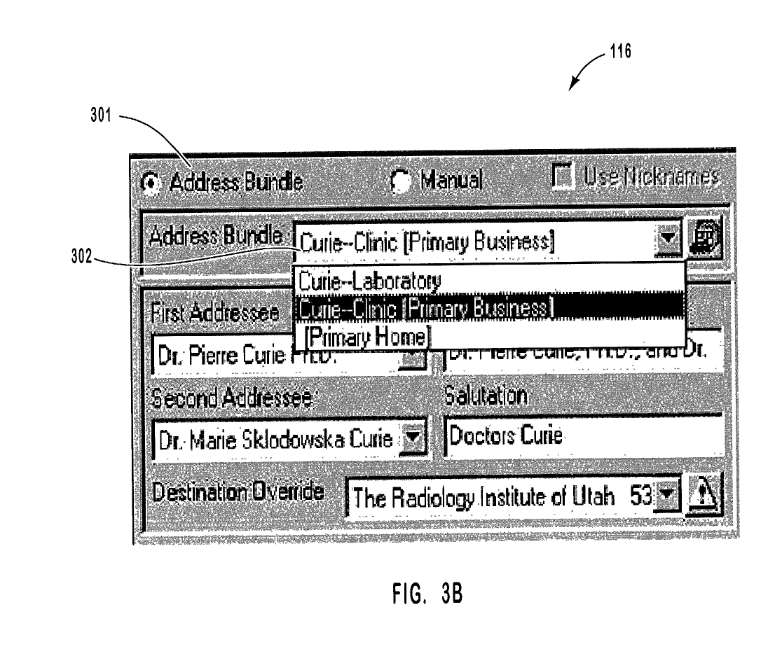

FIG. 3A illustrates a contact group 112 that has an address module 116A and an address module 116B. Each address module may include one or more addresses and one or more individuals who use the one or more addresses. In the preferred embodiment, each module includes two individuals, a mailing address, an e-mail address, a phone number, and a fax number, but this is exemplary, not limiting for the invention. In FIG. 3A, the individual 114A and the individual 114B correspond to or use the address 118A. In the address module 116B, the individual 114C uses the address 118B. These may, but need not, be different addresses. However, the individuals 114A, 114B, and 114C are all in the same contact group 112.

For example, assume that the individual 114C is a child who is attending college and is not living at home. The parents, represented by the individuals 114A and 114B, and the child (individual 114C) compose a contact group 112 and should appropriately be so maintained, so that information on the contact group is associated with all three individuals. However, the address module 116A is able to store an address 118A that is different from the address 118B stored in the address module 116B.

The address modules 116A and 116B are not limited to mailing addresses as previously described, but may also include telephone numbers, facsimile numbers, and/or e-mail addresses. Thus, when a contact management message is sent by, for example, email, the email address in the address module is used.

In one embodiment, address modules are implemented as shown in FIG. 3B. Field 301 allows the user 102 to select the default (preferred) address module for the contact group, any one of the other (alternate) address modules associated with the group, or manual addressing. FIG. 3B illustrates that the user 102 has selected an alternate address module. Within Field 302 of FIG. 3 are various addresses that have been recognized for this particular contact group. In particular, this contact group has a home address, a work address, and a laboratory address. The screenshot 116 illustrates that each address module will be referenced to a specific address and individuals within a contact group so that by selecting a particular address module, the user will send a correspondence to the appropriate individual(s) associated with that address module.

Data Interface

One aspect of the present invention is its implementation of certain rules of time management, i.e., delegation and organization. Delegation requires that certain duties be done by certain people and that duties be kept separate. Organization requires that each user organize her duties efficiently. Staff members are organized in a team-oriented environment wherein each team member is considered a user 102. Thus, a user 102 is an individual person working on behalf of the team.

Users can be subdivided into various types, tiers, or roles. For example, users can be divided into primary salespersons, secondary salespersons, assistants, and operators. The division of users may not be consistent across different users. Thus, the tiers or division of users described herein is exemplary and is intended to represent other potential divisions. The following example illustrates an exemplary division of users in a financial situation.

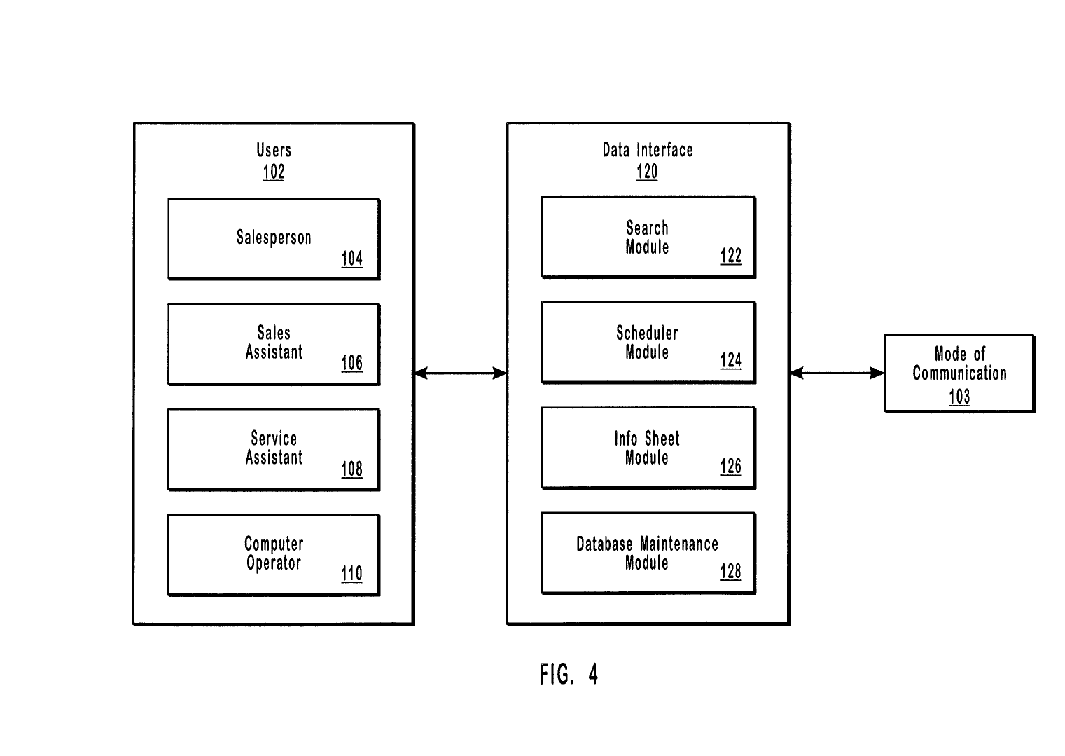

As shown in FIG. 2 and FIG. 4, in one embodiment intended for financial advisors a team is typically composed of four main user types: salespersons 104, sales assistants 106, service assistants 108, and computer operators 110. In one embodiment, individual users are in fact members of user groups, often called “staffgroups,” which actually occupy the positions enumerated in the preceding sentence, thus facilitating the scheduling of assignments for more than one individual user whenever appropriate. However, there are no limits on the number of users a team and/or a staffgroup may have and the provided examples of typical users are not to be considered limiting in any way.

A salesperson 104 is typically able to use any module of the present invention and the primary job of the salesperson 104 is to make sales. Any functions or responsibilities that are not within that category should be delegated to other users. For example, a salesperson 104 in the financial arena is often referred to as a registered representative (“RR”). Although the designation “RR” used in these exemplary illustrations is used only for appropriately licensed financial advisors in the securities industry, counterpart sales positions exist in many other arenas, often with their own technical terms (e.g., the distinction between “agent” and “broker” in the real estate industry).

The sales assistant 106 ensures that the salesperson 104 always has plenty of interested clients and prospects to talk to and see. This may include drafting or adapting contact management messages such as letters and scripts and developing lists from which to develop prospects. For larger offices, this position can be split into client sales assistant and prospect sales assistant. A client sales assistant's position may be focused entirely on maintaining contact and scheduling appointments with clients, while the prospect sales assistant focuses entirely on generating the prospects who will become new clients. This avoids stalling of productivity while creating new business.

The service assistant 108 duties involve responsibility for all service issues. The service assistant 108 manages the salesperson's calendar (i.e., serves as a gatekeeper), serves as host/hostess of the office, and answers the phone. Again, the title applied is often arbitrary and not necessarily related to the functions and responsibilities of the individual user, so that it may be changed according to various situations. For example, the title of “Service Manager” may be more useful when interacting with contact groups.

The computer operator 110 is responsible for maintaining the accuracy and security of the data obtained for contact groups and individuals, for the outflow of contact and campaign management messages, and for recording responses thereto.

As mentioned above, the salesperson 104 should delegate all non-sales functions to other users. Furthermore, certain preliminary steps that are essential to making sales can also be delegated to other users to make the process more efficient. For example, the salesperson 104 should delegate to the service assistant 108 all service problems and the duties of running the office. The salesperson 104 should delegate to the computer operator 110 the duties of correcting and completing data input and of protecting and safeguarding data and hardware systems. The salesperson 104 should delegate to the sales assistant 106 duties that ensure that the salesperson will always have plenty of people to talk to and see. Similarly, in order to maintain focus and momentum, the salesperson 104 should organize his own duties to group similar contact management actions into the same period of time.

The team structure may be implemented on both a microscopic and a macroscopic level. More particularly, users may be organized into one team or multiple teams. Furthermore, the above team structure allows a team to be easily transformed into a seminar team for organizing seminars. The salesperson would ordinarily be the seminar presenter. The sales assistant would normally be the seminar marketing director, the service assistant the seminar coordinator, and the computer operator the seminar communications assistant. However, as more seminars are scheduled and the number of clients grows, additional staff might over time be hired and fitted into the special seminar slots, thus allowing each individual to concentrate on either a seminar or non-seminar post. Throughout such a transition, organization and delegation insure that all necessary contact and campaign management actions are implemented or performed by the appropriate users. It is inefficient, for example, to have a salesperson 104 perform contact management actions that are more suitable for the computer operator 110.

The invention departs from other contact management systems, which do not emphasize this organizational structure. For example, on any given day, a user 102 must contact multiple contact groups and complete contact management actions or campaign management actions (discussed below). It would be difficult for the user 102 to have to find each contact group's history, find the next contact management action that needs to be done, implement the contact management action, and then repeat the process for each contact group. It would become particularly burdensome when considering that some campaigns can involve hundreds of contact groups.

Rather, it is beneficial for the user 102 to have an organized list of the contact management actions she is required to perform. Furthermore, the user is often familiar with the contact groups to be contacted, so that an inundation of unnecessary information would make the user's job more difficult. However, the user 102 should be able to access any and all information on a particular contact group whenever it becomes necessary.

FIG. 4 further illustrates the relationship between the users 102 and the data interface 120. The data interface 120 is a module that presents information in whatever way is most useful for a user, depending on the objectives the user is trying to accomplish. In other words, the data interface 120 enables a user to view information in more than one way. A brief description of the data interface 120 will first be given below, while a more detailed description of each part of the data interface follows.

One module of the data interface 120 is the scheduler module 124 (“the scheduler”). The scheduler 124 is a scheduling tool for the user. The scheduler 124 displays and helps the user to organize a schedule of her contact management and campaign management actions. Note that campaign management actions may relate to multiple contact groups. If the user 102 does not need additional information about a given contact group, the user can feasibly do that contact management action solely from the scheduler module 124.

The data interface 120 also provides an info sheet module 126. The info sheet module 126 allows the user to view information relating to one contact group. The user can do virtually all contact management actions from the info sheet and, most importantly, obtain information on a particular contact group.

Another feature of the data interface 120 is the database maintenance module 128 (“the DMM”). The DMM 128 assembles the most extensive database information for a particular contact group. The DMM 128 is intended for computer operators to help them maintain contact group information up to date.

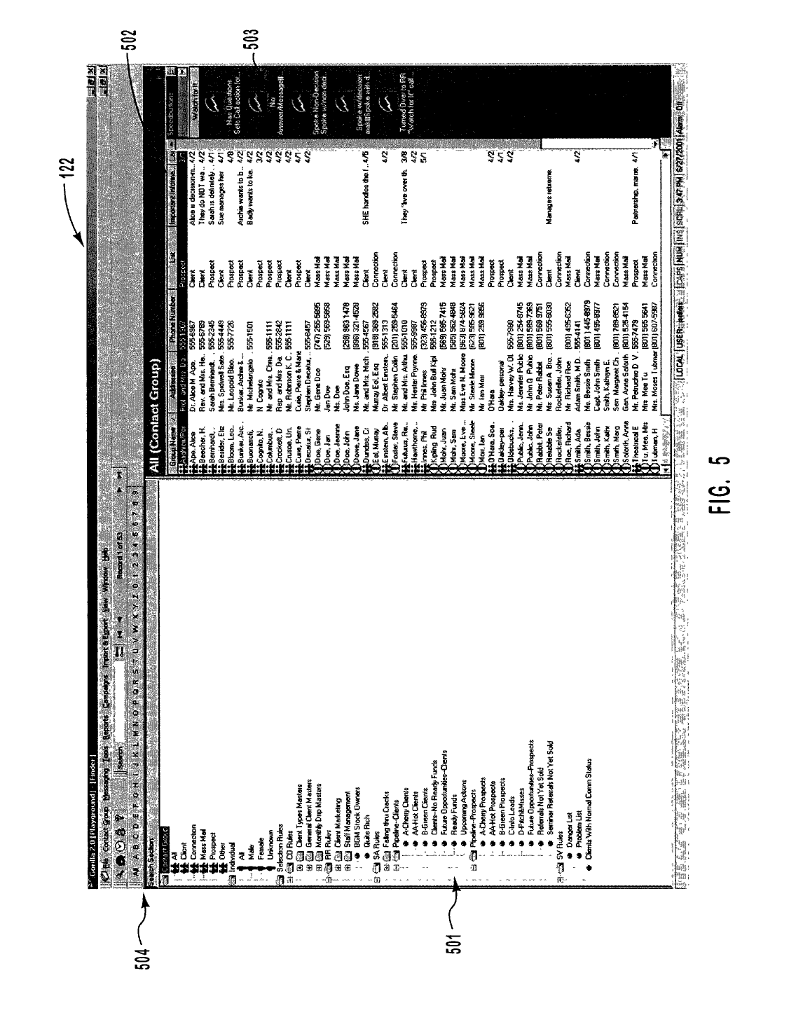

A search module 122 is also provided, as shown in FIGS. 4 and 5. The search module 122 helps a user locate a particular contact group or group of contact groups. As illustrated in FIG. 5, the user can locate a contact group using search tools such as hierarchy trees (Field 501), alphabetical sequence (Field 504), and the like. These search tools are not exclusive of each other and one or more may be used to find a particular contact group. Users are able to search by contact group and individual based on various criteria. The contact groups found according to the search criteria appear in Field 502, allowing the user to browse through and select from qualifying contact groups.

Field 501 provides a hierarchy tree search tool. In Field 501, the user 102 is able to locate contact groups according to the status of that particular group. For example, the search module 122 may assist a user 102 in finding all contact groups with corporate status or all contact groups who are hot prospects. The user would find the contact group in a corresponding folder labeled “corporate” or “hot prospects,” for example, in each case based on a “selection rule” using that characteristic as a criterion. Another example: A service assistant 108 may want to find a contact group that has a service problem. Thus, the section of the hierarchy tree designated especially for the service assistant 108 would contain a folder with contact groups that have been flagged as having a concern, i.e., “the problem client” folder. The service assistant 108 simply has to choose the problem client folder in the search module 122 to see a list of contact groups that are contained therein. The selection rules described here are exemplary, not limiting, and the user is provided the capability to create new selection rules. Additional selection rules, many of them more complex than those described in this paragraph, are provided in the preferred embodiment for the convenience of the user.

Not only is a user 102 able to find contact groups from the search module 122, but the user can also perform contact management actions from this screen. Field 503 of FIG. 5 contains space for displaying action buttons (discussed more fully below). Any changes to a contact group's record performed in the search module will reflect in the scheduler 124, info sheet 126, and DMM 128.

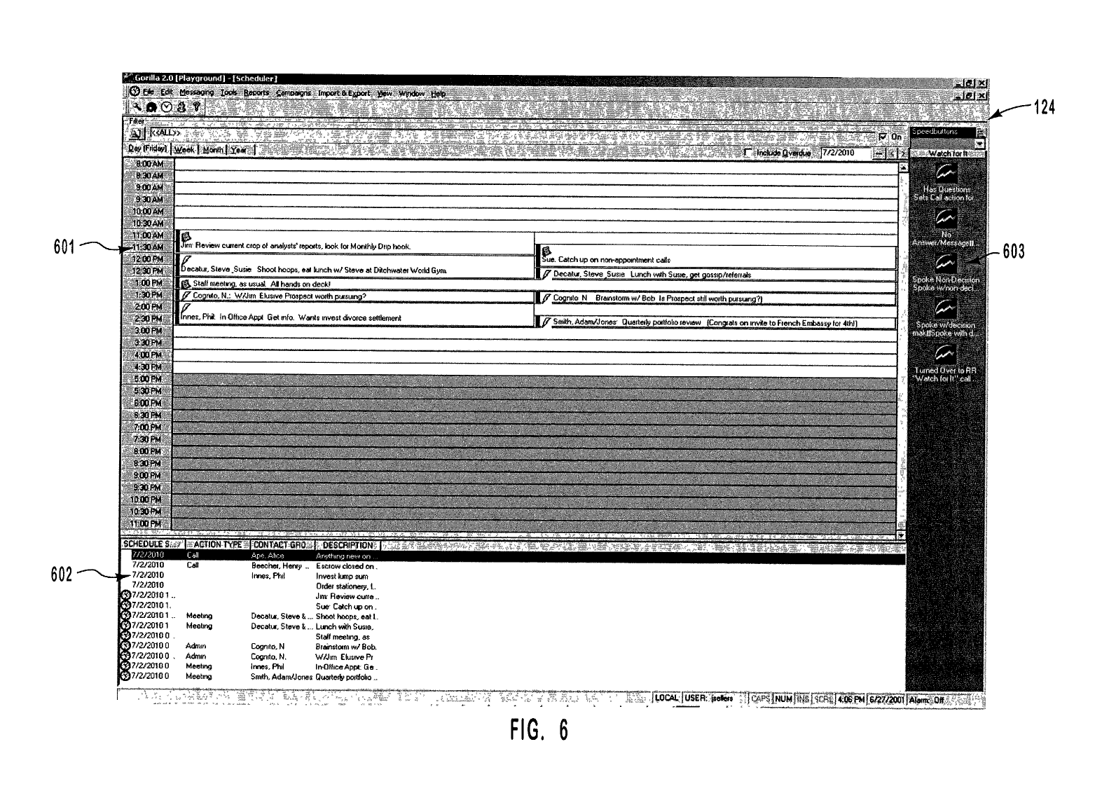

In more detail, the scheduler 124 is a summary of all the activity for a particular user 102—or, if desired, for more than one user. FIG. 6 is an exemplary screen shot of what a user 102 would see when she opens her scheduler 124, set to display only her own current assignments. As shown in FIG. 6, the scheduler 124 has various components or modules.

For example, a calendar module is shown in Field 601 of FIG. 6. The calendar displays assignments that the user 102 is required to do by day, week, month, or year as the user chooses. A planner is shown in Field 602 of FIG. 6. The planner organizes assignments by the date and shows the action type, associated contact group or campaign (if any), and description for each. The scheduler 124 contains all assignments including scheduled and unscheduled assignments. Scheduled assignments are those with a specific time designated, e.g., meetings with clients, and are displayed in both the calendar (Field 601) and the planner (Field 602). Unscheduled assignments have a date but no particular time designated, e.g., calling a client to try to set up a meeting and are shown only in the planner (Field 602). The scheduler 124 allows a user 102 to manage all her daily assignments in one screen. For example, from the scheduler 124, the user 102 can manage her campaigns, attend scheduled meetings and make scheduled phone calls, complete unscheduled ‘to-do’ assignments, etc.

In Field 603, the scheduler 124 provides an action button list. Action buttons address one aspect of the present invention that is concerned with efficiently implementing contact management strategies. In contact management, many situations are extremely similar, requiring the same response by the user. For example, when finding clients, many opportunities require the same or similar response. Thus, it would be advantageous for the user to be able to predetermine the appropriate response to a particular situation and then to easily implement this response. This is accomplished in the present instance through action button modules 132 Action buttons will be discussed in more detail below.

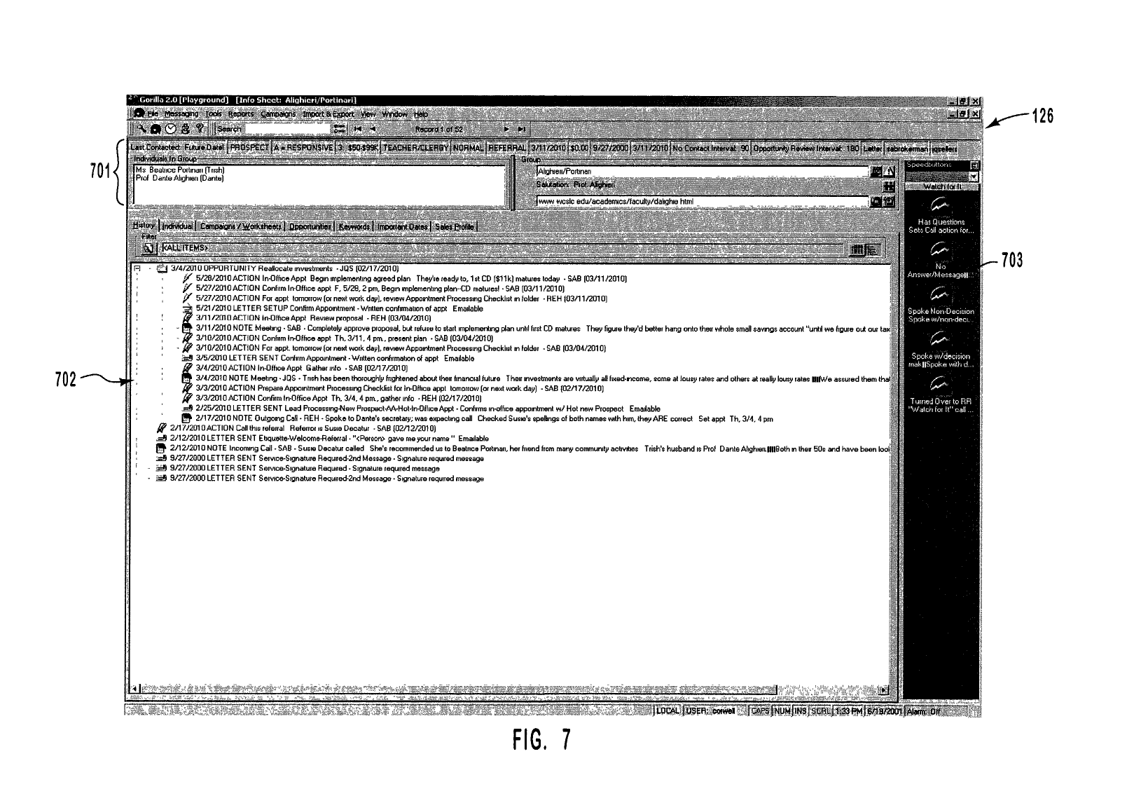

As illustrated in FIG. 7, which is a screenshot of an info sheet 126, the info sheet 126 helps manage the relationship between a user and a particular contact group by displaying information relating to that contact group. The info sheet 126 allows updates to the database regarding the displayed contact group to be performed. In Field 701, the info sheet 126 contains general identifying information about the contact group including names of individuals found within the contact group, the status of the contact group, financial information on the status group, and the like.

In Field 702, the info sheet 126 contains a record of the contact management actions that have been taken as well as future contact management actions to be taken in regard to the contact group. Field 702 also allows a user to look at information relevant to the contact group such as: status in any campaigns, contents of any worksheets (discussed more fully below), opportunities, keywords that classify this contact group, important dates, and sales profile information.

The info sheet 126 is the primary working screen for the relationship between a user and a particular contact group. The info sheet 126 facilitates record-keeping to help build and maintain the relationship. Furthermore, the info sheet 126 allows the user 102 to perform many contact management actions and to access other interfaces to perform those not directly possible from the info sheet 126. For this purpose, Field 703 provides action buttons, described below, to facilitate this process.

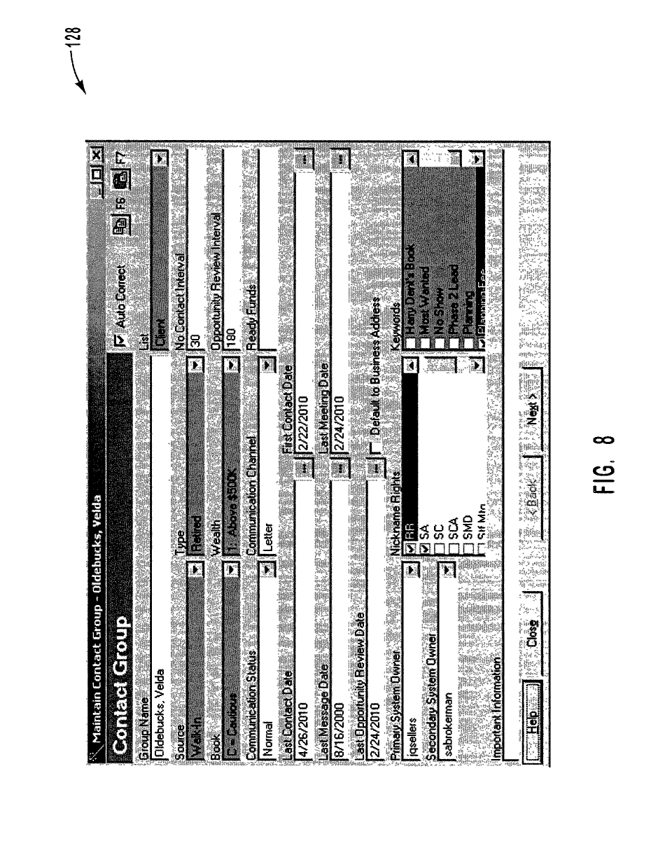

FIG. 8 illustrates the DMM 128. The DMM 128 contains detailed information for a particular contact group and/or individual. FIG. 8 illustrates one embodiment for the DMM 128. The DMM 128 contains detailed information on each contact group 112 such as the group name, status, last contact date, last message date, keywords, and the like. Besides providing this information with reference to the group as a whole, various “pages” of the DMM display and provide access to information on the individuals in the contact group, mailing addresses, phone numbers, e-mail addresses, important dates, accounts, various address module, etc.

The search module 122, the scheduler 124, the info sheet 126, and the DMM 128 provide different ways to view information, depending on the objective of the user. There is, of course, significant overlap of the information displayed in these various interfaces. Furthermore, while contact management actions can be taken in any one particular screen, the data for that contact group will always be updated so that the updates can be viewed in any screen in which it might be relevant.

Usually, login access is required to access all screens. Initial login takes place at the beginning of use of the system. However, access may be limited to certain areas within the system depending on the user.

Context Sensitive History Including a Tree View and a List View

For each objective or opportunity that the user is attempting to achieve, there will be a corresponding number of contact or campaign management actions. For example, the user 102 can view the history of the contact management actions taken with respect to each objective for a contact group in the info sheet 126. The history can be viewed in at least two ways.

In a tree view, the contact management actions are organized by their relationships to objectives and opportunities. In other words, the tree view is a hierarchal history view. That is, all of the contact management actions pertaining to a particular objective or opportunity are kept in the same folder. The display of each such folder can be collapsed to simply the objective or opportunity itself. The contact management actions that are displayed can be contact management actions that have already occurred and been handled or they can be contact management actions that will be performed in the future.

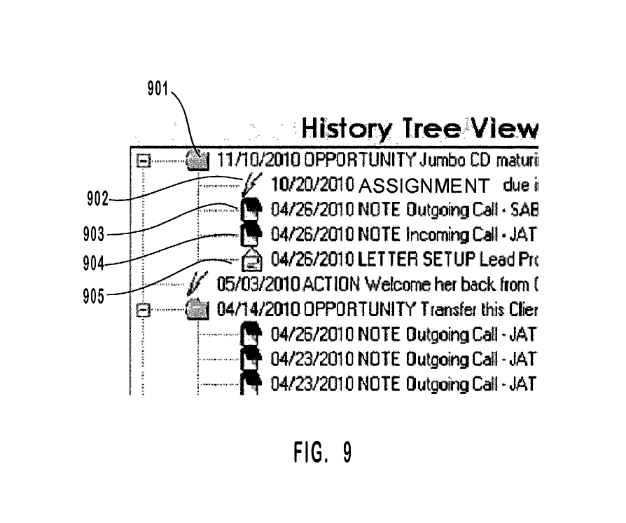

FIG. 9 shows an example of the history tree view embodiment. For example, in FIG. 9, folder 901 contains an opportunity (namely, a Jumbo CD will be maturing in the future). Within folder 901 are contact management actions regarding that opportunity. Assignment 902 shows that the opportunity is due in a certain period of time. Note 903 states that there was an outgoing call by a user. Note 904 states that there was an incoming call by an individual in the contact group. Letter setup 905 shows that a letter will be sent regarding the specific opportunity. The foregoing is an example of how contact management actions can be organized according to objective and is not meant to be limiting to the particular contact management actions discussed. As previously stated, some of these actions may be in the future. Thus, the letter setup 905 may only be scheduled.

The tree view allows the user to view the history of the contact group in an efficiently organized manner. The value of the tree view is that it organizes information into discrete portions based on the objective or opportunity so that it is more digestible for the user viewing the information. For example, if there is a service problem, all of the contact management actions involving the problem are kept in the same objective folder and the service assistant does not have to read the entire file to review them. Secondly, the user saves time by avoiding the need to describe the problem to subsequent users because both the objective and the related contact management actions will be easily identifiable by other users and available to them. This benefit becomes especially valuable when randomly assigned people will be viewing the information (e.g., a call center).

A list view shows contact management actions organized by one characteristic of those actions (by default, in date order). The list view thus provides alternative advantages to those provided by the tree view. For example, since it can easily be sorted by type of action, the list view is useful when a user desires to locate a call to a contact group. This is particularly useful when the user is uncertain of which opportunity or objective was involved. In both views, display of contact management actions is subject to various filters. One filter is actions that have been performed versus actions that have not been performed, so that either group can be shown alone in either view. However, only in the list view can both groups be shown sorted from each other.

Messaging Module

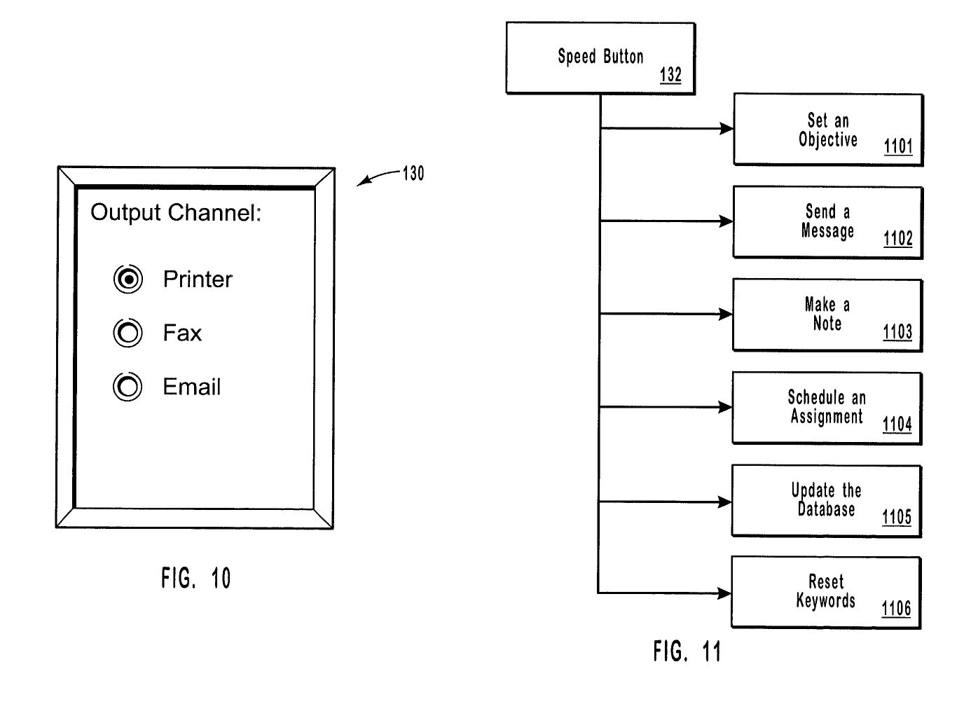

FIG. 10 illustrates a messaging module 130. Messaging is a way to achieve all of the objectives previously discussed: generate goodwill, retain clients, create business now and in the future, etc. The messaging module 130 includes the ability to select the primary mode of communication for sending messages to contact groups. Typical modes of communication include, but are not limited to, telephone, email, mail, facsimile, and the like.

The messaging module 130 allows a user 102 to select a preferred channel of communication for a particular contact group 112 as its default channel. Thereafter, unless the user determines otherwise, any messages will be sent via that default channel. Sending messages in this manner will add to client retention because (1) the client is more likely to receive a message via their preferred mode of communication; and perhaps (2) the client will be pleased that the user cared enough to remember their preferred mode.

Furthermore, the messaging module 130 enhances the power of a campaign (discussed more fully below). Generally, a campaign is a strategy marketing to more than one contact group. The campaign can be programmed so that whenever possible messages will be sent based on the default channel instead of through only one mode of communication, thereby enhancing the effectiveness of the campaign strategy. Additionally, the messaging module 130 can be used in conjunction with the address module. A new address module can be created specifically for use in a campaign, e.g., only the individual within a contact group who is about to turn 21 (or for users who are financial advisers, 59½); only the female or male of a couple; and so on.

Action Buttons

An action button is a user-definable series of one or more contact or campaign management actions, frequently coupled with database management actions. The action button module provides the user with the ability to create, edit, and delete action buttons, and to assemble groups of action buttons likely to be used for different results of the same process (e.g., accepting, rejecting, or postponing a solicitation). Action buttons implement contact management actions based on the idea that when an identical or similar problem arises, the user creates and uses a standard solution for that problem. For example, for a mechanic, a client's car safety inspection is a yearly occurrence and the user (mechanic) often employs the same response pattern for each contact group (i.e., making, confirming, and carrying out an appointment with the client, etc.). Selling new tires, on the other hand, is an irregular occurrence, but a similar response can still be employed by the user (i.e., billing, recording the warranty, etc.). However, these and other situations can be approached using action buttons because both occurrences require responses that involve a predictable series of contact management actions that should be performed as to each contact group in that situation.

Dealing with a service problem that will take more than 24 hours to resolve further illustrates the advantages and usefulness of action buttons. The service assistant, when presented with the problem, simply clicks an action button 132, which initiates the predetermined contact management actions toward resolving the client's concern. For example: the action button 132 sets up an objective to solve the problem, which will show up in the service assistant's scheduler until it is marked done. The same action button 132 also sets up a letter from the service assistant to the contact group that states she is responsible for solving the problem, promises to do so, and encloses business cards. Finally, the action button 132 sets up recurring assignment for her to call the contact group every three days saying the problem is being worked on until it is in fact resolved. A single action button implements the same pattern of contact management actions every time a similar problem recurs, without requiring the user to remember or work out the various contact management actions each time.

Action buttons provide other advantages as well. If an objective requires multiple contact management actions, a user can easily forget one, e.g., entering certain critical profiling information. Action buttons do not permit a user to forget any of the contact management actions and ensure that each response is handled accurately and, as long as the user consistently uses the action buttons, that search queries are much more accurate and reliable. Action buttons also provide the advantage of standardizing data entry.

FIG. 11 illustrates a number of exemplary contact management actions that an action button 132 can perform. One skilled in the art will recognize that action buttons 132 are not limited to these contact management actions and that other contact management actions may be implemented by an action button.

Set an objective (1101). When an action button sets an objective, the system creates an objective file folder. An objective file folder holds all of the history that pertains to that particular objective. Any other history items added by the same action button are assumed to pertain to that objective.

Set up a message (1102). A message is a communication sent to a contact group regarding the objective.

Add a note (1103). A note indicates a contact management action that has already occurred and may contain details about the contact management action. For example, the note may contain a summary of a telephone call.

Schedule an assignment (1104). For example, in the objective history, an assignment might appear which reminds the sales assistant to call the client to remind her of an appointment.

Update the database (1105). The database will be updated to reflect the contact management actions taken with respect to the objective.

Reset keywords (1106). Contact groups are often statused by reference to keywords, which can be used in searches.

When a contact management action requires the user to input data entry (e.g., to describe the objective, enter the text of a note, choose a message, revise a default date), the action button accommodates user input at appropriate places, and does not proceed to its next contact management action until the user has made or declined to make such input.

The following illustrates how an action button 132 can be used to reach a particular objective. When a user has scheduled an appointment with a contact group, the user selects an action button 132 named “AA Hot Out of Office.” ‘AA’ means that the contact group is a hot prospect. ‘Out of office’ means that the user has an appointment to meet with the contact group out of the office. By clicking the “AA Hot Out of Office” action button, the user initiates a series of automated contact management actions in the system. First, the system will set an objective for an out of office appointment. Second, the system then creates a note about the appointment. In this case, the note would indicate that the user made an appointment with the contact group. Third, the action button then sets an assignment for a sales assistant to call and confirm the appointment with the contact group. On the sales assistant's scheduler, an assignment would automatically appear to have the sales assistant call and confirm the appointment with the contact group. Fourth, the system sends a message/letter to the contact group confirming the appointment. Fifth, the system also may make a number of database changes including changing the contact group identification from a “mass mail” contact to a “new prospect.” Sixth, the system also records the first contact date which is the date the contact group became a prospect. Furthermore, the system modifies the keyword associated with the contact group to become “AA,” which statuses the contact group as a hot prospect. This series of transaction results in at least six contact management actions that normally would require manual input by the user 102. The action button 132 allows for all these contact management actions to be initiated and/or automatically completed with one click of a button and insures that none of the contact management actions are forgotten.

The data interface 120 provides a tracking tool for service assistants. In the search module 122, the service assistant can click on a folder called “problem list.” By doing so, the service assistant gets a list of every contact group with a current service problem, assuming that the service assistant (directly or through the computer operator) has used action buttons or otherwise chosen the action type “problem” for such assignments. When a user is in danger of losing a contact group, the service assistant clicks the “danger list” action button which adds a keyword “danger,” thus placing the contact group in the “danger list,” and also brings up an objective to be filled out, detailing the problem. The service assistant may have another action button to remove a contact group from the danger list, or just delete the keyword (e g., through the info sheet module 126). These are examples of contact/campaign management actions that can be performed with action buttons. However, these contact/campaign management actions can be performed without an action button.

Lead Processing: Lead processing involves the contact management actions of converting a prospect into a client. The key is to keep track of and classify all sales leads according to a standardized system based on objective criteria: degree of prospect interest, financial qualification—i.e., ability to afford the user's product(s) and/or service(s)—and readiness to act. Action buttons are ideal for automatically setting up the necessary contact management actions for contact groups once they are appropriately categorized by a user.

For example, hot prospects are the category with the highest priority and are handled first. These contact groups are very interested, financially qualified, and ready to start the sales process now,. either having approached the user or being willing to make an appointment. An action button labeled “AA hot” classifies the contact group as a hot prospect (by adding a keyword) and prompts the user to set an assignment for an appointment, note the conversation, set an assignment to confirm the appointment in writing, and set an assignment to confirm one day before the appointment by telephone. One skilled in the art will recognize that the user can similarly configure an action button to deal with other types of leads such as those leads that are less interested or not interested at all, as well as for many other recurring situations. The foregoing examples illustrate that action buttons would provide an advantage in all types of contact management situations.

Worksheet Module

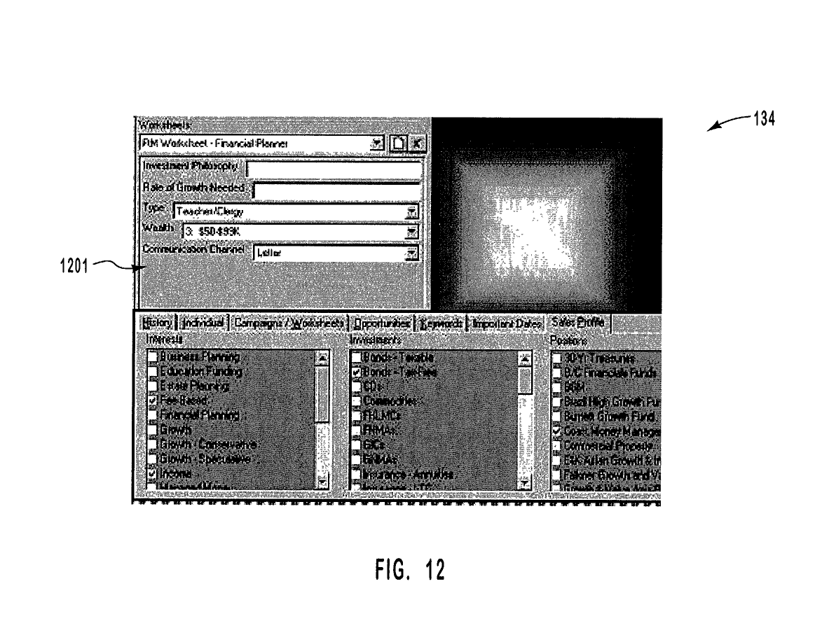

In accordance with a further aspect of the invention, there is shown in FIG. 12 a worksheet module 134. The worksheet module 134 is intended to make the database dynamic and useful to the user. When running a campaign or dealing with a particular issue in contact management, the user may have need for information that is not currently in the database. Furthermore, the user would like to have certain information readily on hand to be able to discuss intelligently with the contact group. The worksheet module 134 essentially allows users both to draw from and to create information for the database.

The worksheet module 134 allows the user to create data fields shown in Field 1201. Some data fields shown in Field 1201 are information that already exists in the database. The worksheet allows this data to be imported from the database into the worksheet, and displays a blank when that data is lacking. The user may also create data fields for information that is not currently in the database. Thus, while the user is dealing with a particular contact group, the user has the existing information readily on the worksheet and can fill in the other data fields as information is discovered.

The worksheet module 134 is also advantageous for campaign management. While campaign management will be described in more detail below, a campaign is generally targeted to more than one contact group to reach a specific objective. Through the worksheet module 134, the user has the ability to create a worksheet that would retrieve the required information from the database and/or provide fields for other required information in the same format for each contact group selected in the campaign. Furthermore, after a particular worksheet is created for a particular campaign, the user has the choice to use or not use the worksheet in other campaigns or to create a new one as the user desires.

The following example will illustrate the advantage of worksheets. In many financial planning situations, the user desires to conduct a periodic review of the client's accounts for the benefit of both the user and the client. The database may or may not contain all of the information that would be useful to produce a client review. So, the user is enabled through the worksheet module 134 to extract all relevant information from the database, such as the client's financial status and investment interests, and to create fields for other information, such as how often the client would like a periodic review, whether she wants a cup of coffee when she meets with the user, etc. If desired, some data fields can be created to be filled in after the user actually performs the review with the client.

The data collected from the worksheet module 134 will be stored on the database. After a worksheet is created, a user 102 can access any worksheet that has been used for a particular contact group from that contact group's info sheet 126. Furthermore, the information from the worksheet will be searchable by database search engines. Worksheets can also be reset when executing a campaign such that the information can be collected for a new situation.

Campaign Management

Another aspect of the present invention is directed to campaign management. Campaign management is generally defined as a series of actions directed toward multiple contact groups. Campaign management is, in essence, a superstructure of contact management. Thus, one advantage of the campaign management element in the invention is that it allows the user to implement the novel features discussed in reference to contact management in the context of campaign management. Such features include, but are not limited to, address modules for handling multiple addresses, hierarchical information structure, messaging for sending correspondence to a preferred address, worksheets for extracting and obtaining data for a contact group, and action buttons for initiating repetitive contact management actions. Campaign management also includes the ability to perform campaign management actions that allow mass mailings to be sent out in waves rather than in a single instance. These mass mail actions can occur at regular intervals. Contact groups that are brought into a campaign can be separated into separate tracks within the campaign.

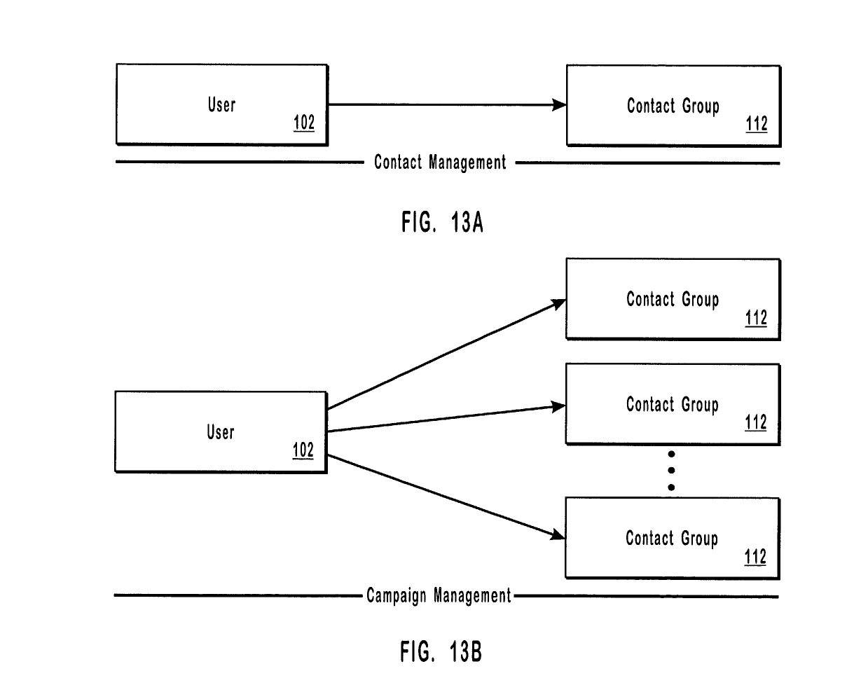

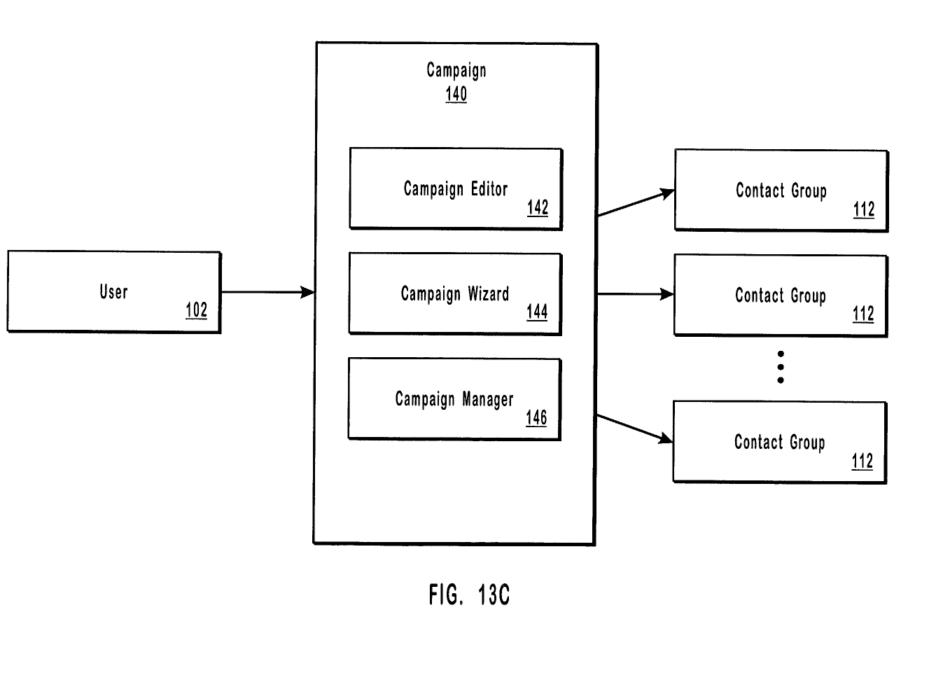

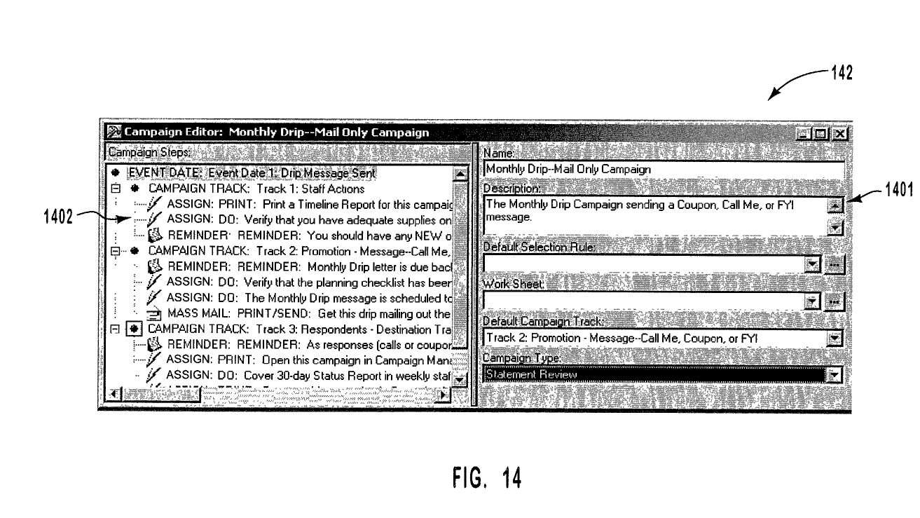

There is shown in FIG. 13A and 13B possible relationships between a user 102 and contact groups 112. As shown in FIG. 13A, contact management is executed with respect to one contact group, while campaign management contemplates targeting multiple (i.e., two or more) contact groups through use of a campaign. A campaign is a series of campaign management actions taken in a given situation that is intended to produce or produces predictable results. Campaigns can also be useful to filter through initial prospects to identify those showing interest in a particular product.

A campaign editor module allows the user to design a campaign suitable for a specific objective. After the campaign is designed, a campaign wizard module allows the user to select, e.g., the dates on which to run a particular instance of the campaign. Preferably, a campaign manager module provides the user a logical data interface for viewing the campaign and the contact groups selected for the campaign. Alternatively, the user has the option of obtaining campaigns that have already been designed and tested. A user, for example, can access a catalog of campaigns over a network such as the Internet and download those campaigns that are of interest to the user. These predesigned campaigns, as well as those designed by the user, are often referred to as campaign masters.

A campaign 140 may have a specific campaign “style,” i.e., the outgoing channel(s) of communication used, such as mail only, a combination of mail and telephone contact, fax, email, etc. Moreover, a message may provide various style of response, e.g., a response coupon, a request to call the user, a questionnaire, etc.

Campaign Editor Module

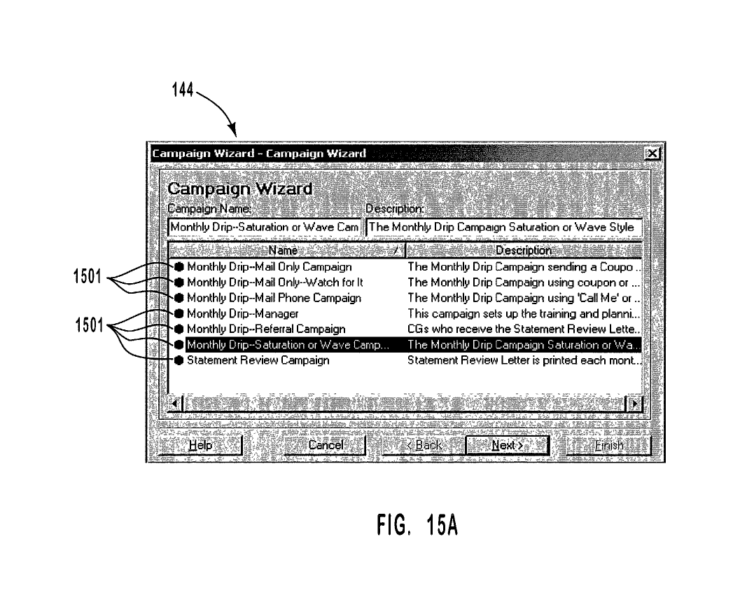

Referring to FIGS. 31C and FIG. 14. FIG. 14 shows a screenshot of an exemplary embodiment of the campaign editor module 142. The campaign editor module 142 acts as an interface to assist the user 102 in creating campaigns 140. The campaign editor module 142 assists the user in creating campaign masters. A campaign master is similar to a template, that is, it is a general campaign designed to cover all requirements for a particular objective, including a relative timeline, but without specific dates or the names of specific users.

FIG. 14 shows an embodiment of a campaign editor module 142. Field 1401 shows basic details regarding the campaign master. Its name and a brief description of the campaign is given. Field 1402 shows that the campaign has been defined comprising various campaign tracks, similar to bins into which the user sorts contact groups according to their progress through the stages of the campaign, level of interest, etc. (Campaign tracks will be discussed further below.) The user defines certain campaign management actions to implement for each track. For example, campaign track 1 contains various campaign management actions, such as objective, reminders, and assignments, that prepare the users to implement the campaign. Similar campaign management actions also define campaign track 2 and higher-numbered tracks. As can be seen through FIG. 14, campaign tracks are similar to action buttons in that they are lists of actions defined once and used repeatedly.

Campaign Wizard Module

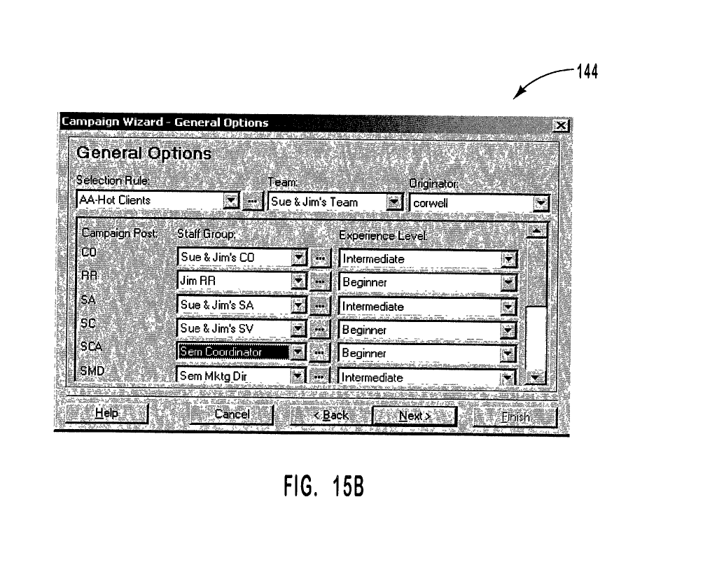

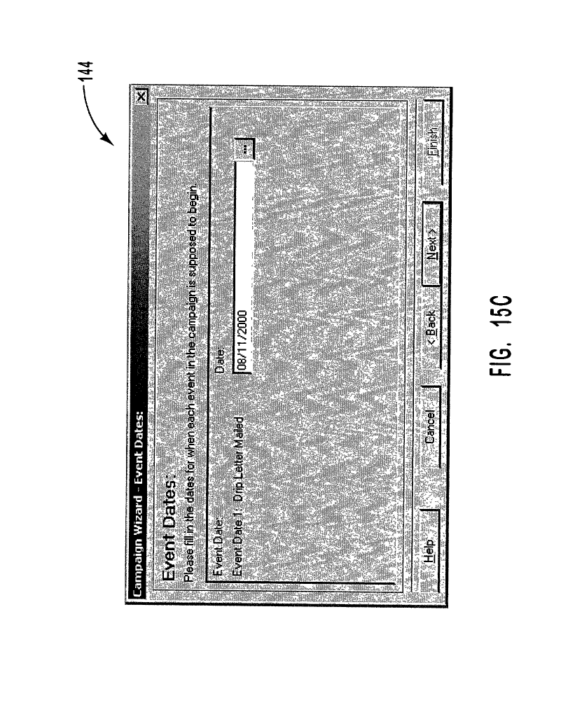

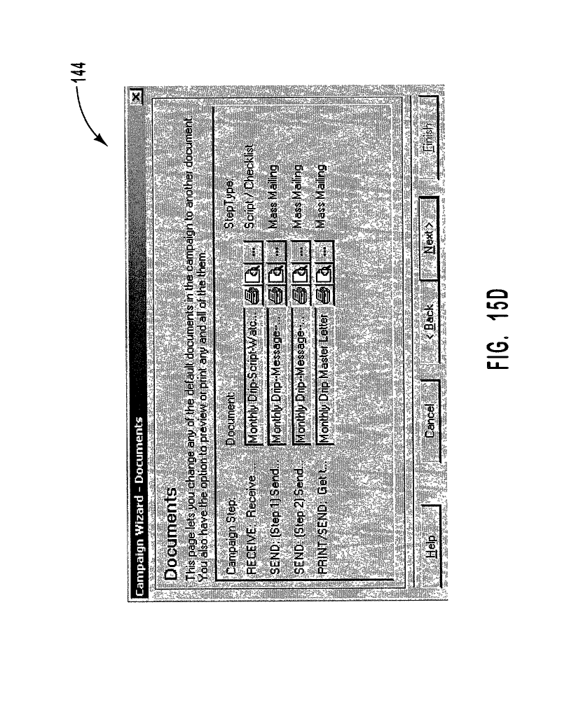

Preferably, when the user 102 runs a campaign, a campaign wizard module 144 is provided as shown in FIG. 15A such that the user can select, from among various available campaign masters 1501, the one that is appropriate for the user's current objective. After choosing a campaign master, the user employs the campaign wizard to target a definable collection of contact groups; assign users and their experience levels to the campaign 140, as shown in FIG. 15B; choose a particular date to start the campaign and create a schedule that works for the team, as shown in FIG. 15C; and to select, change, and/or preview the documents are required for the campaign, as shown in FIG. 15D.

Making such choices creates a “campaign instance.” The reason for this distinction is that the user 102 can have several campaign instances based on the same campaign master running at the same time (and/or several campaign instances based on different campaigns running at the same time). For example, the user 102 may have the March 12ₜₕ 401k instance and the March 20ₜₕ 401k instance both running on overlapping dates at different stages of progress.

Campaign Manager Module

A campaign is executed from the campaign manager module 146. A campaign manager module 146 is an interface that allows a user 102 to view and implement the campaign management actions required for a particular campaign. In this aspect, the campaign manager is much like the scheduler and info sheet modules described for contact management. The campaign manager module 146 can be illustrated by a particular campaign instance.

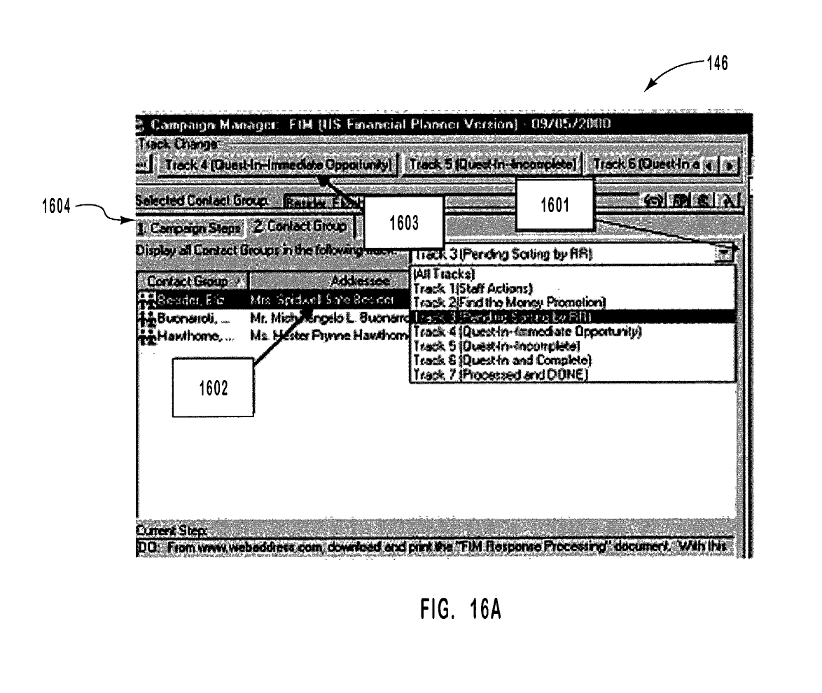

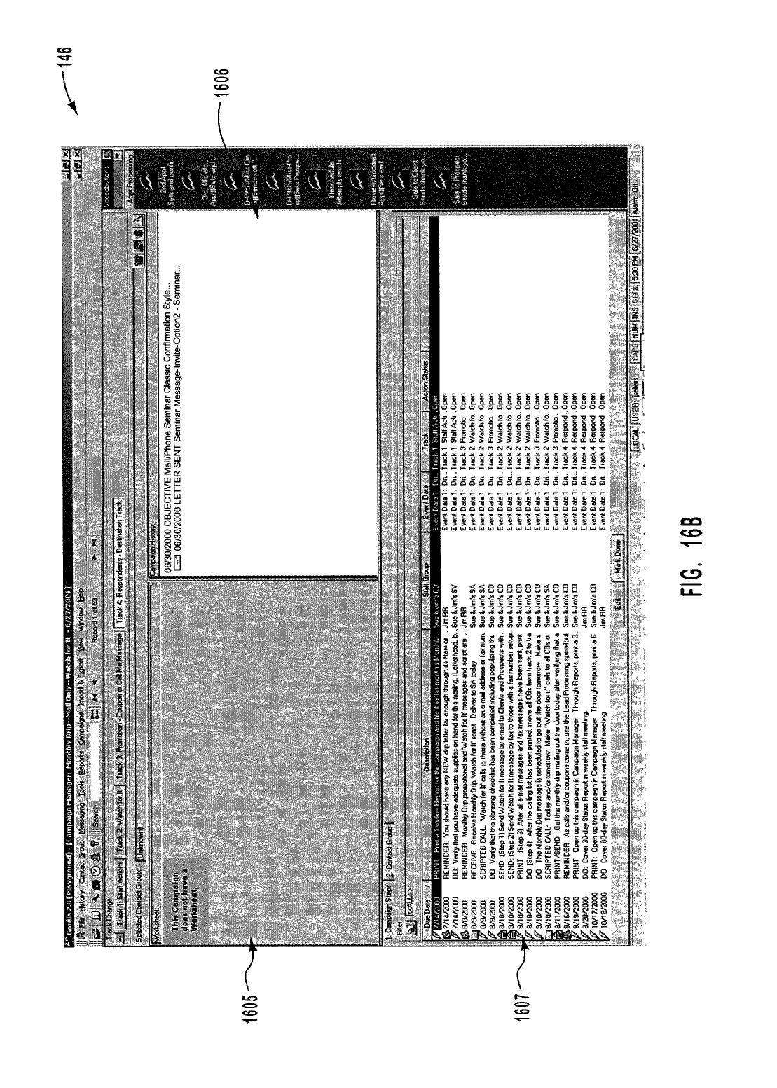

FIG. 16A shows one embodiment of the campaign manager module 146. Preferably, the user will be able to view the campaign in at least two views: a campaign management action view (or campaign steps view) and a contact group view. The Field 1604 of FIG. 16A shows that the user has selected the contact group view. In Field 1601, the user can select a particular track pertaining to a specific campaign and view all of the contact groups in that track. The contact groups in that track will appear in Field 1602. Field 1603 of FIG. 16A shows the predetermined campaign tracks which allow the user to easily select and categorize the contact groups as she interacts with them.

Secondly, the campaign manager module 146 can view the campaign according to campaign management actions (or campaign steps) as shown in FIG. 16B. In the campaign management actions view, the campaign history is available to the user as shown in Field 1606. Also, any worksheet associated with the particular campaign instance will be displayed in Field 1605, with the data displayed for the contact group selected in Field 1602 (see FIG. 16A). Further, in Field 1607, the campaign management action view shows, in chronological order, the campaign management actions, the due date by which they should be done, the user who is in charge of completing the campaign management action, and other information pertinent to the campaign. These fields are exemplary of an embodiment of the campaign manager and are not to be construed as limiting the present invention.

The following illustration on campaign tracks may prove useful: A user decides to use a campaign 140 to promote a new product and mails out seminar invitations to multiple contact groups. At this stage, all the contact groups are initially grouped in the “promotion track.” Some contact groups will respond in the negative and will be grouped in the “can't come” track. Some contact groups may respond positively and indicate that they will attend. These contact groups are put in the “will come” track. The “will come” track selection has been configured to automatically send the contact group a confirmation letter and automatically schedule the contact group for the seminar. Furthermore, the “will come” track may also automatically send an assignment to a user to call the contact group one day before the seminar. This assignment will automatically show up on the user's scheduler. Once the contact groups are separated between the “can't come” track and the “will come” track, the contact groups may be further separated into more tracks. For example, after the seminar is held, the “will come” contact groups can be separated into a “did show” track and a “no show” track. Appropriate campaign management actions can be taken with respect to each track.

A campaign management action is similar to a contact management action. Therefore, a campaign management action may be setting an objective, sending a message, making a note, scheduling an assignment, updating the database, or resetting keywords. Certain campaign tracks require that an assignment be sent to a team member to accomplish a particular task. For example, when an individual responds to the invitation, an assignment is sent to the sales assistant to send a confirmation letter and will be displayed on the sales assistant's scheduler. Another campaign management action may include the user 102 filling out certain forms, whether electronic or hardcopy, in order to complete a campaign management action.

A campaign message is a letter or communication sent to one or more contact groups during response processing or the promotion phase of the campaign. A campaign script is the user's side of a model dialog, usually with branching paths depending on the contact group's responses, that a user can reference when executing the campaign. For example, 1 or 2 days before a seminar is to be given, the sales assistant 106 will receive an assignment to call contact groups who have confirmed to remind them of the seminar, preferably using the campaign script.

A campaign checklist may be provided at various intervals of the campaign to assist the team members in ensuring that all campaign management actions are being completed in a timely manner. For example, in a seminar campaign there is usually a post-seminar processing checklist that walks the computer operator through the process to make sure it is done accurately and completely every time.

Preferably, users will participate in a planning phase in the campaign. Most of the planning occurs in a planning meeting. After all team members learn to run the campaign or process responses, the computer operator 110 receives an assignment to print a timeline for the campaign. The timeline assigns campaign management actions to each team member, such campaign management actions to be done by a particular date. This timeline is the key planning document. It gives the sequence of campaign management actions required to complete the desired result.

Shortly after the campaign 140 is activated, it generates a campaign management action for the computer operator 110 to print a planning meeting agenda. On the agenda are campaign management actions the team should go through to plan the campaign. Among these campaign management actions are: fix the timeline according to particular needs, select checklists, location of seminar, etc.

One will recognize the similarities between contact management and campaign management in that both will produce predictable results. Thus, it follows that action buttons work well in both environments. For example, suppose a contact responds to a coupon received during a campaign indicating interest in hearing periodically about the Asian market. The user 102 could click an action button 132 perhaps entitled “Asian Market Interest.” This action button 132 would initiate a letter to the contact group 112 thanking the individual for indicating her interest in the Asian Market. It may also put the contact group 112 on a mailing list for periodic mailings regarding the Asian Market. Further, the action button 132 would change the contact group's profile data from contact to prospective client. Moreover, a campaign can be so constructed that when contact groups are moved from one campaign to another, the same action button can automatically be applied to each contact group so moved. This “Asian Market Interest” action button thus would perform contact management actions on several contact groups as a result of a campaign management action.

One advantage of campaign management is that while a campaign 140 is run, some information from the campaign appears on the contact group' info sheet 126. When the user 102 opens the campaign tab in the info sheet 126, the user can see which track of what campaign the contact group is in, if any, and can easily retrack a group by clicking on one of the track buttons displayed.

A final note should be said about contact management versus campaign management. Some of the actions for both contact management and campaign management are similar. That is because the basic premise for campaign management is that campaign management actions are being done to multiple contact groups while in contact management, contact management actions are being done to a single contact group. Thus, it is entirely feasible that the same action would be done to one contact group that can be done to many contact groups. The simple distinction is this: when the user is applying an action to one contact group, it is contact management. When the user is performing an action to multiple contact groups, the user is utilizing campaign management. It is possible, while executing a campaign, for a user to perform campaign management on a contact group and then to subsequently perform contact management actions on that same contact group. That is why certain modules of contact management and campaign management (i.e., action buttons, worksheets, etc.) work so well in either environment and serve to complement each other, thereby making both contact management and campaign management more efficient and productive.

Another advantage of campaign management, which is essentially an extension of contact management, is that a consolidated view of the contact groups in a particular campaign as well as associated data is available to the users. This enables the users to be reactive to the contact groups as well as to individuals in the various contact groups. For example, assume that, in a campaign, a user places a call to a contact group or to an individual in order to sell a product of a company to the contact group. The contact group may reject the offer. In addition, the contact group may request that certain changes be made to the account of the contact group. The present invention provides the ability to implement the change to the contact group's account without affecting the data that is specific to the campaign.

One of the difficulties that is overcome by the present invention is permitting the user to be informed about the various contact and/or campaign management actions that are being performed. For example, when a contact group initiates a management act (by calling in response to a promotional letter, for example), it was previously difficult for the user to determine of identify the promotional letter to which the contact group refers. In the systems described herein, the user is able to quickly use the info sheet to jump to the campaign manager such that the user is informed about the interest of the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Volume in drive B is 010706_1113
Volume Serial Number is 67AC-0666
Directory of E:\

| | | |
|---|---|---|
| ACCOUN˜5 | <DIR> | 07-06-01 11:13a Account Group |
| ADDFOR˜7 | <DIR> | 07-06-01 11:13a Add Forms |
| B2 | VBP | 16,404 07-05-01 6:19p B2.vbp |
| B2 | VBW | 15,444 07-05-01 6:07p B2.vbw |
| B2EXP˜14 MDB | 1,314,816 07-05-01 5:38p | B2ExportHelper.mdb |
| B2IMPORT MDB | 530,432 03-07-01 11:25a | B2import.mdb |
| BGMCON˜9 | <DIR> | 07-06-01 11:13a BGMControls |
| BGM_D˜11 | <DIR> | 07-06-01 11:13a BGM_DBEngine21 |
| CAMPA˜13 | <DIR> | 07-06-01 11:13a Campaigns |
| CONTA˜15 | <DIR> | 07-06-01 11:13a Contact Mgmt Process |
| CONTA˜17 | <DIR> | 07-06-01 11:13a Contact Group |
| DATABASE | <DIR> | 07-06-01 11:13a Database |
| DATAE˜21 | <DIR> | 07-06-01 11:13a DataEntryWizard |
| DEVEL˜23 | <DIR> | 07-06-01 11:13a Development Docs |
| DIALER | <DIR> | 07-06-01 11:13a Dialer |
| DOWNL˜27 | <DIR> | 07-06-01 11:13a DownlinePurge |
| FINDER | <DIR> | 07-06-01 11:13a Finder |
| FRMABOUT FRM | 13,737 07-05-01 6:19p | frmAbout.frm |
| FRMABOUT FRX | 1,261,554 03-07-01 11:25a | frmAbout.frx |
| FRMLOGIN FRM | 21,831 07-05-01 6:19p | frmLogin.frm |
| FRMLOGIN FRX | 1,260,156 03-07-01 11:25a | frmLogin.frx |
| FRMTRA˜FRM | 4,823 07-05-01 6:19p | frmTrackerPath.frm |
| FRMTR˜50 FRX | 1,660 03-19-01 5:02p | frmTrackerPath.frx |
| GOR2B2 | <DIR> | 07-06-01 11:13a Gor2B2 |
| GRAPHICS | <DIR> | 07-06-01 11:13a Graphics |
| HELP | <DIR> | 07-06-01 11:13a Help |
| IMPORTDB EXE | 1,114,153 07-05-01 5:38p | ImportDB.exe |
| IMPOR˜37 | <DIR> | 07-06-01 11:13a ImportDatabase |
| IMPOR˜39 | <DIR> 07-06-01 11:13a | Import Wizards (Distributables) |
| IMPOR˜41 | <DIR> 07-06-01 11:13a | Import Wizards |
| IMPOR˜43 | <DIR> | 07-06-01 11:13a Import & Export |
| INDIVS | <DIR> | 07-06-01 11:13a Indivs |
| JUNIO˜47 | <DIR> | 07-06-01 11:13a Junior System |
| LETTE˜49 | <DIR> | 07-06-01 11:13a LetterSetup |
| LIBRARY | <DIR> | 07-06-01 11:13a Library |
| MAIN BAS | 8,321 07-05-01 6:19p | Main.bas |
| MAINFORM FRM | 69,661 07-05-01 6:19p | MainForm.frm |
| MAINFORM FRX | 979,268 06-26-01 10:58a | MainForm.frx |
| MINUINFO TB2 | 975,992 07-05-01 6:09p | MNUINFO.TB2 |
| MODTR˜84 BAS | 5,385 07-05-01 6:19p | modTracker.bas |
| OFFIC˜53 | <DIR> | 07-06-01 11:13a Office Policies |
| OLD20˜55 | <DIR> | 07-06-01 11:13a Old 20 database |
| ORGAN˜57 | <DIR> | 07-06-01 11:13a Organizer |
| POPUPS | <DIR> | 07-06-01 11:13a popups |
| REPORTS | <DIR> | 07-06-01 11:13a Reports |
| RESOURCE RES | 347,148 03-07-01 11:25a | Resource.res |
| RESOU˜63 | <DIR> | 07-06-01 11:13a Resources |
| SCHED˜65 | <DIR> | 07-06-01 11:13a Scheduler |
| SMFS | <DIR> | 07-06-01 11:13a SMFs |
| SPEED˜69 | <DIR> | 07-06-01 11:13a SpeedButtons |
| SPLASH FRM | 4,023 07-05-01 6:19p | Splash.frm |
| SPLASH FRX | 1,260,148 03-07-01 11:25a | Splash.frx |
| SR | <DIR> | 07-06-01 11:13a SR |
| SYSTEM | <DIR> | 07-06-01 11:13a System |
| TEXTE˜75 | <DIR> | 07-06-01 11:13a TextExpWiz21 |
| TEXTI˜77 | <DIR> | 07-06-01 11:13a TextImpWiz21 |
| TRIGGERS | <DIR> | 07-06-01 11:13a Triggers |
| USERMGMT | <DIR> | 07-06-01 11:13a UserMgmt |
| VBLI˜122 BAS | 945 07-05-01 6:19p | vbLibDebug.bas |
| WORDT˜83 | <DIR> | 07-06-01 11:13a WordTemplates |
| WORKS˜85 | <DIR> | 07-06-01 11:13a Worksheets |
| WORKS˜87 | <DIR> | 07-06-01 11:13a Workstation Licenses Utility |
| | 20 file(s) | 9,205,901 bytes |

Directory of E:\Account Group

| | | |
|---|---|---|
| . | | <DIR> 07-06-01 11:13a . |
| .. | <DIR> | 07-06-01 11:13a .. |
| CLSACC˜6 CLS | 20,314 07-05-01 6:19p | clsAccountMgr.cls |
| FRMACC˜8 FRM | 8,030 03-07-01 11:26a | frmAccountGroups.frm |
| MODAC˜10 BAS | 1,155 07-05-01 6:19p | modAccountGroup.bas |
| | 3 file(s) | 29,499 bytes |

Directory of E:\Add Forms

| | | |
|---|---|---|
| . | <DIR> | 07-06-01 11:13a . |
| .. | <DIR> | 07-06-01 11:13a .. |
| FRMADD˜6 FRM | 69,508 07-05-01 6:20p | frmAddressBundleEdit.frm |
| FRMADD˜8 FRM | 5,235 07-05-01 6:20p | frmAddKeyword.frm |
| FRMAD˜10 FRM | 11,046 07-05-01 6:20p | frmAddSBKeyword.frm |
| FRMAD˜12 FRX | 1,332 03-07-01 11:26a | frmAddSBKeyword.frx |
| FRMADDSB FRM | 35,793 03-07-01 11:26a | frmAddSB.frm |
| FRMAD˜16 FRM | 41,165 07-05-01 6:19p | frmAddAccount.frm |
| FRMAD˜18 FRX | 1,833 03-15-01 5:13p | frmAddAccount.frx |
| FRMAD˜20 FRM | 15,278 03-07-01 11:26a | frmAddCommission.frm |
| FRMAD˜22 FRX | 330 03-07-01 11:26a | frmAddImportantDates.frx |
| FRMAD˜24 FRM | 15,238 03-07-01 11:26a | frmAddExpenditure.frm |
| FRMAD˜26 FRX | 1,090 05-25-01 10:10a | frmAddKeyword.frx |
| FRMAD˜28 FRM | 6,638 07-05-01 6:19p | frmAddImportantDates.frm |
| FRMAD˜30 FRX | 8,558 05-31-01 6:20p | frmAddressBundleEdit.frx |
| FRMIN˜32 FRM | 11,132 03-07-01 11:26a | frmIndvRelate.frm |
| | 14 file(s) | 224,176 bytes |

Directory of E:\BGMControls

| | | |
|---|---|---|
| . | <DIR> | 07-06-01 11:13a . |
| .. | <DIR> | 07-06-01 11:13a .. |
| BGMCHE˜6 CTL | 12,375 07-05-01 6:20p | BGMCheckBox.ctl |
| BGMCHE˜8 CTX | 838 03-07-01 11:26a | BGMCheckBox.ctx |
| BGMCH˜10 CTL | 19,864 07-05-01 6:20p | BGMCheckListBox.Ctl |
| BGMCH˜12 CTX | 899 03-07-01 11:26a | BGMCheckListBox.ctx |
| BGMCOMBO CTL | 22,903 07-05-01 6:20p | BGMCombo.ctl |
| BGMCOMBO CTX | 2,459 03-07-01 11:26a | BGMCombo.ctx |
| BGMDA˜18 CTL | 8,622 07-05-01 6:20p | BGMDataLabel.ctl |
| BGMDA˜20 CTX | 838 03-07-01 11:26a | BGMDataLabel.ctx |
| BGMLABEL CTL | 7,827 07-05-01 6:20p | BGMLabel.ctl |
| BGMLABEL CTX | 838 03-07-01 11:26a | BGMLabel.ctx |
| BGMLI˜26 CTL | 25,251 07-05-01 6:20p | BGMListBox.ctl |
| BGMLI˜28 CTX | 2,455 03-07-01 11:26a | BGMListBox.ctx |
| BGMLI˜30 CTL | 53,752 07-05-01 6:20p | BGMListView.ctl |
| BGMLI˜32 CTX | 873 03-07-01 11:26a | BGMListView.ctx |
| BGMME˜34 CTL | 27,930 07-05-01 6:20p | BGMMemoBox.ctl |
| BGMME˜36 CTX | 841 03-07-01 11:26a | BGMMemoBox.ctx |
| BGMPR˜38 PAG | 5,751 07-05-01 6:20p | BGMPropList.pag |
| BGMTE˜40 CTL | 29,984 07-05-01 6:20p | BGMTextBox.ctl |
| BGMTE˜42 CTX | 838 03-07-01 11:26a | BGMTextBox.ctx |
| BGMVI˜44 CTL | 59,796 03-07-01 11:26a | BGMVirtualListView.ctl |
| BGM_D˜46 CTL | 20,850 07-05-01 6:20p | BGM_DB_Arbitrator.ctl |
| BGM_D˜48 CTX | 1,064 03-07-01 11:26a | BGM_DB_Arbitrator.ctx |
| BGM_R˜50 CTL | 38,755 07-05-01 6:20p | BGM_RS_Arbitrator.ctl |
| BGM_R˜52 CTX | 1,064 03-07-01 11:26a | BGM_RS_Arbitrator.ctx |
| BOUND˜54 PAG | 2,314 07-05-01 6:20p | Bound Controls.pag |
| CFIELD CLS | 1,302 07-05-01 6:20p | cField.cls |
| CHOOS˜58 PAG | 6,157 07-05-01 6:20p | Choose Field.pag |
| CHOOS˜60 PAG | 7,266 07-05-01 6:20p | Choose Fill Fields.pag |
| CTABLE CLS | 1,820 07-05-01 6:20p | cTable.cls |
| CTLCO˜64 CTL | 35,275 07-05-01 6:20p | ctlColumnHeaders.ctl |
| CTLCO˜66 CTL | 6,174 07-05-01 6:20p | ctlControlHolder.ctl |
| CTLLVW CTL | 72,747 07-05-01 6:20p | ctlLVW.ctl |
| CTLLVW CTX | 891 03-07-01 11:26a | ctlLVW.ctx |
| CTLME˜72 CTL | 61,854 07-05-01 6:20p | ctlMemLVW.ctl |
| CTLME˜74 CTX | 786 03-07-01 11:26a | ctlMemLVW.ctx |
| CTLPI˜76 CTL | 8,133 07-05-01 6:20p | ctlPicButton.ctl |
| CTLPI˜78 CTX | 242 05-16-01 8:44a | ctlPicButton.ctx |
| CTLPR˜80 CTL | 23,742 07-05-01 6:20p | ctlPrintPreview.ctl |
| CTLPR˜82 CTX | 79,526 04-25-01 9:16a | ctlPrintPreview.ctx |
| DATETEXT CTL | 13,939 03-07-01 11:26a | DateText.ctl |
| FIELD˜86 CLS | 2,624 07-05-01 6:20p | FieldConst.cls |
| FRMDUMMY FRM | 1,468 07-05-01 5:50p | frmDummy.frm |
| FRMDUMMY FRX | 1,209 05-16-01 8:44a | frmDummy.frx |
| FRMLV˜92 FRM | 14,772 07-05-01 6:20p | frmLVWCustomize.frm |
| FRMLV˜94 FRX | 1,090 06-21-01 10:47a | frmLVWCustomize.frx |
| INITD˜96 BAS | 362,172 07-05-01 6:20p | initdbconst.bas |
| PAGDE˜98 PAG | 11,988 07-05-01 6:20p | pagDefaultFields.pag |
| PAGD˜100 PGX | 172 03-07-01 11:26a | pagDefaultFields.pgx |
| PAGR˜102 PAG | 7,358 07-05-01 6:20p | pagRelation.pag |
| PAGU˜104 PAG | 11,938 07-05-01 6:20p | pagUDefFields.pag |
| PAGU˜106 PGX | 178 03-07-01 11:26a | pagUDefFields.pgx |
| TABL˜108 CLS | 2,703 07-05-01 6:20p | TableConst.cls |
| | 52 file(s) 1,086,507 bytes | |

Directory of E:\BGM_DBEngine21

| | | |
|---|---|---|
| . | <DIR> | 07-06-01 11:13a . |
| .. | <DIR> | 07-06-01 11:13a .. |
| BGM_DA˜6 CLS | 5,803 03-07-01 11:26a | BGM_Database.cls |
| BGM_DB˜8 DLL | 86,016 03-07-01 11:26a | BGM_DBEngine.dll |
| BGM_D˜10 EXP | 1,000 03-07-01 11:26a | BGM_DBEngine.exp |
| BGM_D˜12 LIB | 2,708 03-07-01 11:26a | BGM_DBEngine.lib |
| BGM_D˜14 VBP | 1,203 03-07-01 11:26a | BGM_DBEngine.vbp |
| BGM_Q˜16 CLS | 2,434 03-07-01 11:26a | BGM_Query.cls |
| BGM_R˜18 CLS | 14,587 03-07-01 11:26a | BGM_Recordset.cls |
| QUERIES CLS | 3,848 03-07-01 11:26a | Queries.cls |
| RECOR˜22 CLS | 5,140 03-07-01 11:26a | Recordsets.cls |
| | 9 file(s) | 122,739 bytes |

Directory of E:\Campaigns

| | | |
|---|---|---|
| . | <DIR> | 07-06-01 11:13a . |
| .. | <DIR> | 07-06-01 11:13a .. |
| CAMPAI˜5 | <DIR> | 07-06-01 11:13a Campaign Wizard |
| CAMPAI˜8 CLS | 25,467 07-05-01 6:20p | CampaignStep.cls |
| CAMPM˜10 FRM | 148,460 07-05-01 6:20p | campManager.frm |
| CAMPM˜12 FRX | 44,770 06-14-01 11:06a | campManager.frx |
| CAMPM˜14 FRM | 8,084 07-05-01 6:20p | campManagerOpen.frm |
| CAMPM˜16 FRX | 2,432 03-07-01 11:26a | campManagerOpen.frx |
| CLSCA˜18 CLS | 434 07-05-01 6:20p | clsCampaignParamData1.cls |
| CLSCA˜20 CLS | 9,673 07-05-01 6:20p | clsCampWizRefCtls.cls |
| CLSCA˜22 CLS | 22,335 07-05-01 6:20p | clsCampaignMasterLetter.cls |
| CLSCA˜24 CLS | 5,579 07-05-01 6:20p | clsCampaignMasterLetterCMFCollection.cls |
| CLSCA˜26 CLS | 11,257 07-05-01 6:20p | clsCampaignMasterTrack.cls |
| CLSCA˜28 CLS | 10,279 07-05-01 6:20p | clsCampaignMasterStepCollection.cls |
| CLSCA˜30 CLS | 38,279 05-11-01 5:09p | clsCampMasterRefinementControls.cls |
| CLSCA˜32 CLS | 7,122 07-05-01 6:20p | clsCampaignMasterLetterCMF.cls |
| CLSCA˜34 CLS | 5,862 07-05-01 6:20p | clsCampaignMasterTrackCollection.cls |
| CLSCA˜36 CLS | 4,672 07-05-01 6:20p | clsCampMasterRefCtls.cls |
| CLSCA˜38 CLS | 5,120 05-11-01 4:50p | clsCampWizRefinementControls.cls |
| CLSCA˜40 CLS | 3,485 07-05-01 6:20p | clsCallParams.cls |
| CLSCA˜42 CLS | 6,867 07-05-01 6:20p | clsCampaignInstanceCost.cls |
| CLSCA˜44 CLS | 11,940 07-05-01 6:20p | clsCampaignMaster.cls |
| CLSCA˜46 CLS | 6,140 07-05-01 6:20p | clsCampaignMasterEventDate.cls |
| CLSCA˜48 CLS | 4,878 07-05-01 6:20p | clsCampaignMasterEventDateCollection.cls |
| CLSEV˜50 CLS | 6,677 03-07-01 11:26a | clsEventDate.cls |
| CLSIN˜52 CLS | 694 03-07-01 11:26a | clsInstanceEventHelper.cls |
| CLSMA˜54 CLS | 7,181 03-07-01 11:26a | clsMasterTrack.cls |
| FRMCA˜56 FRX | 12 03-07-01 11:26a | frmCAMPFilter.frx |
| FRMCA˜58 FRM | 9,930 07-05-01 6:20p | frmCAMPFilter.frm |
| FRMCA˜60 FRX | 1,676 03-07-01 11:26a | frmCampCallingListOptions.frx |
| FRMCA˜62 FRM | 11,249 07-05-01 6:20p | frmCampCallingListOptions.frm |
| FRMCA˜64 FRM | 11,018 07-05-01 6:20p | frmCampaignTrackJumper.frm |
| FRMCA˜66 FRM | 20,012 03-07-01 11:26a | frmCampList.frm |
| FRMCA˜68 FRM | 35,649 07-05-01 6:20p | frmCampHousekeepingPopup.frm |
| FRMCA˜70 FRM | 27,179 07-05-01 6:20p | frmCampObjective.frm |
| FRMCA˜72 FRX | 8,137 04-25-01 9:16a | frmCampaignStatusReport.frx |
| FRMCA˜74 FRM | 48,172 07-05-01 6:20p | frmCampaignStatusReport.frm |
| FRMCA˜76 FRX | 1,606 03-07-01 11:26a | frmCampMasterTrackList.frx |
| FRMCA˜78 FRM | 44,951 07-05-01 6:20p | frmCampMassMail.frm |
| FRMCA˜80 FRX | 1,916 05-14-01 4:14p | frmCampMassMail.frx |
| FRMCA˜82 FRM | 36,009 03-07-01 11:26a | frmCampCMP.frm |
| FRMCA˜84 FRX | 3,739 05-15-01 10:50a | frmCampPrint.frx |
| FRMCA˜86 FRX | 1,090 03-07-01 11:26a | frmCampMasterEventList.frx |
| FRMCA˜88 FRM | 14,152 07-05-01 6:20p | frmCampReminder.frm |
| FRMCA˜90 FRX | 1,141 03-07-01 11:26a | frmCampReminder.frx |
| FRMCA˜92 FRX | 1,418 05-18-01 2:36p | frmCampMasterRefinements.frx |
| FRMCA˜94 FRX | 1,372 03-07-01 11:26a | frmCampMasterEVDatePopup.frx |
| FRMCA˜96 FRM | 54,769 07-05-01 6:20p | frmCampHouseKeeping.frm |
| FRMCA˜98 FRX | 1,090 03-07-01 11:26a | frmCampMasterTrackPopup.frx |
| FRMC˜100 FRM | 7,973 07-05-01 6:20p | frmCampMasterTrackPopup.frm |
| FRMC˜102 FRX | 13,076 05-25-01 10:38a | frmCampHousekeeping.frx |
| FRMC˜104 FRM | 12,115 07-05-01 6:20p | frmCampMasterTrackList.frm |
| FRMC˜106 FRM | 8,346 07-05-01 6:20p | frmCampaignTrackChooser.frm |
| FRMC˜108 FRX | 1,096 03-07-01 11:26a | frmCampaignTrackChooser.frx |
| FRMC˜110 FRM | 119,825 07-05-01 6:20p | frmCampPrint.frm |
| FRMC˜112 FRX | 1,454 03-07-01 11:26a | frmCampaignTrackJumper.frx |
| FRMC˜114 FRM | 9,021 07-05-01 6:20p | frmCampMasterEventList.frm |
| FRMC˜116 FRM | 16,396 03-07-01 11:26a | frmCampaigns.frm |
| FRMC˜118 FRM | 8,549 07-05-01 6:20p | frmCampMasterRefinements.frm |
| FRMC˜120 FRM | 86,609 07-05-01 6:20p | frmCampaignMaker.frm |
| FRMC˜122 FRM | 30,112 07-05-01 6:20p | frmCampMasterHouseKeeping.frm |
| FRMC˜124 FRX | 1,500 03-07-01 11:26a | frmCampMasterHouseKeeping.frx |
| FRMC˜126 FRX | 12,576 07-05-01 5:13p | frmCampHousekeepingPopup.frx |
| FRMC˜128 FRM | 9,821 07-05-01 6:20p | frmCampMasterEVDatePopup.frm |
| FRMC˜130 FRX | 22,699 03-07-01 11:26a | frmCampObjective.frx |
| FRMA˜132 FRM | 6,917 07-05-01 6:20p | frmAddCG2Camp.frm |
| FRMA˜134 FRX | 1,020 03-07-01 11:26a | frmAddCG2Camp.frx |
| FRMA˜136 FRM | 7,483 07-05-01 6:20p | frmAddEditCost.frm |
| FRMA˜138 FRX | 1,418 03-07-01 11:26a | frmAddEditCost.frx |
| FRMC˜140 FRM | 21,193 07-05-01 6:20p | frmCampAction.frm |
| FRMC˜142 FRX | 2,347 03-07-01 11:26a | frmCampAction.frx |
| FRMC˜144 FRM | 14,055 03-07-01 11:26a | frmCampaignActionInfo.frm |
| FRMC˜146 FRX | 86,485 04-25-01 9:16a | frmCampaignCallingList.frx |
| FRMC˜148 FRM | 43,860 07-05-01 6:20p | frmCampaignCallingList.frm |
| FRMC˜150 FRX | 1,418 03-07-01 11:26a | frmCampaignCost.frx |
| FRMC˜152 FRM | 8,143 07-05-01 6:20p | frmCampaignCost.frm |
| FRMC˜154 FRX | 11,708 03-07-01 11:26a | frmCampaignMaker.frx |
| FRMC˜156 FRM | 9,860 07-05-01 6:20p | frmCGCampAdd.frm |
| FRMC˜158 FRX | 2,542 03-07-01 11:26a | frmCGCampAdd.frx |
| FRMC˜160 FRM | 19,114 03-07-01 11:26a | frmChecklist.frm |
| FRMD˜162 FRM | 5,486 07-05-01 6:20p | frmDeleteCampaign.frm |
| FRMD˜164 FRX | 3,156 03-07-01 11:26a | frmDeleteCampaign.frx |
| FRMM˜166 FRM | 11,368 07-05-01 6:20p | frmManageEventDates.frm |
| FRMM˜168 FRX | 1,332 03-07-01 11:26a | frmManageEventDates.frx |
| FRMM˜170 FRM | 36,131 03-07-01 11:26a | frmMassMail.frm |
| FRMO˜172 FRM | 6,678 07-05-01 6:20p | frmOpenCampaign.frm |
| FRMO˜174 FRX | 3,950 03-07-01 11:26a | frmOpenCampaign.frx |
| FRMP˜176 FRM | 74,922 03-07-01 11:26a | frmPicCampaignWizard.frm |
| FRMR˜178 FRM | 3,455 03-07-01 11:26a | frmReminder.frm |
| FRMR˜180 FRM | 12,889 03-07-01 11:26a | frmReminderMaker.frm |
| FRMS˜182 FRM | 9,615 07-05-01 6:20p | frmSaveCampaign.frm |
| FRMS˜184 FRX | 3,950 03-07-01 11:26a | frmSaveCampaign.frx |
| FRMS˜186 FRM | 6,189 07-05-01 6:20p | frmStatOptions.frm |
| FRMS˜188 FRX | 1,418 03-07-01 11:26a | frmStatOptions.frx |
| FRMTASK FRM | 5,990 03-07-01 11:26a | frmTask.frm |
| MODC˜192 BAS | 8,764 03-07-01 11:26a | modCampaignEngine.bas |
| MODC˜194 BAS | 38,150 07-05-01 6:20p | modCampaignMaker.bas |
| MODC˜196 BAS | 135 03-07-01 11:26a | modCampaigns.bas |
| NODE˜198 CLS | 524 07-05-01 5:52p | NodeHolder.cls |
| REMINDER CLS | 2,918 03-07-01 11:26a | Reminder.cls |
| REMI˜202 CLS | 2,904 03-07-01 11:26a | ReminderSet.cls |
| TREE˜204 CLS | 10,049 03-07-01 11:26a | TreeViewHelper.cls |
| | 99 file(s) 1,602,678 bytes | |

Directory of E:\Campaigns\Campaign Wizard

| | | |
|---|---|---|
| . | <DIR> | 07-06-01 11:13a . |
| .. | <DIR> | 07-06-01 11:13a .. |
| CLSCAM˜6 CLS | 3,565 07-05-01 6:20p | clsCampaignWizLetterCMF.cls |
| CLSCAM˜8 CLS | 8,227 07-05-01 6:20p | clsCampaignWizStepCollection.cls |
| CLSCA˜10 CLS | 2,310 03-07-01 11:26a | clsCampaignWizLetterCollection.cls |
| CLSCA˜12 CLS | 4,009 07-05-01 6:20p | clsCampaignWizEventDateCollection.cls |
| CLSCA˜14 CLS | 4,100 07-05-01 6:20p | clsCampaignWizLetterCMFCollection.cls |
| CLSCA˜16 CLS | 16,930 07-05-01 6:20p | clsCampaignWizStep.cls |
| CLSCA˜18 CLS | 2,055 07-05-01 6:20p | clsCampaignWizTeamPostCollection.cls |
| CLSCA˜20 CLS | 19,039 07-05-01 6:20p | clsCampaignWizLetter.cls |
| CLSCA˜22 CLS | 3,367 07-05-01 6:20p | clsCampaignWizTeamPost.cls |
| CLSCA˜24 CLS | 1,972 03-07-01 11:26a | clsCampaignPost2StaffGroup.cls |
| CLSCA˜26 CLS | 1,455 03-07-01 11:26a | clsCampaignPost2StaffGroupList.cls |
| CLSCA˜28 CLS | 59,616 07-05-01 6:20p | clsCampaignWiz.cls |
| CLSCA˜30 CLS | 4,090 07-05-01 6:20p | clsCampaignWizEventDate.cls |
| CLSEV˜32 CLS | 1,663 03-07-01 11:26a | clsEventDateEntry.cls |
| CLSEV˜34 CLS | 1,400 03-07-01 11:26a | clsEventDateEntryList.cls |
| CLSIN˜36 CLS | 508 03-07-01 11:26a | clsInstanceTrackHelper.cls |
| FRMCA˜38 FRM | 103,514 07-05-01 6:20p | frmCampaignWizard.frm |
| FRMCA˜40 FRX | 150,425 07-05-01 11:24a | frmCampaignWizard.frx |
| FRMCA˜42 FRM | 44,886 07-05-01 6:20p | frmCampaignWizardLetter.frm |
| FRMCA˜44 FRX | 3,368 05-14-01 4:39p | frmCampaignWizardLetter.frx |
| | 20 file(s) | 436,499 bytes |

Directory of E:\Contact Mgmt Process

| | | |
|---|---|---|
| . | | <DIR> 07-06-01 11:13a . |
| .. | <DIR> | 07-06-01 11:13a .. |
| CLSOBJ˜6 CLS | 5,956 07-05-01 6:32p | clsOBJTreeItem.cls |
| CLSOBJ˜8 CLS | 19,029 07-05-01 6:32p | clsObjTreeItemList.cls |
| FRMAC˜10 FRM | 43,516 07-05-01 6:32p | frmActions.frm |
| FRMAC˜12 FRX | 3,684 05-16-01 9:49a | frmActions.frx |
| FRMCMP FRM | 37,838 03-07-01 11:26a | frmCMP.frm |
| FRMCM˜16 FRM | 90,652 07-05-01 6:32p | frmCMP_R2.frm |
| FRMCM˜18 FRX | 26,186 06-26-01 2:47p | frmCMP_R2.frx |
| FRMLE˜20 FRM | 27,944 07-05-01 6:32p | frmLetterHistView.frm |
| FRMLE˜22 FRX | 1,090 03-07-01 11:26a | frmLetterHistView.frx |
| FRMNOTE FRM | 26,278 07-05-01 6:32p | frmNote.frm |
| FRMNOTE FRX | 1,332 06-01-01 1:32p | frmNote.frx |
| MODOB˜28 BAS | 63,133 07-05-01 6:32p | modObjective.bas |
| | 12 file(s) | 346,638 bytes |

Directory of E:\Contact Group

| | | |
|---|---|---|
| . | | <DIR> 07-06-01 11:13a . |
| .. | <DIR> | 07-06-01 11:13a .. |
| CLSIND˜6 CLS | 735 07-05-01 5:52p | clsINDVProps.cls |
| CONTAC˜5 | <DIR> | 07-06-01 11:13a Contact Mgmt |
| CPWINDOW FRM | 123,550 03-07-01 11:26a | CPWindow.frm |
| FRMCG˜12FRM | 61,944 07-05-01 6:20p | frmCGDownlineWiz.frm |
| FRMCG˜14 FRX | 144,938 07-05-01 5:14p | frmCGDownlineWiz.frx |
| FRMCG˜16 FRM | 7,685 03-07-01 11:26a | frmCGEdit.frm |
| FRMCG˜18 FRM | 13,178 07-05-01 6:20p | frmCGStatusBarEdit.frm |
| FRMCG˜20 FRX | 786 05-09-01 10:20a | frmCGStatusBarEdit.frx |
| FRMFAT FRM | 255,459 03-07-01 11:26a | frmFat.frm |
| FRMHI˜24 FRM | 17,732 07-05-01 6:20p | frmHistoryFilter.frm |
| FRMIN˜26 FRM | 231,529 07-05-01 6:20p | frmInfoSheet.frm |
| FRMIN˜28 FRX | 52,529 06-26-01 1:53p | frmInfoSheet.frx |
| FRMOB˜30 FRM | 4,429 03-07-01 11:26a | frmObjectiveEditing.frm |
| | 12 file(s) | 914,494 bytes |

Directory of E:\Contact Group\Contact Mgmt

| | | |
|---|---|---|
| . | | <DIR> 07-06-01 11:13a . |
| .. | DIR> | 07-06-01 11:13a .. |
| FRMCGU˜6 FRM | 45,431 07-05-01 6:32p | frmCGUpdate.frm |
| FRMCGU˜8 FRX | 37,458 03-07-01 11:26a | frmCGUpdate.frx |
| | 2 file(s) | 82,889 bytes |

Directory of E:\Database

| | | |
|---|---|---|
| . | | <DIR> 07-06-01 11:13a . |
| .. | <DIR> | 07-06-01 11:13a .. |
| B2 MDB | 6,340,608 05-30-01 5:59p | B2.mdb |
| B21 MDB | 5,652,480 07-05-01 5:14p | B21.mdb |
| B2DBC˜10 TXT | 50,274 06-26-01 4:20p | B2DBChanges.txt |
| BASEL˜12 LOG | 260 06-19-01 5:16p | Baseline 2.0.LOG |
| NEWMS˜14 MDB | 126,976 03-07-01 11:27a | new msynch tables.mdb |
| NEWOB˜16 MDB | 397,312 05-10-01 10:32a | New ObjTree Queries and other v21 |
| | | changes.mdb |
| NEWOB˜18 MDB | 286,720 04-17-01 10:21a | New ObjTree Queries.mdb |
| SCHED˜20 MDB | 92,160 03-07-01 11:27a | Scheduler2.mdb |
| | 8 file(s) 12,946,790 bytes | |

Directory of E:\DataEntry Wizard

| | | |
|---|---|---|
| . | | <DIR>07-06-01 11:13a . |
| .. | <DIR> | 07-06-01 11:13a .. |
| DWIZ FRM | 331,423 03-07-01 11:27a | dWiz.frm |
| DWIZ_V2 | <DIR> 07-06-01 11:13a | DWiz_V2 |
| FRMED˜10 FRM | 56,608 07-05-01 6:33p | frmEditList.frm |
| FRMED˜12 FRX | 1,090 03-07-01 11:27a | frmEditList.frx |
| MODDA˜14 BAS | 17,951 07-05-01 6:33p | modDataEntry.bas |
| | 4 file(s) | 407,072 bytes |

Directory of E:\DataEntryWizard\DWiz_V2

| | | |
|---|---|---|
| . | | <DIR> 07-06-01 11:13a . |
| .. | <DIR> | 07-06-01 11:13a .. |
| CLSADD˜6 CLS | 14,559 07-05-01 6:33p | clsAddressBundle.cls |
| CLSADD˜8 CLS | 8,208 07-05-01 6:33p | clsAddressBundleList.cls |
| CLSCO˜10 CLS | 3,868 07-05-01 6:33p | clsCONTROLINFO.cls |
| CLSDW˜12 CLS | 593 07-05-01 5:52p | clsDWizPage.cls |
| CTLFA˜14 CTL | 137,064 07-05-01 6:33p | ctlFatBoy.ctl |
| GTLFA˜16 CTX | 242 03-15-01 1:14p | ctlFatBoy.ctx |
| FRMDWIZ FRM | 183,471 07-05-01 6:33p | frmDWiz.frm |
| FRMDWIZ FRX | 26,922 05-15-01 4:24p | frmDWiz.frx |
| | 8 file(s) | 374,927 bytes |

Directory of E:\Development Docs

| | | |
|---|---|---|
| . | | <DIR> 07-06-01 11:13a . |
| .. | <DIR> | 07-06-01 11:13a .. |
| 20INTR˜6 DOC | 52,736 03-07-01 11:27a | 2.0 Intro Rev1.doc |
| ADDRES˜8 DOC | 20,992 03-07-01 11:27a | Address Bundle Fixes.doc |
| ADDRE˜10 DOC | 2,786,816 03-07-01 11:27a | Address Bundles.doc |
| B2PRI˜12 DOC | 29,696 03-07-01 11:27a | B2 Priorities.doc |
| BASEL˜14 DOC | 566,272 03-07-01 11:27a | Baseline demo.doc |
| BASEL˜16 DOC | 24,064 03-07-01 11:27a | Baseline topics.doc |
| BASEL˜18 DOC | 23,040 03-07-01 11:27a | Baseline vs ISM Data Levels.doc |
| BGNEW˜20 DOC | 24,576 03-07-01 11:27a | BG New Fields.doc |
| BILLC˜22 DOC | 94,208 03-07-01 11:27a | Bill Camp Comments jun98.doc |
| BILLS˜24 DOC | 2,446,336 03-07-01 11:27a | Bills NY Presentation SBs.doc |
| CAMPA˜26 DOC | 30,208 03-07-01 11:27a | Gampaign ToDo.doc |
| CAMPA˜28 DOC | 2,291,712 03-07-01 11:27a | Campaign Manager.doc |
| CAMPA˜30 DOC | 31,744 03-07-01 11:27a | Campaign SR.doc |
| CAMPA˜32 DOC | 26,112 03-07-01 11:27a | Campaign Status Report Specs.doc |
| CAMPA˜34 DOC | 288,768 03-07-01 11:27a | Campaign Structure.doc |
| CAMPA˜36 DOC | 36,352 03-07-01 11:27a | CAMPAIGN Dictionary.doc |
| CAMPA˜38 DOC | 2,522,624 03-07-01 11:27a | CAMPAIGN EDITOR enhances.doc |
| CAMPA˜40 DOC | 2,439,680 03-07-01 11:27a | Campaign Editor.doc |
| CAMPA˜42 DOC | 25,600 03-07-01 11:27a | Campaign Issues - Tripwires.doc |
| CAMPS˜44 DOC | 25,600 03-07-01 11:27a | Camp Strength & Weakness.doc |
| CARDW˜46 DOC | 1,992,704 03-07-01 11:27a | Cardware Installer Tech Doc.doc |
| CG2SY˜48 DOC | 1,187,328 03-07-01 11:27a | CG2System Owner.doc |
| CONTA˜50 DOC | 826,368 03-07-01 11:27a | CONTACT MANAGEMENT |
| | | PROCESSES.doc |
| CORTN˜52 DOC | 47,104 03-07-01 11:27a | cortney memo.doc |
| DATAS˜54 PPT | 24,576 03-07-01 11:27a | Data Structure Org Chart.ppt |
| DTSAG˜56 DOC | 356,352 03-07-01 11:27a | DTS AG DESIGN Jun98.doc |
| DTSBU˜58 RTF | 27,733 03-07-01 11:27a | DTSBUGS_Response_EDIT.rtf |
| DTSRE˜60 DOC | 192,512 03-07-01 11:27a | DTS Response 02-08-99.doc |
| DTSTO˜62 DOC | 24,576 03-07-01 11:27a | DTS to Bill Flame-reduction.doc |
| FATFO˜64 DOC | 4,184,064 03-07-01 11:27a | FAT FORM REWORKING.doc |
| FEATU˜66 DOC | 22,016 03-07-01 11:27a | Features to do list.doc |
| FEATU˜68 OPX | 15,421 03-07-01 11:27a | Feature Dependancies.opx |
| GORILL˜5 | <DIR> 07-06-01 11:13a | Gorilla-Tracker Integration |
| GORIL˜72 DOC | 129,024 05-24-01 2:04p | Gorilla 20 to 21 changes.doc |
| GORIL˜74 DOC | 80,896 03-07-01 11:27a | Gorilla Release Letter.doc |
| GORIL˜76 DOC | 2,042,880 03-07-01 11:27a | Gorilla Times Article July 99.doc |
| GORIL˜78 DOC | 58,880 03-07-01 11:27a | Gorilla Times Article March 99.doc |
| IMPOR˜80 DOC | 1,030,144 03-07-01 11:27a | IMPORTANT DATES2.doc |
| INTER˜82 DOC | 27,136 03-07-01 11:27a | InterfaceReviewV1.doc |
| INTER˜84 DOC | 44,032 03-07-01 11:27a | InterfaceReviewV1Graphic.doc |
| INTIN˜86 DOC | 4,572,160 03-07-01 11:27a | Int Inv Positions.doc |
| JR11B˜88 DOC | 22,016 03-07-01 11:27a | Jr 11 Beta staff memo.doc |
| JUNIO˜90 DOC | 34,304 03-07-01 11:27a | Junior View Data.doc |
| LEGAL˜92 DOC | 1,448,960 03-07-01 11:27a | Legal message areas.doc |
| LETTER ZIP | 340,478 03-07-01 11:27a | Letter.zip |
| LETTE˜96 DOC | 23,040 03-07-01 11:27a | Letter Web site Database upscale csw.doc |
| LETTE˜98 DOC | 211,456 03-07-01 11:27a | Letters on the WEB.doc |
| MAIL˜100 DOC | 1,030,656 03-07-01 11:27a | Mailing Waves.doc |
| MDIT˜102 DOC | 24,064 03-07-01 11:27a | MDI Toolbar&Menus.doc |
| MESS˜104 DOC | 41,472 03-07-01 11:27a | Messaging Procedure.doc |
| NEWM˜106 DOC | 152,064 03-07-01 11:27a | New Milestones.doc |
| OFFI˜108 DOC | 23,552 06-05-01 4:21p | Office Procedure Manager.doc |
| POSI˜110 DOC | 20,992 03-07-01 11:27a | position field.doc |
| PROF˜112 DOC | 863,744 03-07-01 11:27a | Profile data 2.0.doc |
| PROF˜114 DOC | 198,656 03-07-01 11:27a | Profile Data Implementation.doc |
| PROF˜116 DOC | 132,608 03-07-01 11:27a | Profile data.doc |
| PROP˜118 DOC | 193,024 03-07-01 11:27a | Proposed Speedbutton changes.doc |
| PROT˜120 DOC | 146,432 03-07-01 11:27a | Protocomment May 21 1998-Rev 10 June.doc |
| PROT˜122 DOC | 47,616 03-07-01 11:27a | Protocomment May 21 1998.doc |
| PUBL˜124 DOC | 23,552 05-24-01 5:10p | publish or perish csw.DOC |
| REFE˜126 DOC | 1,406,976 03-07-01 11:27a | referrals.doc |
| REQU˜128 DOC | 19,456 03-07-01 11:27a | Requirements Template.doc |
| SEGR˜130 DOC | 29,184 03-07-01 11:27a | SEG Ranting.doc |
| SELE˜132 DOC | 66,048 03-07-01 11:27a | Selection Rule Q&A 8-9-00.doc |
| SELE˜134 DOC | 30,720 03-12-01 4:13p | selection rule refining.doc |
| SELR˜136 DOC | 20,480 03-07-01 11:27a | Sd Rules Update 10-6-99.doc |
| SENA˜138 PPT | 157,696 03-07-01 11:27a | Senario One.ppt |
| SENA˜140 PPT | 122,368 03-07-01 11:27a | Senario Three.ppt |
| SENA˜142 PPT | 123,392 03-07-01 11:27a | Senario Two.ppt |
| SILV˜144 DOC | 512,000 03-07-01 11:27a | Silverback Proposal System.doc |
| SIMP˜146 DOC | 45,568 03-07-01 11:27a | Simpler Profile Requirements.doc |
| SMAR˜148 DOC | 25,600 03-07-01 11:27a | Smart Dialer Design.doc |
| SMAR˜150 DOC | 33,280 03-07-01 11:27a | Smart Dialer Requirements.doc |
| STAT˜152 DOC | 27,136 03-07-01 11:27a | State Bits.doc |
| TEAM˜154 DOC | 1,519,104 03-07-01 11:27a | Team Mgmt.doc |
| TECH˜156 TXT | 819 03-07-01 11:27a | tech assistant.txt |
| TEST˜158 DOC | 28,672 03-07-01 11:27a | tester ad.doc |
| TEST˜160 DOC | 25,600 03-07-01 11:27a | Tester Coversheet.doc |
| TEST˜162 DOC | 22,528 03-07-01 11:27a | TesterTest.doc |
| TEST˜164 TXT | 2,481 03-07-01 11:27a | testquest.txt |
| TODO˜166 PPT | 37,888 03-07-01 11:27a | todo dependancies.ppt |
| USAB˜168 DOC | 76,800 03-07-01 11:27a | UsabProcv193.doc |
| USER˜170 DOC | 52,736 03-07-01 11:27a | Users 98 Post Mortom.doc |
| USER˜172 DOC | 24,064 03-07-01 11:27a | user security.doc |
| VBCO˜174 DOC | 23,552 03-07-01 11:27a | VB Contract Job Ad.doc |
| WORK˜176 DOC | 351,232 03-07-01 11:27a | WORKSTATION LICENSING.doc |
| | 85 file(s) 40,437,108 bytes | |

Directory of E:\Development Docs\Gorilla-Tracker Integration

| | | |
|---|---|---|
| . | | <DIR> 07-06-01 11:13a . |
| .. | <DIR> | 07-06-01 11:13a .. |
| GORILL˜6 DOC | 171,520 03-19-01 5:03p | gorilla.screens.doc |
| GORILL˜8 DOC | 30,208 03-19-01 5:03p | gorilla.update.doc |
| SCHED˜10 DOC | 19,456 06-14-01 2:51p | Schedule for Erick Smith.doc |
| STGPH˜12 DOC | 178,176 06-14-01 2:51p | STG Phase One Requirements.doc |
| TRACK˜14 DOC | 60,416 03-19-01 5:03p | tracker.gorilla.data.doc |
| TRACK˜16 DOC | 19,968 03-19-01 5:03p | tracker.rs.fields.doc |
| TRACK˜18 DOC | 314,368 03-19-01 5:03p | tracker.screens.doc |
| | 7 file(s) | 794,112 bytes |

Directory of E:\Dialer

| | | |
|---|---|---|
| . | | <DIR> 07-06-01 11:13a . |
| .. | <DIR> | 07-06-01 11:13a .. |
| CTLDIA˜6 CTL | 17,964 07-05-01 6:33p | ctlDialer.ctl |
| CTLDIA˜8 CTX | 1,594 04-13-01 8:14a | ctlDialer.ctx |
| DIALER FRM | 16,466 07-05-01 6:33p | dialer.frm |
| DIALER FRX | 2,684 04-13-01 4:12p | dialer.frx |
| DIALE˜14 BAS | 15,642 07-05-01 6:33p | DialerLib.bas |
| | 5 file(s) | 54,350 bytes |

Directory of E:\DownlinePurge

| | | |
|---|---|---|
| . | <DIR> | 07-06-01 11:13a . |
| .. | <DIR> | 07-06-01 11:13a .. |
| CLSCGD˜6 CLS | 73,815 07-05-01 6:33p | clsCGDownline.cls |
| CLSCGD˜8 CLS | 977 07-05-01 6:33p | clsCGDownline_Test.cls |
| CLSDE˜10 CLS | 1,958 07-05-01 6:33p | clsDebugOutputStream.cls |
| CLSPR˜12 CLS | 11,612 07-05-01 6:33p | clsPrintHistoryOptions.cls |
| FRMDO˜14 FRM | 24,456 04-06-01 4:45p | frmDownline.frm |
| FRMDO˜16 FRX | 1,660 03-07-01 11:27a | frmDownline.frx |
| FRMPR˜18 FRM | 13,968 07-05-01 6:33p | frmPrintHistory.frm |
| FRMPR˜20 FRX | 330 05-22-01 4:58p | frmPrintHistory.frx |
| FRMPR˜22 FRM | 27,688 07-05-01 6:33p | frmPrintHistoryOptions.frm |
| FRMPR˜24 FRX | 2,068 04-06-01 4:12p | frmPrintHistoryOptions.frx |
| | 10 file(s) | 158,532 bytes |

Directory of E:\Finder

| | | |
|---|---|---|
| . | <DIR> | 07-06-01 11:13a . |
| .. | <DIR> | 07-06-01 11:13a .. |
| BUYING˜6 FRM | 683 03-07-01 11:27a | Buying Units.frm |
| CLSSEA˜8 CLS | 12,077 07-05-01 6:33p | clsSearchBar.cls |
| CLSSE˜10 CLS | 10,413 07-05-01 6:33p | clsSearchControls.cls |
| CONTA˜12 FRM | 18,202 03-07-01 11:27a | Contact Groups.frm |
| FINDER FRM | 96,769 07-05-01 6:33p | finder.frm |
| FINDER FRX | 15,910 05-11-01 2:25p | finder.frx |
| FRMPO˜18 FRM | 15,683 07-05-01 6:33p | frmPopupCGChooser.frm |
| FRMPO˜20 FRX | 3,876 03-07-01 11:27a | frmPopupCGChooser.frx |
| FRMPO˜22 FRM | 15,750 07-05-01 6:33p | frmPopupIndivChooser.frm |
| FRMPO˜24 FRX | 4,188 03-07-01 11:27a | frmPopupIndivChooser.frx |
| FRMSE˜26 FRM | 8,562 07-05-01 6:33p | frmSearchOptions.frm |
| FRMSE˜28 FRX | 1,090 03-07-01 11:27a | frmSearchOptions.frx |
| | 12 file(s) | 203,203 bytes |

Directory of E:\Gor2B2

| | | |
|---|---|---|
| . | <DIR> | 07-06-01 11:13a . |
| .. | <DIR> | 07-06-01 11:13a .. |
| B2STUFF BAS | 3,679 03-07-01 11:27a | B2Stuff.bas |
| CLASSG˜8 CLS | 791 03-07-01 11:27a | classGor2B2.cls |
| CLSCRC CLS | 2,901 03-07-01 11:27a | clsCRC.cls |
| CLSPA˜12 CLS | 468 03-07-01 11:27a | clsParamDataNumStr.cls |
| EMPTYD˜5 1CO | <DIR> 07-06-01 11:13a | empty db for 1.x to 2.1 conversion |
| FIX BAS | 20,472 06-20-01 4:56p | Fix.bas |
| FRMGO˜18 FRM | 35,014 06-19-01 3:27p | frmGor2B2.frm |
| FRMGO˜20 FRX | 1,574 06-19-01 3:27p | frmGor2B2.frx |
| FRMLOGIN FRM | 14,397 06-20-01 5:08p | frmLogin.frm |
| FRMLOGIN FRX | 7,440 06-20-01 5:08p | frmLogin.frx |
| G4W2B2 MDB | 237,568 03-07-01 11:27a | G4W2B2.mdb |
| GOR2B2 EXE | 360,448 06-20-01 5:09p | Gor2B2.exe |
| GOR2B2 LOG | 9,324 06-25-01 4:38p | Gor2B2.log |
| GOR2B2 MDB | 499,712 06-26-01 9:21a | gor2B2.mdb |
| GOR2B2 VBP | 2,271 06-20-01 5:09p | Gor2B2.vbp |
| GOR2B2 VBW | 947 06-27-01 4:38p | Gor2B2.vbw |
| GOR2W˜38 EXE | 360,448 06-28-01 2:36p | Gor2B2_debug.exe |
| GOR2B˜40 MDB | 1,816,576 06-19-01 3:44p | gor2B2_old.mdb |
| MODCO˜42 BAS | 60,874 06-20-01 4:26p | modConvert.bas |
| MODMAIN BAS | 472 06-20-01 4:41p | modMain.bas |
| MODTI˜46 BAS | 8,578 06-19-01 2:51p | modTitleLogicHelper.bas |
| PROGRESS FRM | 2,997 03-07-01 11:27a | Progress.frm |
| PROGRESS FRX | 1,090 03-07-01 11:27a | PROGRESS.FRX |
| UTILITY MDB | 802,816 06-26-01 9:21a | Utility.mdb |
| | 23 file(s) 4,250,857 bytes | |

Directory of E:\Gor2B2\empty db for 1.x to 2.1 conversion

| | | |
|---|---|---|
| . | <DIR> | 07-06-01 11:13a . |
| .. | <DIR> | 07-06-01 11:13a .. |
| B21 MDB | 6,295,552 06-27-01 10:11a | B21.mdb |
| | 1 file(s) 6,295,552 bytes | |

Directory of E:\Graphics

| | | |
|---|---|---|
| . | <DIR> | 07-06-01 11:13a . |
| .. | <DIR> | 07-06-01 11:13a .. |
| 8MILLION | <DIR> | 07-06-01 11:13a 8Million |
| 90DAY˜8 ICO | 318 03-07-01 11:27a | 90 Day.ico |
| ACCOUNT ICO | 766 03-07-01 11:27a | account.ico |
| ACTION BMP | 1,350 03-07-01 11:27a | action.bmp |
| ADDREA˜14 BMP | 1,062 03-07-01 11:27a | Address_Bungle.bmp |
| BANDED BMP | 5,318 03-07-01 11:27a | banded.bmp |
| BGM BMP | 246 03-07-01 11:27a | bgm.bmp |
| BGMLBL BMP | 246 03-07-01 11:27a | bgmlbl.bmp |
| BGM_ARB BMP | 246 03-07-01 11:27a | bgm_arb.bmp |
| BIRTHDAY ICO | 318 03-07-01 11:27a | birthday.ico |
| CHECK BMP | 246 03-07-01 11:27a | check.bmp |
| CHECK ICO | 198 03-07-01 11:27a | check.ico |
| CLASS˜30 BMP | 5,318 03-07-01 11:27a | classical.bmp |
| CLIP BMP | 374 03-07-01 11:27a | clip.bmp |
| COMBO BMP | 246 03-07-01 11:27a | combo.bmp |
| COMPO˜36 BMP | 5,318 03-07-01 11:27a | composite.bmp |
| CONTA˜38 BMP | 1,006 03-07-01 11:27a | ContactGroup.bmp |
| CONTE˜40 BMP | 5,318 03-07-01 11:27a | contemporary.bmp |
| DATA BMP | 246 03-07-01 11:27a | data.bmp |
| DATE BMP | 246 03-07-01 11:27a | date.bmp |
| DELETECG ICO | 318 04-17-01 10:22a | DeleteCG.ico |
| DOTDO˜48 BMP | 230 04-25-01 9:16a | dotdotdot.bmp |
| DOWN BMP | 230 03-07-01 11:27a | down.bmp |
| DOWN ICO | 766 03-07-01 11:27a | down.ico |
| DUEEMAIL ICO | 766 03-07-01 11:27a | dueemail.ico |
| DUEFAX ICO | 766 03-07-01 11:27a | dueFax.ico |
| DUEPRINT ICO | 766 03-07-01 11:27a | duePrint.ico |
| ELEGANT BMP | 5,318 03-07-01 11:27a | elegant.bmp |
| EMAIL ICO | 1,078 03-07-01 11:27a | email.ico |
| ENVNE˜64 BMP | 246 03-15-01 5:24p | env new jrview.bmp |
| ERASE BMP | 246 03-07-01 11:27a | erase.bmp |
| EXIT ICO | 766 03-07-01 11:27a | exit.ico |
| EXPORT BMP | 15,318 03-07-01 11:27a | export.bmp |
| FAX ICO | 766 03-07-01 11:27a | fax.ico |
| FINDER BMP | 2,038 03-07-01 11:27a | finder.bmp |
| FOOTBALL BMP | 246 03-07-01 11:27a | FootBall.bmp |
| FOOTBALL ICO | 318 03-07-01 11:27a | Football.ico |
| FORM BMP | 5,318 03-07-01 11:27a | form.bmp |
| GOREYE ICO | 766 03-07-01 11:27a | GorEye.ico |
| GROUP ICO | 766 03-07-01 11:27a | group.ico |
| IINFO˜86 BMP | 1,006 03-07-01 11:27a | iinfo_none.bmp |
| INSTA˜88 BMP | 549,496 03-07-01 11:27a | installer.bmp |
| JRIEC˜90 BMP | 822 03-07-01 11:27a | JrIECheckmark.bmp |
| JRIEX˜92 BMP | 822 03-07-01 11:27a | JrIEXMark.bmp |
| JRIE˜94 BMP | 822 03-07-01 11:27a | jr ie.bmp |
| JUNIO˜96 ICO | 318 03-07-01 11:27a | junior ie.ico) |
| LABEL BMP | 5,318 03-07-01 11:27a | label.bmp |
| LETT˜100 BMP | 1,334 03-07-01 11:27a | lettersent.bmp |
| LETT˜102 BMP | 886 03-07-01 11:27a | lettersetup.bmp |
| LIST BMP | 246 03-07-01 11:27a | list.bmp |
| LISTVIEW BMP | 246 03-07-01 11:27a | listview.bmp |
| LOGIN BMP | 324,872 03-07-01 11:27a | login.bmp |
| LOGO BMP | 6,334 03-07-01 11:27a | logo.bmp |
| LTR | <DIR> | 07-06-01 11:13a LTR |
| MACRO ICO | 766 03-07-01 11:27a | Macro.ico |
| MONEY ICO | 766 03-07-01 11:27a | money.ico |
| NEW2˜9 IGR | <DIR> 07-06-01 11:13a | new 2.1 graphics |
| NEWT˜120 BMP | 822 05-11-01 2:23p | new treeview dropdown.bmp |
| NO_C˜122 ICO | 318 03-07-01 11:27a | No_Contact.ico |
| OBJE˜124 BMP | 1,438 03-07-01 11:27a | objective.bmp |
| OPPO˜126 BMP | 1,254 03-07-01 11:27a | opportunity due.bmp |
| OVER˜128 BMP | 1,254 03-07-01 11:27a | over review interval.bmp |
| PRINT ICO | 766 03-07-01 11:27a | Print.ico |
| PRINTER ICO | 318 03-07-01 11:27a | printer.ico |
| PROF˜134 BMP | 5,318 03-07-01 11:27a | professional.bmp |
| REMINDER BMP | 246 03-07-01 11:27a | reminder.bmp |
| REMINDER ICO | 766 03-07-01 11:27a | Reminder.ico |
| REMI˜140 BMP | 246 03-07-01 11:27a | ReminderCheck.bmp |
| REMI˜142 ICO | 318 03-07-01 11:27a | reminder16.ico |
| REMI˜144 BMP | 246 03-07-01 11:27a | ReminderCheck_print.bmp |
| REMI˜146 ICO | 318 03-07-01 11:27a | Reminder_Chk.ico |
| REMI˜148 BMP | 246 03-07-01 11:27a | reminder_print.bmp |
| SB BMP | 3,126 03-07-01 11:27a | sb.bmp |
| SB PNG | 1,926 03-07-01 11:27a | sb.png |
| SBCA˜154 ICO | 318 03-07-01 11:27a | SBCategory.ico |
| SBGROUP ICO | 318 03-07-01 11:27a | SBGroup.ico |
| SCHED BMP | 1,194 03-07-01 11:27a | sched.bmp |
| SCHE˜160 BMP | 1,334 03-07-01 11:27a | scheduled object.bmp |
| SCHE˜162 ICO | 318 03-07-01 11:27a | scheduler.ico |
| SCHE˜164 BMP | 1,334 03-07-01 11:27a | scheduled.bmp |
| SHED BMP | 438 03-07-01 11:27a | shed.bmp |
| SMAL˜168 ICO | 318 03-07-01 11:27a | smallMoney.ico |
| SMGOREYE ICO | 318 03-07-01 11:27a | smGorEye.ico |
| SPEE˜172 ICO | 318 03-07-01 11:27a | speedbutton.ico |
| SPLASH BMP | 37,978 03-07-01 11:27a | splash.bmp |
| SPLASHL BMP | 421,974 03-07-01 11:27a | SPLASHL.BMP |
| TVWICON BMP | 758 03-07-01 11:27a | tvwIcon.bmp |
| UNCHECK ICO | 318 03-07-01 11:27a | uncheck.ico |
| URL BMP | 822 03-07-01 11:27a | url.bmp |
| WIZARD ICO | 766 03-07-01 11:27a | wizard.ico |
| ZACAR˜11 | <DIR> 07-06-01 11:13a | zac art |
| | 87 file(s) 1,447,222 bytes | |

Directory of E:\Graphics\8Million

| | | |
|---|---|---|
| . | <DIR> | 07-06-01 11:13a . |
| .. | <DIR> | 07-06-01 11:13a .. |
| FLDARR BMP | 246 03-07-01 11:27a | fldarr.bmp |
| FLDARR ICO | 318 03-07-01 11:27a | fldarr.ico |
| FLDAR˜10 BMP | 246 03-07-01 11:27a | fldarr_print.bmp |
| FLDCHK BMP | 246 03-07-01 11:27a | fldchk.bmp |
| FLDCHK ICO | 318 03-07-01 11:27a | fldchk.ico |
| FLDCH˜16 BMP | 246 03-07-01 11:27a | fldchk_print.bmp |
| FLDRX BMP | 246 03-07-01 11:27a | fldrx.bmp |
| FLDRX ICO | 318 03-07-01 11:27a | fldrx.ico |
| FLDRX˜22 BMP | 246 03-07-01 11:27a | fldrx_print.bmp |
| LETTE˜24 ICO | 318 03-07-01 11:27a | LetterSent16.ico |
| LIT BMP | 246 03-07-01 11:27a | lit.bmp |
| LIT16 ICO | 318 03-07-01 11:27a | lit16.ico |
| LITARR BMP | 246 03-07-01 11:27a | litarr.bmp |
| LITARR ICO | 318 03-07-01 11:27a | litarr.ico |
| LITAR˜34 BMP | 246 03-07-01 11:27a | litarr_print.bmp |
| LITCHECK BMP | 246 03-07-01 11:27a | litcheck.bmp |
| LITCH˜38 BMP | 246 03-07-01 11:27a | litcheck_print.bmp |
| LITCHK ICO | 318 03-07-01 11:27a | litchk.ico |
| LITENING ICO | 1,078 03-07-01 11:27a | LITENING.ICO |
| LITX BMP | 246 03-07-01 11:27a | litx.bmp |
| LITX ICO | 318 03-07-01 11:27a | litx.ico |
| LITX_˜48 BMP | 246 03-07-01 11:27a | litx_print.bmp |
| LIT_P˜50 BMP | 246 03-07-01 11:27a | lit_print.bmp |
| MASSMAlL BMP | 246 03-07-01 11:27a | MassMail.bmp |
| MASSM˜54 BMP | 246 03-07-01 11:27a | MassMail_Check.bmp |
| MASSM˜56 ICO | 318 03-07-01 11:27a | Massmail16.ico |
| MASSM˜58 BMP | 246 03-07-01 11:27a | MassMail_Check_print.bmp |
| MASSM˜60 ICO | 318 03-07-01 11:27a | Massmail_chk16.ico |
| MASSM˜62 BMP | 246 03-07-01 11:27a | MassMail_print.bmp |
| OPENF˜64 ICO | 318 03-07-01 11:27a | OpenFldr16.ico |
| OPENFOLD ICO | 1,078 03-07-01 11:27a | OPENFOLD.ICO |
| OPENF˜68 BMP | 246 03-07-01 11:27a | openfolder.bmp |
| OPENF˜70 BMP | 246 03-07-01 11:27a | openfolder_print.bmp |
| | 33 file(s) | 10,574 bytes |

Directory of E:\Graphics\LTR

| | | |
|---|---|---|
| . | <DIR> | 07-06-01 11:13a . |
| .. | <DIR> | 07-06-01 11:13a .. |
| ATTACH˜6 BMP | 246 03-07-01 11:27a | Attachment.bmp |
| ATTACH˜8 ICO | 318 03-07-01 11:27a | Attachment.ico |
| ATTAC˜10 BMP | 246 03-07-01 11:27a | attachment1.bmp |
| ATTAC˜12 BMP | 246 03-07-01 11:27a | attachment2.bmp |
| LETTER BMP | 246 03-07-01 11:27a | Letter.bmp |
| LETTER1 BMP | 246 03-07-01 11:27a | Letter1.bmp |
| LETTER2 BMP | 246 03-07-01 11:27a | Letter2.bmp |
| SCRIPT BMP | 246 03-07-01 11:27a | Script.bmp |
| SCRIPT1 BMP | 246 03-07-01 11:27a | Script1.bmp |
| SCRIPT2 BMP | 246 03-07-01 11:27a | Script2.bmp |
| | 10 file(s) | 2,532 bytes |

Directory of E:\Graphics\new 2.1 graphics

| | | |
|---|---|---|
| . | <DIR> | 07-06-01 11:13a . |
| .. | <DIR> | 07-06-01 11:13a .. |
| 16ICON ICO | 1,406 03-07-01 11:27a | 16icon.ico |
| 32ICON ICO | 2,238 03-07-01 11:27a | 32icon.ico |
| ABOUT˜10 BMP | 630,056 03-07-01 11:27a | about1play.bmp |
| ABOUT˜12 BMP | 630,056 03-07-01 11:27a | about screen - release.bmp |
| ICON16 BMP | 824 03-07-01 11:27a | icon16.bmp |
| ICON32 BMP | 3,128 03-07-01 11:27a | icon32.bmp |
| ICON64 BMP | 12,344 03-07-01 11:27a | icon64.bmp |
| INSTA˜20 BMP | 1,276,856 03-07-01 11:27a | installer1.bmp |
| LOGIN1 BMP | 630,056 03-07-01 11:28a | login1.bmp |
| LOGIN˜24 BMP | 630,056 03-07-01 11:28a | login1-play.bmp |
| SELEC˜26 ICO | 1,406 05-08-01 8:46a | selection rule refinement.ico |
| SPLASH BMP | 630,056 03-07-01 11:28a | splash.bmp |
| SPLAS˜30 BMP | 630,056 03-07-01 11:28a | splash-play.bmp |
| | 13 file(s) 5,078,538 bytes | |

Directory of E:\Graphics\zac art

| | | |
|---|---|---|
| . | <DIR> | 07-06-01 11:13a . |
| .. | <DIR> | 07-06-01 11:13a .. |
| NEWSCR˜5 | <DIR> 07-06-01 11:13a | New Screen (Sept 19th) |
| PROGRA˜7 | <DIR> 07-06-01 11:13a | program icons |
| SPEED˜10 BMP | 3,128 03-07-01 11:28a | speedbutton.bmp |
| SPLAS˜12 BMP | 630,056 03-07-01 11:28a | splashscreen.bmp |
| WIZARD˜9 | <DIR> 07-06-01 11:13a | Wizard Pictures |
| | 2 file(s) | 633,184 bytes |

Directory of E:\Graphics\zac art\New Screen (Sept 19th)

| | | |
|---|---|---|
| . | <DIR> | 07-06-01 11:13a . |
| .. | <DIR> | 07-06-01 11:13a .. |
| ABOUT BMP | 630,056 03-07-01 11:28a | about.bmp |
| NEWSPL˜8 BMP | 630,056 03-07-01 11:28a | newsplash.bmp |
| PLAYG˜10 BMP | 630,056 03-07-01 11:28a | playground-about.bmp |
| PLAYG˜12 BMP | 630,056 03-07-01 11:28a | playgroundsplash.bmp |
| | 4 file(s) 2,520,224 bytes | |

Directory of E:\Graphics\zac art\program icons

| | | |
|---|---|---|
| . | <DIR> | 07-06-01 11:13a . |
| .. | <DIR> | 07-06-01 11:13a .. |
| 16 | ICO 2,238 03-07-01 11:28a | 16.ico |
| 32 | ICO 2,238 03-07-01 11:28a | 32.ico |
| | 2 file(s) | 4,476 bytes |

Directory of E:\Graphics\zac art\Wizard Pictures

| | | |
|---|---|---|
| . | <DIR> | 07-06-01 11:13a . |
| .. | <DIR> | 07-06-01 11:13a .. |
| SATELL˜5 | <DIR> 07-06-01 11:13a | Satellite (Jr) Wizard |
| VANDAL˜7 | <DIR> 07-06-01 11:13a | Vandalay Import Wizard |
| | 0 file(s) | 0 bytes |

Directory of E:\Graphics\zac art\Wizard Pictures\Satellite (Jr) Wizard

| | | |
|---|---|---|
| . | <DIR> | 07-06-01 11:13a . |
| .. | <DIR> | 07-06-01 11:13a .. |
| MOTHER˜6 BMP | 143,056 03-07-01 11:28a | mothertosatellite-mth.bmp |
| MOTHER˜8 BMP | 143,056 03-07-01 11:28a | mothertosatellite-stl.bmp |
| NEWSA˜10 BMP | 143,056 03-07-01 11:28a | newsatellite-mth.bmp |
| ORPHA˜12 BMP | 143,056 03-07-01 11:28a | orphansatellite.bmp |
| SATEL˜14 BMP | 143,056 03-07-01 11:28a | satellitetomother-mth.bmp |
| SATEL˜16 BMP | 143,056 03-07-01 11:28a | satellitetomother-stl.bmp |
| | 6 file(s) | 858,336 bytes |

Directory of E:\Graphics\zac art\Wizard Pictures\Vandalay Import Wizard

| | | |
|---|---|---|
| . | <DIR> | 07-06-01 11:13a . |
| .. | <DIR> | 07-06-01 11:13a .. |
| IMPORT˜6 BMP | 143,056 03-07-01 11:28a | importsummary.bmp |
| MATCHS˜8 BMP | 143,056 03-07-01 11:28a | matchstaffgroups.bmp |
| SELEC˜10 BMP | 143,056 03-07-01 11:28a | selectimportfile.bmp |
| | 3 file(s) | 429,168 bytes |

Directory of E:\Help

| | | |
|---|---|---|
| . | <DIR> | 07-06-01 11:13a . |
| .. | <DIR> | 07-06-01 11:13a .. |
| BASELI˜5 | <DIR> 07-06-01 11:13a | baseline help |
| GORILLA CNT | 43,773 07-03-01 4:21p | Gorilla.cnt |
| GORILLA HLP | 931,238 07-05-01 10:34a | Gorilla.hlp |
| TEXTIMP HLP | 7,313 05-23-01 9:54a | TEXTIMP.HLP |
| VANDALAY HLP | 7,057 03-07-01 11:28a | VANDALAY.HLP |
| | 4 file(s) | 989,381 bytes |

Directory of E:\Help\baseline help

| | | |
|---|---|---|
| . | <DIR> | 07-06-01 11:13a . |
| .. | <DIR> | 07-06-01 11:13a .. |
| DTSHELP RTF | 38,654 03-07-01 11:28a | dtshelp.rtf |
| INFOSH˜8 BMP | 149,078 03-07-01 11:28a | INFO SHEET.bmp |
| INFOS˜10 SHG | 39,698 03-07-01 11:28a | INFOSHEET.SHG |
| M2HELP FTS | 26,112 03-07-01 11:28a | m2help.FTS |
| M2HELP HLP | 127,309 03-07-01 11:28a | M2HELP.HLP |
| M2HELP HPJ | 105 03-07-01 11:28a | m2help.hpj |
| RULPA˜18 BMP | 120,418 03-07-01 11:28a | RULP add FUTAS.bmp |
| RULPA˜20 BMP | 120,418 03-07-01 11:28a | RULP add KEYWORLD.bmp |
| RULPA˜22 BMP | 312,282 03-07-01 11:28a | RULP add NOTE.bmp |
| RULPF˜24 SHG | 24,764 03-07-01 11:28a | RULP FUTAS.SHG |
| RULPK˜26 SHG | 26,466 03-07-01 11:28a | RULP KEYWORD.SHG |
| RULPN˜28 SHG | 16,438 03-07-01 11:28a | RULP NOTE.SHG |
| | 12 file(s) 1,001,742 bytes | |

Directory of E:\ImportDatabase

| | | |
|---|---|---|
| . | <DIR> | 07-06-01 11:13a . |
| .. | <DIR> | 07-06-01 11:13a .. |
| B2STUFF BAS | 29,225 06-14-01 2:51p | B2Stuff.bas |
| CANIMATE CLS | 9,254 03-19-01 5:03p | CAnimate.cls |
| CAVIH˜10 CLS | 2,965 03-19-01 5:03p | cAVIHelper.cls |
| CLSCRC CLS | 2,901 03-19-01 5:03p | clsCRC.cls |
| CLSDU˜14 CLS | 2,099 03-07-01 11:28a | clsDuplicateItem.cls |
| CLSEN˜16 CLS | 23,936 03-19-01 5:03p | clsEncrypt.cls |
| CONVE˜18 VBP | 1,404 05-23-01 9:54a | Convert21.vbp |
| EXPORT FRM | 40,722 03-19-01 5:03p | Export.frm |
| EXPORT FRX | 1,126 03-07-01 11:28a | Export.frx |
| FOLDE˜24 CLS | 485 03-07-01 11:28a | FolderLeaf.cls |
| FRMAVI FRM | 3,267 03-19-01 5:03p | frmAVI.frm |
| FRMAVI FRX | 12 03-19-01 5:03p | frmAVI.frx |
| FRMCH˜30 FRM | 3,787 03-07-01 11:28a | frmChooseDirectory.frm |
| FRMCH˜32 FRX | 1,090 03-07-01 11:28a | frmChooseDirectory.frx |
| FRMCO˜34 FRM | 7,134 05-23-01 9:54a | frmConvert21.frm |
| FRMCO˜36 FRX | 1,902 05-21-01 3:36p | frmConvert21.frx |
| FRMDB˜38 FRM | 13,309 03-07-01 11:28a | frmDBPath.frm |
| FRMDB˜40 FRX | 2,300 03-07-01 11:28a | frmDBPath.frx |
| FRMEX˜42 FRM | 117,170 07-05-01 6:34p | frmExportWizard.frm |
| FRMEX˜44 FRX | 576,006 06-18-01 11:34a | frmExportWizard.frx |
| FRMFI˜46 FRM | 10,703 03-19-01 5:03p | frmFixDuplicates.frm |
| FRMFI˜48 FRX | 1,090 03-07-01 11:28a | frmFixDuplicates.frx |
| FRMIM˜50 FRM | 56,083 04-27-01 5:05p | frmImportWizard.frm |
| FRMIM˜52 FRX | 484 04-25-01 5:08p | frmImportWizard.frx |
| FRMST˜54 FRM | 9,490 03-07-01 11:28a | frmStaffGroupMatch.frm |
| FRMST˜56 FRX | 1,090 03-07-01 11:28a | frmStaffGroupMatch.frx |
| FRMWAIT FRM | 2,637 03-26-01 10:50a | frmWait.frm |
| FRMYE˜60 FRM | 3,041 03-07-01 11:28a | frmYesNoAll.frm |
| FRMYE˜62 FRX | 1,090 03-07-01 11:28a | frmYesNoAll.frx |
| IMPORT FRM | 16,577 03-07-01 11:28a | Import.frm |
| IMPORT FRX | 1,090 03-07-01 11:28a | Import.frx |
| IMPORTDB EXE | 1,114,153 07-05-01 5:39p | ImportDB.exe |
| IMPOR˜70 EXE | 585,777 04-25-01 5:08p | ImportExportUtil.exe |
| IMPOR˜72 VBP | 1,948 05-21-01 3:36p | ImportDatabase.vbp |
| IMPOR˜74 VBP | 1,926 06-29-01 10:34a | ImportExportUtil.vbp |
| MODCO˜76 BAS | 417 05-21-01 3:36p | modConvert.bas |
| MODEX˜78 BAS | 45,408 06-29-01 4:46p | modExport.bas |
| MODHO˜80 BAS | 30,343 06-29-01 3:58p | modHotdog.bas |
| MODIM˜82 BAS | 148,797 07-05-01 6:34p | modImport.bas |
| NODEH˜84 CLS | 392 03-07-01 11:28a | NodeHolder.cls |
| STITCH RES | 9,552 03-19-01 5:03p | stitch.res |
| VANDALAY EXE | 786,473 05-25-01 4:44p | Vandalay.exe |
| | 42 file(s) 3,668,655 bytes | |

Directory of E:\Import Wizards (Distributables)

| | | |
|---|---|---|
| . | <DIR> | 07-06-01 11:13a . |
| .. | <DIR> | 07-06-01 11:13a .. |
| TEXTEX˜6 DLL | 397,312 06-26-01 9:21a | TextExpWiz.dll |
| | 1 file(s) | 397,312 bytes |

Directory of E:\Import Wizards

| | | |
|---|---|---|
| . | <DIR> | 07-06-01 11:13a . |
| .. | <DIR> | 07-06-01 11:13a .. |
| | 0 file(s) | 0 bytes |

Directory of E:\Import & Export

| | | |
|---|---|---|
| . | <DIR> | 07-06-01 11:13a . |
| .. | <DIR> | 07-06-01 11:13a .. |
| CLSCGT˜6 CLS | 60,428 07-05-01 6:34p | clsCGTXFR.cls |
| FRMEXP˜8 FRM | 10,208 03-07-01 11:28a | frmExportImportantInfoOpt.frm |
| FRMEX˜10 FRM | 7,739 03-07-01 11:28a | frmExportPhoneOpt.frm |
| FRMEX˜12 FRM | 6,638 03-07-01 11:28a | frmExportIntrestsOpt.frm |
| FRMEX˜14 FRM | 13,371 03-07-01 11:28a | frmExportDelimitOpt.frm |
| FRMEX˜16 FRM | 11,226 03-07-01 11:28a | frmExportIDNumsOpt.frm |
| FRMEX˜18 FRM | 7,710 03-07-01 11:28a | frmExportFormat.frm |
| FRMEX˜20 FRM | 11,986 03-07-01 11:28a | frmExportStatusOpt.frm |
| FRMEX˜22 FRM | 8,764 03-07-01 11:28a | frmExportFileName.frm |
| FRMEX˜24 FRM | 6,516 03-07-01 11:28a | frmExportFinish.frm |
| FRMEX˜26 FRM | 14,258 03-07-01 11:28a | frmExportStart.frm |
| FRMEX˜28 FRM | 7,664 03-07-01 11:28a | frmExportEMailOpt.frm |
| FRMEX˜30 FRM | 9,757 03-07-01 11:28a | frmExportFixedOpt.frm |
| FRMEX˜32 FRM | 20,498 03-07-01 11:28a | frmExportNotesOpt.frm |
| FRMEX˜34 FRM | 10,607 03-07-01 11:28a | frmExportNameOpt.frm |
| FRMEX˜36 FRM | 20,811 03-07-01 11:28a | frmExportHistoryOpt.frm |
| FRMEX˜38 FRM | 19,164 03-07-01 11:28a | frmExport.frm |
| FRMEX˜40 FRM | 6,633 03-07-01 11:28a | frmExportAccountsOpt.frm |
| FRMEX˜42 FRM | 11,412 03-07-01 11:28a | frmExportAddressOpt.frm |
| FRMEX˜44 FRM | 11,148 03-07-01 11:28a | frmExportDatesOpt.frm |
| FRMIM˜46 FRM | 15,945 07-05-01 6:34p | frmImportExport.frm |
| FRMIM˜48 FRX | 1,090 03-07-01 11:28a | frmImportExport.frx |
| FRMWI˜50 FRM | 7,704 03-07-01 11:28a | frmWizardPage1.frm |
| FRMWI˜52 FRM | 13,425 03-07-01 11:28a | frmWizardPage2.frm |
| FRMWI˜54 FRM | 12,020 03-07-01 11:28a | frmWizardPage3.frm |
| FRMWI˜56 FRM | 20,854 03-07-01 11:28a | frmWizardPage4.frm |
| IMPOR˜58 BAS | 821 03-07-01 11:28a | ImportWizard.bas |
| MODEX˜60 BAS | 9,830 03-07-01 11:28a | modExportWiz.bas |
| | 28 file(s) | 358,227 bytes |
| FRMSE˜32 FRM | 114,912 07-05-01 6:34p | frmSetupNewLetter.frm |
| FRMSE˜34 FRX | 7,251 06-06-01 3:33p | frmSetupNewLetter.frx |
| MODLE˜36 BAS | 158,253 07-05-01 6:34p | modLetters.bas |
| | 16 file(s) | 457,176 bytes |

Directory of E:\Library

| | | |
|---|---|---|
| . | <DIR> | 07-06-01 11:13a . |
| .. | <DIR> | 07-06-01 11:13a .. |
| ACCESS BAS | 9,136 03-07-01 11:28a | Access.bas |
| ASSERT BAS | 6,830 07-05-01 6:34p | assert.bas |
| ASSERT FRM | 3,274 07-05-01 6:34p | assert.frm |
| ASSERT FRX | 2,180 03-07-01 11:28a | assert.frx |
| CLSCRC CLS | 2,901 07-05-01 6:34p | clsCRC.cls |
| CLSEN˜16 CLS | 8,102 03-07-01 11:28a | clsEncryptSimple.cls |
| CLSHO˜18 CLS | 1,531 07-05-01 6:34p | clsHourglass.cls |
| CLSPR˜20 CLS | 8,997 07-05-01 6:34p | clsPrintData.cls |
| CLSRE˜22 CLS | 91,675 07-05-01 6:34p | clsRefresh.cls |
| COMMDLG BAS | 1,657 07-05-01 6:34p | CommDlg.bas |
| DBCONST BAS | 231,201 07-05-01 5:54p | DBConst.bas |
| DBITEMS BAS | 43,377 07-05-01 6:34p | DBItems.bas |
| DBTAB˜30 BAS | 55,172 07-05-01 6:34p | DBTableConst.BAS |
| FILES˜32 BAS | 10,177 07-05-01 6:34p | FileSystem.bas |
| FOLDE˜34 CLS | 581 07-05-01 6:34p | FolderLeaf.cls |
| HELPCTX BAS | 21,247 07-05-01 5:54p | HelpCtx.bas |
| MAIN BAS | 298 03-07-01 11:28a | Main.bas |
| MISC BAS | 108,801 07-05-01 6:34p | Misc.bas |
| MODAD˜42 BAS | 29,606 07-05-01 6:34p | modAddressLogic.bas |
| MODCH˜44 BAS | 3,575 07-05-01 6:34p | modCheckBoxListBox.bas |
| MODDE˜46 BAS | 60,629 07-05-01 6:34p | modDeleteEntity.bas |
| MODFO˜48 BAS | 40,955 07-05-01 6:34p | modFolders.bas |
| MODKE˜50 BAS | 11,621 07-05-01 6:34p | modKeysForSSListBar.bas |
| MODLI˜52 BAS | 10,909 07-05-01 6:34p | modLicense.bas |
| MODPR˜54 BAS | 8,453 07-05-01 6:34p | modPrinter.bas |
| MODSA˜56 BAS | 84,703 07-05-01 6:34p | modSatellite.bas |
| MODTI˜58 BAS | 45,305 07-05-01 6:34p | modTitleLogic.bas |
| MSWORD BAS | 137,079 07-05-01 6:34p | MSWord.bas |
| REGFN BAS | 15,886 07-05-01 6:34p | RegFN.bas |
| REGISTRY BAS | 25,859 07-05-01 6:34p | Registry.bas |
| SELRULES BAS | 4,663 07-05-01 6:34p | SelRules.bas |
| WINDO˜68 BAS | 18,211 07-05-01 6:34p | WindowsFunctions.bas |
| | 32 file(s) 1,104,591 bytes | |

Directory of E:\Indivs

| | | |
|---|---|---|
| . | <DIR> | 07-06-01 11:13a . |
| .. | <DIR> | 07-06-01 11:13a .. |
| ASSOCI˜6 FRM | 19,941 07-05-01 6:34p | associated persons.frm |
| ASSOCI˜8 FRX | 1,574 04-18-01 3:10p | associated persons.frx |
| FRMBD˜10 FRM | 38,831 07-05-01 6:34p | frmBDayWizard.frm |
| FRMBD˜12 FRX | 2,166 06-26-01 2:27p | frmBDayWizard.frx |
| FRMIN˜14 FRM | 43,020 07-05-01 6:34p | frmIndividuals.frm |
| FRMIN˜16 FRX | 4,282 05-09-01 10:22a | frmIndividuals.frx |
| MODINDV BAS | 24,526 07-05-01 6:34p | modIndv.bas |
| MULTI˜20 FRM | 63,200 07-05-01 6:34p | Multi-Page Picture Wizard.frm |
| MULTI˜22 FRX | 7,136 03-07-01 11:28a | Multi-Page Picture Wizard.frx |
| | 9 file(s) | 204,676 bytes |

Directory of E:\Junior System

| | | |
|---|---|---|
| . | <DIR> | 07-06-01 11:13a . |
| .. | <DIR> | 07-06-01 11:13a .. |
| FRMJUN˜6 FRM | 73,848 07-05-01 6:34p | frmJuniorIEWiz.frm |
| FRMJUN˜8 FRX | 664,262 07-05-01 1:48p | frmJuniorIEWiz.frx |
| FRMSA˜10 FRM | 23,792 07-05-01 6:34p | frmSatelliteUserIEWiz.frm |
| FRMSA˜12 FRX | 289,098 03-07-01 11:28a | frmSatelliteUserIEWiz.frx |
| | 4 file(s) 1,051,000 bytes | |

Directory of E:\LetterSetup

| | | |
|---|---|---|
| . | <DIR> | 07-06-01 11:13a . |
| .. | <DIR> | 07-06-01 11:13a .. |
| FRMADD˜6 FRM | 6,431 07-05-01 6:34p | frmAddAttch.frm |
| FRMADD˜8 FRX | 918 03-07-01 11:28a | frmAddAttch.frx |
| FRMEM˜10 FRM | 6,158 03-07-01 11:28a | frmEmailProperties.frm |
| FRMLE˜12 FRM | 49,106 07-05-01 6:34p | frmLetterPrintRecovery.frm |
| FRMLE˜14 FRX | 1,090 06-29-01 3:53p | frmLetterPrintRecovery.frx |
| FRMLE˜16 FRM | 50,842 07-05-01 6:34p | frmLetterSetup.frm |
| FRMLE˜18 FRX | 9,880 03-07-01 11:28a | frmLetterSetup.frx |
| FRMLS˜20 FRM | 20,955 07-05-01 6:34p | frmLSUPQFilter.frm |
| FRMLS˜22 FRX | 210 03-07-01 11:28a | frmLSUPQFilter.frx |
| FRMME˜24 FRM | 8,957 07-05-01 6:34p | frmMergeFieldEditCMF.frm |
| FRMME˜26 FRX | 1,090 03-07-01 11:28a | frmMergeFieldEditCMF.frx |
| FRMME˜28 FRM | 20,033 07-05-01 6:34p | frmMergeFieldViewer.frm |
| FRMME˜30 FRX | 1,090 03-07-01 11:28a | frmMergeFieldViewer.frx |

Directory of E:\Office Policies

| | | |
|---|---|---|
| . | <DIR> | 07-06-01 11:13a . |
| .. | <DIR> | 07-06-01 11:13a .. |
| CLSOPDUE CLS | 1,170 07-05-01 5:55p | clsOPDue.cls |
| FRMOFF˜8 FRM | 45,407 07-05-01 6:34p | frmOfficePolicies.frm |
| FRMOF˜10 FRX | 5,699 05-22-01 11:48a | frmOfficePolicies.frx |
| FRMOF˜12 FRM | 19,929 07-05-01 6:34p | frmOfficeProceduresDue.frm |
| FRMOF˜14 FRX | 1,578 05-11-01 4:12p | frmOfficeProceduresDue.frx |
| FRMOP˜16 FRM | 2,108 06-12-01 5:09p | frmOPCoordinator.frm |
| FRMOP˜18 FRX | 2,478 06-12-01 5:09p | frmOPCoordinator.frx |
| OFFIC˜20 BAS | 41,758 07-05-01 6:34p | OfficeProcedures.bas |
| | 8 file(s) | 120,127 bytes |

Directory of E:\Old 20 database

| | | |
|---|---|---|
| . | <DIR> | 07-06-01 11:13a . |
| .. | <DIR> | 07-06-01 11:13a .. |
| B2 | MDB 3,803,136 05-31-01 10:51a | B2.mdb |
| | 1 file(s) 3,803,136 bytes | |

Directory of E:\Organizer

| | | |
|---|---|---|
| . | <DIR> | 07-06-01 11:13a . |
| .. | <DIR> | 07-06-01 11:13a .. |
| FRMATT˜6 FRM | 26,228 07-05-01 6:34p | frmAttchDef.frm |
| FRMATT˜8 FRX | 1,678 03-07-01 11:28a | frmAttchDef.frx |
| FRMCH˜10 FRM | 33,590 07-05-01 6:34p | frmChecklistDef.frm |
| FRMCH˜12 FRX | 974 03-07-01 11:28a | frmChecklistDef.frx |
| FRMEN˜14 FRM | 29,778 07-05-01 6:34p | frmEnvLabel.frm |
| FRMEN˜16 FRX | 1,408 03-07-01 11:28a | frmEnvLabel.frx |
| FRMLE˜18 FRM | 41,253 07-05-01 6:34p | frmLetterDef.frm |
| FRMLE˜20 FRX | 2,387 03-07-01 11:28a | frmLetterDef.frx |
| FRMOR˜22 FRM | 108,120 07-05-01 6:34p | frmOrganizerMain.frm |
| FRMOR˜24 FRX | 7,976 03-07-01 11:28a | frmOrganizerMain.frx |
| FRMPU˜26 FRM | 4,417 07-05-01 6:34p | frmPurgeCMF.frm |
| FRMPU˜28 FRX | 1,567 03-07-01 11:28a | frmPurgeCMF.frx |
| FRMSC˜30 FRM | 28,434 07-05-01 6:34p | frmScriptDef.frm |
| FRMSC˜32 FRX | 1,678 03-07-01 11:28a | frmScriptDef.frx |
| FRMSE˜34 FRM | 9,780 07-05-01 6:34p | frmSearchDocs.frm |
| FRMSE˜36 FRX | 1,197 03-07-01 11:28a | frmSearchDocs.frx |
| ORGAN˜38 BAS | 85,587 07-05-01 6:34p | Organizer.bas |
| | 17 file(s) | 386,052 bytes |

Directory of E:\popups

| | | |
|---|---|---|
| . | <DIR> | 07-06-01 11:13a . |
| .. | <DIR> | 07-06-01 11:13a .. |
| CLSDAY˜6 CLS | 884 07-05-01 6:34p | clsDayViewPopupParam.cls |
| FRMADD˜8 FRM | 30,471 07-05-01 6:34p | frmAddressBundle_Popup.frm |
| FRMAD˜10 FRX | 2,416 03-07-01 11:28a | frmAddressBundle_Popup.frx |
| FRMCH˜12 FRM | 4,954 07-05-01 6:34p | frmChooseDuplicates.frm |
| FRMCH˜14 FRX | 1,418 03-07-01 11:28a | frmChooseDuplicates.frx |
| FRMDA˜16 FRM | 11,081 07-05-01 6:34p | frmDayViewPopup.frm |
| FRMDA˜18 FRX | 84 04-05-01 2:38p | frmDayViewPopup.frx |
| FRMII˜20 FRM | 2,933 07-05-01 6:34p | frmIInfo_Popup.frm |
| FRMTV˜22 FRM | 19,920 07-05-01 6:34p | frmTVWPopUp.frm |
| FRMTV˜24 FRX | 4,764 03-07-01 11:28a | frmTVWPopUp.frx |
| | 10 file(s) | 78,925 bytes |

Directory of E:\Reports

| | | |
|---|---|---|
| . | <DIR> | 07-06-01 11:13a . |
| .. | <DIR> | 07-06-01 11:13a .. |
| CLSDAT˜6 CLS | 466 07-05-01 6:34p | clsDateParams.cls |
| CLSFUN˜8 CLS | 6,574 07-05-01 6:34p | clsFundsDueOptions.cls |
| CLSIN˜10 CLS | 5,589 07-05-01 6:34p | clsInfoSheetOptions.cls |
| CLSNO˜12 CLS | 3,692 07-05-01 6:34p | clsNoContactReportOptions.cls |
| CLSPR˜14 CLS | 5,474 07-05-01 6:34p | clsPrinterProps.cls |
| CLSRE˜16 CLS | 9,566 07-05-01 6:34p | clsReferralOptions.cls |
| CLSRS˜18 CLS | 8,342 07-05-01 6:34p | clsRSPrint.cls |
| CLSRS˜20 CLS | 1,400 07-05-01 6:34p | clsRSPrintField.cls |
| CLSRS˜22 CLS | 2,113 07-05-01 6:34p | clsRSPrintRow.cls |
| CLSWE˜24 CLS | 1,306 07-05-01 6:34p | clsWeeklyStatOptions.cls |
| FRMPR˜26 FRX | 101,843 05-18-01 5:13p | frmPrintInfoSheet.frx |
| FRMPR˜28 FRM | 32,654 07-05-01 6:34p | frmPrintInfoSheet.frm |
| FRMPR˜30 FRM | 8,255 07-05-01 6:34p | frmPrintSROptions.frm |
| FRMPR˜32 FRX | 576 03-07-01 11:28a | frmPrintSROptions.frx |
| FRMPR˜34 FRM | 17,351 07-05-01 6:34p | frmPrintReferralOptions.frm |
| FRMPR˜36 FRX | 1,056 05-09-01 10:16a | frmPrintReferralOptions.frx |
| FRMPR˜38 FRX | 86,485 04-25-01 9:37a | frmPrint_TodaysUpdates.frx |
| FRMPR˜40 FRM | 15,139 07-05-01 6:34p | frmPrint_WeeklyStatsOptions.frm |
| FRMPR˜42 FRX | 1,056 06-28-01 3:54p | frmPrint_WeeklyStatsOptions.frx |
| FRMPR˜44 FRX | 1,540 03-07-01 11:28a | frmPrintFundsDueOptions.frx |
| FRMPR˜46 FRM | 15,313 07-05-01 6:34p | frmPrintFundsDueOptions.frm |
| FRMPR˜48 FRM | 30,652 07-05-01 6:34p | frmPrintReferrals.frm |
| FRMPR˜50 FRX | 95,261 04-25-01 9:37a | frmPrintReferrals.frx |
| FRMPR˜52 FRX | 814 04-06-01 4:13p | frmPrint_TodaysUpdates_Options.frx |
| FRMPR˜54 FRX | 86,536 04-25-01 9:37a | frmPrintLSUPReport.frx |
| FRMPR˜56 FRX | 86,485 04-25-01 9:37a | frmPrintSR.frx |
| FRMPR˜58 FRM | 26,904 07-05-01 6:34p | frmPrint_TodaysUpdates.frm |
| FRMPR˜60 FRX | 863 03-07-01 11:28a | frmPrint_ActionToDo_Options.frx |
| FRMPR˜62 FRM | 14,906 07-05-01 6:34p | frmPrint_ActionToDo_Options.frm |
| FRMPR˜64 FRX | 3,214 05-11-01 2:52p | frmPrintInfoSheetOptions.frx |
| FRMPR˜66 FRM | 11,662 07-05-01 6:34p | frmPrint_TodaysUpdates_Options.frm |
| FRMPR˜68 FRM | 30,351 07-05-01 6:34p | frmPrintLSUPReport.frm |
| FRMPR˜70 FRM | 25,212 07-05-01 6:34p | frmPrintSR.frm |
| FRMPR˜72 FRM | 26,863 07-05-01 6:34p | frmPrintInfoSheetOptions.frm |
| FRMDU˜74 FRM | 10,398 07-05-01 6:34p | frmDUCOptions.frm |
| FRMDU˜76 FRX | 330 03-07-01 11:28a | frmDUCOptions.frx |
| FRMOV˜78 FRM | 25,403 07-05-01 6:34p | frmOverNoContactInterval.frm |
| FRMOV˜80 FRX | 86,485 04-25-01 9:37a | frmOverNoContactInterval.frx |
| FRMOV˜82 FRM | 7,482 07-05-01 6:34p | frmOverNoContactOptions.frm |
| FRMOV˜84 FRX | 1,934 06-11-01 9:40a | frmOverNoContactOptions.frx |
| FRMPR˜86 FRM | 33,621 07-05-01 6:34p | frmPrintCampTimeline.frm |
| FRMPR˜88 FRX | 70,327 04-25-01 9:37a | frmPrintCampTimeline.frx |
| FRMPR˜90 FRM | 4,181 07-05-01 6:34p | frmPrintCampTimeline_Options.frm |
| FRMPR˜92 FRX | 2,564 03-07-01 11:28a | frmPrintCampTimeline_Options.frx |
| FRMPR˜94 FRM | 26,550 07-05-01 6:34p | frmPrintDUC.frm |
| FRMPR˜96 FRX | 86,485 04-25-01 9:37a | frmPrintDUC.frx |
| FRMPR˜98 FRM | 38,648 07-05-01 6:34p | frmPrintFundsDue.frm |
| FRMP˜100 FRX | 86,485 04-25-01 9:37a | frmPrintFundsDue.frx |
| FRMR˜102 FRM | 55,004 07-05-01 6:34p | frmReportPrint.frm |
| FRMR˜104 FRX | 79,853 05-09-01 5:04p | frmReportPrint.frx |
| FRMS˜106 FRM | 23,717 03-07-01 11:28a | frmSBPrint.frm |
| FRMW˜108 FRM | 68,817 07-05-01 6:34p | frmWeeklyStats.frm |
| FRMW˜110 FRX | 79,917 06-28-01 3:56p | frmWeeklyStats.frx |
| MODPRINT BAS | 291,062 07-05-01 6:34p | modPrint.bas |
| MODV˜114 BAS | 16,754 07-05-01 6:34p | modVSChart.bas |
| | 55 file(s) 1,861,530 bytes | |

Directory of E:\Resources

| | | |
|---|---|---|
| . | <DIR> | 07-06-01 11:13a . |
| .. | <DIR> | 07-06-01 11:13a .. |
| AVI RC | 509 03-07-01 11:28a | avi.rc |
| BITMAPS RC | 621 03-07-01 11:28a | bitmaps.rc |
| RESOURCE RC | 23,716 03-07-01 11:28a | resource.rc |
| | 3 file(s) | 24,846 bytes |

Directory of E:\Scheduler

| | | |
|---|---|---|
| . | <DIR> | 07-06-01 11:13a . |
| .. | <DIR> | 07-06-01 11:13a .. |
| FRMSCH˜6 FRM | 33,111 07-05-01 6:34p | frmSchedObject.frm |
| FRMSCH˜8 FRX | 3,684 03-07-01 11:28a | frmSchedObject.frx |
| FRMSC˜10 FRM | 85,758 07-05-01 6:34p | frmScheduler.frm |
| FRMSC˜12 FRX | 10,974 05-11-01 3:41p | frmScheduler.frx |
| FRMTA˜14 FRM | 10,792 07-05-01 6:34p | frmTaskTypes.frm |
| FRMTA˜16 FRX | 1,090 03-07-01 11:28a | frmTaskTypes.frx |
| MODSC˜18 BAS | 71,611 07-05-01 6:34p | modScheduler.bas |
| | 7 file(s) | 217,020 bytes |

Directory of E:\SMFs

| | | |
|---|---|---|
| . | <DIR> | 07-06-01 11:13a . |
| .. | <DIR> | 07-06-01 11:13a .. |
| MODSMF BAS | 4,463 07-05-01 6:34p | modSMF.bas |
| | 1 file(s) | 4,463 bytes |

Directory of E:\SpeedButtons

| | | |
|---|---|---|
| . | <DIR> | 07-06-01 11:13a . |
| .. | <DIR> | 07-06-01 11:13a .. |
| CLSSBE˜6 CLS | 58,575 07-05-01 6:34p | clsSBEngine.cls |
| FRMADD˜8 FRM | 16,398 03-07-01 11:28a | frmAddSBCmd.frm |
| FRMAD˜10 FRM | 4,219 03-07-01 11:28a | frmAddSBGroup.frm |
| FRMDA˜12 FRM | 4,510 03-07-01 11:28a | frmDateOffset.frm |
| FRMMA˜14 FRM | 9,393 07-05-01 6:34p | frmMassSBRun.frm |
| FRMMA˜16 FRX | 1,902 03-07-01 11:28a | frmMassSBRun.frx |
| FRMSB˜18 FRM | 88,607 07-05-01 6:34p | frmSBEditing.frm |
| FRMSB˜20 FRX | 4,600 03-07-01 11:28a | frmSBEditing.frx |
| FRMSB˜22 FRM | 13,440 03-07-01 11:28a | frmSBGroupAssoc.frm |
| FRMSB˜24 FRM | 24,874 07-05-01 6:34p | frmSBSalesProfile.frm |
| FRMSB˜26 FRX | 330 03-07-01 11:28a | frmSBSalesProfile.frx |
| FRMSB˜28 FRM | 7,463 07-05-01 6:34p | frmSBStatusInfo.frm |
| FRMSB˜30 FRX | 1,090 03-07-01 11:28a | frmSBStatusInfo.frx |
| FRMSP˜32 FRM | 28,940 03-07-01 11:28a | frmSpeedButtons.frm |
| MODSP˜34 BAS | 110 03-07-01 11:28a | modSpeedButtons.bas |
| SBAPI BAS | 66,176 07-05-01 6:34p | SBAPI.bas |
| | 16 file(s) | 330,627 bytes |

Directory of E:\SR

| | | |
|---|---|---|
| . | <DIR> | 07-06-01 11:13a . |
| .. | <DIR> | 07-06-01 11:13a .. |
| CLSCGS˜6 CLS | 17,054 07-05-01 6:34p | clsCGSRCampArray.cls |
| CLSCHE˜8 CLS | 2,627 07-05-01 6:34p | clsCheckItem.cls |
| CLSSR˜10 CLS | 645 07-05-01 6:34p | clsSRCheckItem.cls |
| CLSSR˜12 CLS | 1,697 07-05-01 6:34p | clsSRCheckItemList.cls |
| CLSSR˜14 CLS | 29,142 07-05-01 6:34p | clsSRRefinePersonal.cls |
| CLSSR˜16 CLS | 39,139 07-05-01 6:34p | clsSRRefineProduct.cls |
| CLSSR˜18 CLS | 3,046 07-05-01 6:34p | clsSRTree.cls |
| CLSSU˜20 CLS | 3,944 07-05-01 6:34p | clsSubPage.cls |
| CLSWO˜22 CLS | 15,605 07-05-01 6:34p | clsWorksheet.cls |
| CLSWO˜24 CLS | 12,993 07-05-01 6:34p | clsWorksheetField.cls |
| CLSWO˜26 CLS | 1,962 07-05-01 6:34p | clsWorksheetFieldList.cls |
| CLSWO˜28 CLS | 1,551 07-05-01 6:34p | clsWorksheetList.cls |
| FRMSE˜30 FRM | 151,026 07-05-01 6:34p | frmSelectionRuleWizard.frm |
| FRMSE˜32 FRX | 155,867 07-05-01 5:15p | frmSelectionRuleWizard.frx |
| FRMSE˜34 LOG | 853 04-23-01 5:48p | frmSelRuleRefinement.log |
| FRMSE˜36 FRM | 113,229 07-05-01 6:34p | frmSelRuleRefinement.frm |
| FRMSE˜38 FRX | 9,239 07-02-01 4:51p | frmSelRuleRefinement.frx |
| FRMSH˜40 FRM | 10,351 07-05-01 6:34p | frmShowMatches.frm |
| FRMSH˜42 FRX | 3,156 03-07-01 11:28a | frmShowMatches.frx |
| FRMSR˜44 FRM | 3,546 07-05-01 6:34p | frmSRBoolean.frm |
| FRMSR˜46 FRX | 1,090 03-07-01 11:28a | frmSRBoolean.frx |
| FRMSR˜48 FRM | 30,186 07-05-01 6:34p | frmSRDateTime.frm |
| FRMSR˜50 FRX | 1,247 03-07-01 11:28a | frmSRDateTime.frx |
| FRMSR˜52 FRM | 18,502 07-05-01 6:34p | frmSRNumber.frm |
| FRMSR˜54 FRX | 1,123 03-07-01 11:28a | frmSRNumber.frx |
| FRMSR˜56 FRM | 87,173 05-11-01 5:42p | frmSRRefinementProduct.frm |
| FRMSR˜58 FRX | 3,764 05-08-01 9:05a | frmSRRefinementProduct.frx |
| FRMSR˜60 FRM | 16,729 07-05-01 6:34p | frmSRText.frm |
| FRMSR˜62 FRX | 1,090 03-07-01 11:28a | frmSRText.frx |
| FRMSR˜64 FRM | 12,144 07-05-01 6:34p | frmSRTTable.frm |
| FRMSR˜66 FRX | 1,090 03-07-01 11:28a | frmSRTTable.frx |
| MODSR˜68 BAS | 7,004 07-05-01 6:34p | modSRRefine.bas |
| PAGE CLS | 8,834 07-05-01 6:34p | Page.cls |
| SRPAG˜72 CLS | 1,323 07-05-01 6:34p | SRPageItem.cls |
| | 34 file(s) | 767,971 bytes |

Directory of E:\System

| | | |
|---|---|---|
| . | <DIR> | 07-06-01 11:13a . |
| .. | <DIR> | 07-06-01 11:13a .. |
| CANIMATE CLS | 9,254 07-05-01 6:34p | CAnimate.cls |
| CAVIHE˜8 CLS | 3,463 07-05-01 6:34p | cAVIHelper.cls |
| CLSPA˜10 CLS | 390 07-05-01 6:34p | clsParamData1.cls |
| CLSPA˜12 CLS | 468 07-05-01 6:34p | clsParamDataNumStr.cls |
| CLSPA˜14 CLS | 486 07-05-01 6:34p | clsParamString.cls |
| CLSPA˜16 CLS | 571 07-05-01 6:34p | clsParamStrings.cls |
| FRMAVI FRM | 3,295 07-05-01 6:34p | frmAVI.frm |
| FRMAVI FRX | 12 03-07-01 11:28a | frmAVI.frx |
| FRMCH˜22 FRM | 4,947 07-05-01 6:34p | frmChooseDirectory.frm |
| FRMCH˜24 FRX | 1,090 03-07-01 11:28a | frmChooseDirectory.frx |
| FRMCH˜26 FRM | 11,094 07-05-01 6:34p | frmChooseRR.frm |
| FRMCH˜28 FRX | 1,623 04-23-01 4:S2p | frmChooseRR.frx |
| FRMDB˜30 FRM | 6,006 07-05-01 6:34p | frmDBCompact.frm |
| FRMDB˜32 FRX | 1,660 03-07-01 11:28a | frmDBCompact.frx |
| FRMDE˜34 FRM | 4,458 07-05-01 6:34p | frmDebugConsole.frm |
| FRMDE˜36 FRX | 1,090 03-07-01 11:28a | frmDebugConsole.frx |
| FRMGR˜38 FRM | 1,294 03-07-01 11:28a | frmGraphicPreview.frm |
| FRMGR˜40 FRX | 1,418 03-07-01 11:28a | frmGraphicPreviewModal.frx |
| FRMGR˜42 FRM | 1,382 07-05-01 6:34p | frmGraphicPreviewModal.frm |
| FRMLI˜44 FRM | 7,799 07-05-01 6:34p | frmLicenceKickOff.frm |
| FRMLI˜46 FRX | 1,741 05-09-01 5:36p | frmLicenceKickOff.frx |
| FRMOP˜48 FRM | 103,672 07-05-01 6:34p | frmOptions.frm |
| FRMOP˜50 FRX | 2,772 03-28-01 4:25p | frmOptions.frx |
| FRMST˜52 FRM | 4,630 07-05-01 6:34p | frmStartupMessage.frm |
| FRMST˜54 FRX | 3,998 03-07-01 11:28a | frmStartupMessage.frx |
| MODPR˜56 BAS | 2,542 07-05-01 6:34p | modPreview.bas |
| | 26 file(s) | 181,155 bytes |

Directory of E:\TextExpWiz21

| | | |
|---|---|---|
| . | <DIR> | 07-06-01 11:13a . |
| .. | <DIR> | 07-06-01 11:13a .. |
| CLSADD˜6 CLS | 14,019 03-07-01 11:28a | clsAddressBundle.cls |
| CLSTEX˜8 CLS | 668 03-07-01 11:28a | clsTextExpWiz.cls |
| DBCONST BAS | 231,201 06-18-01 4:13p | DBConst.bas |
| DBTAB˜12 BAS | 53,049 03-07-01 11:28a | DBTableConst.bas |
| FRMTE˜14 FRM | 82,101 06-26-01 9:22a | frmTextExpWiz.frm |
| FRMTE˜16 FRX | 146,621 05-01-01 5:19p | frmTextExpWiz.frx |
| FRMTV˜18 FRM | 8,445 03-07-01 11:28a | frmTVWPopup.frm |
| FRMTV˜20 FRX | 4,764 03-07-01 11:28a | frmTVWPopup.frx |
| MODMAIN BAS | 2,694 03-07-01 11:28a | modMain.bas |
| MODTI˜24 BAS | 40,610 05-30-01 6:00p | modTitleLogic.bas |
| MODTO˜26 BAS | 25,864 06-26-01 9:22a | modToolbox.bas |
| REGISTRY BAS | 25,222 05-30-01 6:00p | Registry.bas |
| TEXTE˜30 DLL | 393,216 03-30-01 5:28p | TextExpWiz.dll |
| TEXTE˜32 EXP | 990 05-30-01 6:00p | TextExpWiz.exp |
| TEXTE˜34 LIB | 2,646 05-30-01 6:00p | TextExpWiz.lib |
| TEXTE˜36 VBP | 1,731 06-26-01 9:22a | TextExpWiz.vbp |
| | 16 file(s) 1,033,841 bytes | |

Directory of E:\TextImpWiz21

| | | |
|---|---|---|
| . | <DIR> | 07-06-01 11:13a . |
| .. | <DIR> | 07-06-01 11:13a .. |
| CLSCGT˜6 CLS | 60,012 03-07-01 11:28a | clsCGTXFR.cls |
| CLSFIE˜8 CLS | 505 03-07-01 11:28a | clsFieldWidth.cls |
| CLSPA˜10 CLS | 388 03-07-01 11:28a | clsParamData1.cls |
| CLSTE˜12 CLS | 474 03-07-01 11:28a | clsTextImpWiz.cls |
| DBCONST BAS | 231,201 06-18-01 4:13p | DBConst.bas |
| DBTAB˜16 BAS | 52,346 03-07-01 11:28a | DBTableConst.BAS |
| FRMED˜18 FRM | 3,865 03-07-01 11:28a | frmEditField.frm |
| FRMED˜20 FRX | 1,418 05-01-01 5:19p | frmEditField.frx |
| FRMTE˜22 FRM | 125,433 06-26-01 9:22a | frmTextImpWiz.frm |
| FRMTE˜24 FRX | 4,546 06-18-01 11:43a | frmTextImpWiz.frx |
| MODMAIN BAS | 1,365 03-07-01 11:28a | modMain.bas |
| MODTI˜28 BAS | 38,916 05-30-01 6:00p | modTitleLogic.bas |
| MODTO˜30 BAS | 16,988 06-26-01 9:22a | modToolbox.bas |
| REGISTRY BAS | 25,284 06-04-01 1:46p | Registry.bas |
| TEXTI˜34 DLL | 360,448 06-26-01 9:22a | TextImpWiz.dll |
| TEXTI˜36 EXP | 1,009 06-18-01 11:43a | TextImpWiz.exp |
| TEXTI˜38 LIB | 2,646 06-18-01 11:43a | TextImpWiz.lib |
| TEXTI˜40 VBP | 1,935 06-26-01 9:22a | TextImpWiz.vbp |
| | 18 file(s) | 928,779 bytes |

Directory of E:\Triggers

| | | |
|---|---|---|
| . | <DIR> | 07-06-01 11:13a . |
| .. | <DIR> | 07-06-01 11:13a .. |
| FRMTRI˜6 FRM | 9,860 07-05-01 6:34p | frmTriggerDates.frm |
| FRMTRI˜8 FRX | 40 04-20-01 4:38p | frmTriggerDates.frx |
| MODTR˜10 BAS | 12,229 07-05-01 6:34p | modTrigger.bas |
| | 3 file(s) | 22,129 bytes |

Directory of E:\UserMgmt

| | | |
|---|---|---|
| . | <DIR> | 07-06-01 11:13a . |
| .. | <DIR> | 07-06-01 11:13a .. |
| FRMCHA˜6 FRM | 6,929 07-05-01 6:34p | frmChangePassword.frm |
| FRMCHA˜8 FRX | 330 03-07-01 11:28a | frmChangePassword.frx |
| FRMNE˜10 FRM | 12,636 07-05-01 6:34p | frmNewStaffGroup.frm |
| FRMNE˜12 FRX | 330 03-07-01 11:28a | frmNewStaffGroup.frx |
| FRMNE˜14 FRM | 43,965 07-05-01 6:34p | frmNewSysOwnerWiz.frm |
| FRMNE˜16 FRX | 144,486 03-07-01 11:28a | frmNewSysOwnerWiz.frx |
| FRMRR˜18 FRM | 4,275 07-05-01 6:34p | frmRRAccess.frm |
| FRMRR˜20 FRX | 639 03-07-01 11:28a | frmRRAccess.frx |
| FRMUS˜22 FRM | 99,078 07-05-01 6:34p | frmUserMgmt_REV2.frm |
| FRMUS˜24 FRX | 1,349 06-13-01 4:31p | frmUserMgmt_REV2.frx |
| | 10 file(s) | 314,017 bytes |

Directory of E:\WordTemplates

| | | |
|---|---|---|
| . | <DIR> | 07-06-01 11:13a . |
| .. | <DIR> | 07-06-01 11:13a .. |
| B2-LTRS DOT | 836,608 07-05-01 5:15p | B2-ltrs.dot |
| B2-STYLS DOT | 49,152 05-07-01 6:14p | B2-styls.dot |
| | 2 file(s) | 885,760 bytes |

Directory of E:\Worksheets

| | | |
|---|---|---|
| . | <DIR> | 07-06-01 11:13a . |
| .. | <DIR> | 07-06-01 11:13a .. |
| CTLWOR˜6 CTL | 88,741 07-05-01 6:34p | ctlWorksheet.ctl |
| CTLWOR˜8 CTX | 1,028 03-07-01 11:28a | ctlWorksheet.ctx |
| FRMED˜10 FRM | 16,438 07-05-01 6:34p | frmEditWorksheet.frm |
| FRMED˜12 FRX | 1,418 05-16-01 8:46a | frmEditWorksheet.frx |
| FRMEX˜14 FRM | 5,881 07-05-01 6:34p | frmExistingField.frm |
| FRMEX˜16 FRX | 330 03-07-01 11:28a | frmExistingField.frx |
| FRMOP˜18 FRM | 6,005 07-05-01 6:34p | frmOpenWorksheet.frm |
| FRMOP˜20 FRX | 1,418 03-07-01 11:28a | frmOpenWorksheet.frx |
| FRMSA˜22 FRM | 8,499 07-05-01 6:34p | frmSaveWorksheet.frm |
| FRMSA˜24 FRX | 3,156 03-07-01 11:28a | frmSaveWorksheet.frx |
| FRMWO˜26 FRM | 29,783 07-05-01 6:34p | frmWorksheetMaker.frm |
| FRMWO˜28 FRX | 2,966 03-07-01 11:28a | frmWorksheetMaker.frx |
| | 12 file(s) | 165,663 bytes |

Directory of E:\Workstation Licenses Utility

| | | |
|---|---|---|
| . | <DIR> | 07-06-01 11:13a . |
| .. | <DIR> | 07-06-01 11:13a .. |
| CLSENC˜6 CLS | 23,936 07-05-01 6:34p | clsEncrypt.cls |
| FRMENC˜8 FRM | 6,509 03-07-01 11:28a | frmEncrypt.frm |
| FRMES˜10 FRM | 10,398 07-05-01 6:34p | frmESPUpdate.frm |
| FRMES˜12 FRX | 1,405 03-07-01 11:28a | frmESPUpdate.frx |
| FRMMAIN FRM | 12,576 03-07-01 11:28a | frmMain.frm |
| README TXT | 169 03-07-01 11:28a | Readme.txt |
| WORKS˜18 VBP | 992 03-07-01 11:28a | WorkstationLicenses.vbp |
| | 7 file(s) | 55,985 bytes |

Total files listed:

| | |
|---|---|
| 960 file(s) 111,373,563 bytes | |
| 171 dir(s) | 0 bytes free |

What is claimed and desired to be secured by United States Letters Patent is:

1. In a system including a database containing data corresponding to one or more contact groups, a contact management system for assisting one or more users to implement contact management actions regarding a contact group, wherein each of the one or more users have one of multiple roles, the contact management system comprising:
a data interface that allows contact management actions to be communicated among the one or more users, and that allows contact management actions to be communicated between the one or more users and the contact group, said data interface comprising:
a scheduler module for scheduling contact management actions with respect to the contact group, including communicating said scheduled contact management actions to the one or more users, and wherein the one or more users are allowed to implement contact management actions therefrom;
an info sheet module for providing basic data regarding the contact group and allowing the one or more users to implement contact management actions therefrom;
a data maintenance module for providing detailed data regarding the contact group and allowing the one or more users to implement contact management actions therefrom; and
a search module for allowing the one or more users to search for the contact group and allowing the one or more users to implement contact management actions therefrom.

2. The contact management system of claim 1, wherein said scheduler module comprises one or more of a calendar and a planner.

3. The contact management system of claim 1, wherein said info sheet module comprises one or more of identifying information, history of contact management actions, campaigns, worksheets, opportunities, keywords, important dates, accounts, and sales profile information pertaining to the contact group.

4. The contact management system of claim 3, wherein said history of contact management actions comprises one or more of a hierarchical history view for displaying contact management actions based on objectives; and a list view, wherein the list view is sequenced by a characteristic identified by the one or more users.

5. The contact management system of claim 1, wherein said data maintenance module comprises one or more of identifying information, status, last contact date, last message date, channel of communication preferred by the contact group, and financial information pertaining to the contact group.

6. The contact management system of claim 5, wherein said data maintenance module comprises a view of said detailed data regarding the contact group based on one or more of individuals, mailing addresses, phone numbers, e-mail addresses, important dates, accounts, and address modules pertaining to the contact group.

7. The contact management system of claim 1, wherein said search module comprises one or more of hierarchy search tools, alphabet search tools, and status search tools.

8. The contact management system of claim 1, further comprising one or more of:
an address module for selectively identifying a preferred address for a contact group connecting it with one or more appropriate individuals in said contact group, and storing an appropriate form-of-address for the one or more appropriate individuals in the address module, said address module being suitable for use in enabling the one or more users to send a message to said preferred address;
a action button module for assisting the one or more users to automatically initiate contact management actions;
a worksheet module comprising a worksheet, said worksheet comprising data imported from the database and data fields defined by the one or more users; and
an messaging module for scheduling and sending correspondence from the one or more users to the contact group through a predetermined channel of communication, said predetermined channel of communication comprising a default channel of communication selected by the one or more users.

9. In a system including a database containing data corresponding to one or more contact groups, a method for contact management wherein one or more users implement contact management actions with respect to a contact group, the method comprising the steps for:
the one or more users communicating with the contact group through a mode of communication to achieve a predetermined purpose;
implementing contact management actions with respect to the contact group using a data interface during said communication, said data interface comprising:
a scheduler module for scheduling contact management actions with respect to the contact group, including selectively communicating said scheduled contact management actions to the one or more users, and wherein the one or more users are allowed to implement contact management actions therefrom;
an info sheet module for providing basic data regarding the contact group and allowing the one or more users to implement contact management actions therefrom;
a data maintenance module for providing detailed data regarding the contact group and allowing the one or more users to implement contact management actions therefrom; and
a search module for allowing the one or more users to search for a contact group and allowing the one or more users to implement contact management actions therefrom; and
determining appropriate responses regarding said communication with the contact group.

10. The method of claim 9, wherein said mode of communication comprises one or more of telephone, e-mail, mail, and fax.

11. The method of claim 9, wherein the step for determining appropriate responses regarding said communication with the contact group further comprises automatically initiating contact management actions using a action button module comprising the steps for:
determining an objective, said objective being determined from said communication with the contact group;
scheduling and sending one or more messages to the contact group in order to achieve said objective;
scheduling contact management actions, wherein the contact management actions are communicated to the appropriate user selected from the one or more users in order to achieve said objective, wherein the appropriate user comprises one of salesperson, a sales assistant, a service assistant, and a computer operator;
adding one or more notes that indicate the contact management actions that have already occurred in reference to said objective; and
updating the database such that the data for the contact group reflects the contact management actions that have been implemented.

12. The method of claim 11, wherein the step for automatically initiating contact management actions comprises the step for prompting the one or more users to input information regarding said communication.

13. The method of claim 11, wherein the step for automatically initiating contact management actions comprises the step for automatically completing the contact management actions.

14. The method of claim 9, further comprising one or more of the steps for:
selectively identifying a preferred address in the contact group and sending a message to said preferred address;
defining a worksheet, importing data from the database into said worksheet, and defining new data fields in said worksheet;
sending correspondence from the one or more users to the contact group through a predetermined channel of communication;
determining a form-of-address for each individual in the contact group;
providing a context-sensitive history;
creating one or more action buttons, each action button defining a series of contact management actions; and
assigning contact management to some of the one or more users.

15. The method of claim 9, further comprising the step for implementing campaign management actions on the one or more contact groups, wherein the step for implementing campaign management actions on the one or more contact groups comprises the steps for:
creating a campaign from a campaign master, including defining one or more campaign tracks according to predetermined criteria;
executing said campaign by determining on which of the one or more contact groups the campaign will be implemented and by implementing a series of campaign management actions;
evaluating the one or more contact groups during said execution of said campaign, including determining whether the one or more contact groups qualifies under said predetermined criteria of one or more campaign tracks; and
automatically initiating a response based on said evaluation.

16. In a system, including a database that maintains data for one or more contact groups, wherein one or more users communicate with and implement contact management actions regarding a contact group, and wherein such communication requires an appropriate response, a method for initiating the appropriate response comprising the steps for:
determining an objective, said objective being determined from the communication with the contact group;
sending one or more messages to the contact group in order to achieve said objective;
scheduling contact management actions, wherein the contact management actions are communicated to the appropriate user selected from the one or more users in order to achieve said objective, wherein the appropriate user is one of a salesperson, a sales assistant, a service assistant, and a computer operator;
adding one or more notes that indicate the contact management actions that have already occurred in reference to said objective; and
updating the database such that the data for the contact group reflects the contact management actions that have been implemented.

17. The system of claim 16, further comprising the step for assigning a new keyword from a previous keyword such that said new keyword reflects the contact management actions that have been implemented.

18. The method of claim 16, further comprising the step for prompting the one or more users to input information regarding the communication.

19. The method of claim 16, further comprising the step for automatically completing the appropriate response to the communication.

20. In a system including a database containing data corresponding to one or more contact groups, a management system suitable for use for implementing management actions, wherein the management actions include contact management actions and campaign management actions, the management system comprising:
a data interface for allowing one or more users to implement management actions therefrom, said data interface comprising a scheduler module for scheduling management actions with respect to a contact group; an info sheet module for providing basic data regarding the contact group; a data maintenance module for providing detailed data regarding the contact group; a search module for allowing the one or more users to search for the contact group; and one or more of:
an action button module for initiating management actions that are completed by the one or more users;
a worksheet module comprising a worksheet, said worksheet comprising data imported from the database, and data fields defined by the one or more user;
a messaging module comprising a predetermined channel of communication; and
an address module comprising a preferred address corresponding to one or more individuals in the contact group.

21. The management system of claim 20, wherein the management actions include one or more of setting objectives, sending messages, making notes, scheduling contact management actions, updating the database, and resetting keywords.

22. The management system of claim 20, wherein said action button module requires input from the one or more users.

23. The management system of claim 20, wherein said action button module ensures that the management actions are performed.

24. The management system of claim 20, wherein said predetermined channel of communication defines a default channel of communication.

25. The management system of claim 20, wherein said preferred address comprises one or more of a mailing address, a telephone number, a fax number, and an e-mail address.

26. In a system including a database containing data corresponding to a group of contact groups, a method for campaign management for allowing one or more users to implement campaign management actions regarding a group of contact groups, the method comprising the steps for:
creating a campaign, including defining one or more campaign tracks according to predetermined criteria;
executing the campaign, wherein said execution requires implementing a series of campaign management actions;
evaluating a group of contact groups during said execution of said campaign, including determining whether a group of contact groups qualifies under said predetermined criteria of said one or more campaign tracks; and
automatically initiating a response based on said evaluation.

27. The method of claim 26, wherein the step for automatically initiating a response further comprises the step for sorting the group of contact groups into said one or more campaign tracks.

28. The method of claim 26, wherein the step for executing the campaign further comprises selecting a campaign master.

29. The method of claim 26, wherein the step for executing the campaign further comprises the step for defining a campaign instance.

30. The method of claim 26, wherein the step for executing the campaign further comprises the step for viewing said campaign according to campaign management actions.

31. The method of claim 26, wherein the step for executing the campaign further comprises the step for viewing said campaign according to a group of contact groups qualifying under said predetermined criteria of said one or more campaign tracks.

32. The method of claim 26, wherein the step for executing the campaign further comprises the step for implementing contact management actions using a data interface and facilitating communication between the one or more users and the group of contact groups, said data interface comprising:
a scheduler module for scheduling contact management actions with respect to the group of contact groups, including communicating said scheduled contact management actions to the appropriate one or more users;
an info sheet module for providing basic data regarding the group of contact groups;
a data maintenance module for providing detailed data regarding the group of contact groups; and
a search module for allowing the one or more users to search for the group of contact groups.

33. The method of claim 26, further comprising the step for automatically initiating an appropriate response to a communication between one or more users and a group of contact groups comprising the steps for:
determining an objective, said objective being determined from said communication with the group of contact groups;
sending one or more messages to the group of contact groups in order to achieve said objective;
scheduling contact management actions, wherein said contact management actions are communicated to the appropriate user selected from the one or more users in order to achieve said objective, wherein the appropriate user is one of a salesperson, a sales assistant, a service assistant, and a computer operator;
adding one or more notes that indicate said contact management actions that have already occurred in reference to said objective; and
updating the database such that the data for the group of contact groups reflects said communication.

34. The method of claim 26, further comprising one or more of the steps for:
selectively identifying a preferred address for the group of contact groups and sending a message to said preferred address;
defining a worksheet, importing data from the database into said worksheet, and defining new data fields in said worksheet; and
sending correspondence from one or more users to the group of contact groups through a predetermined channel of communication.

35. In a system including a database containing data corresponding to a collection of contact groups, a campaign management system for assisting one or more users to implement campaign management actions regarding the collection of contact groups, the campaign management system comprising:
a campaign management data interface for facilitating communication between the one or more users, and for facilitating communication between the one or more users and the collection of contact groups, said campaign management data interface comprising:
a campaign editor module for defining a campaign therefrom and allowing the one or more users to implement campaign management actions therefrom regarding the collection of contact groups;
a campaign wizard module for scheduling said campaign therefrom and allowing the one or more users to implement campaign management actions therefrom regarding the collection of contact groups; and
a campaign manager module for executing said campaign therefrom and allowing the one or more users to implement campaign management actions therefrom regarding the collection of contact groups.

36. The campaign management system of claim 35, wherein said campaign comprises one or more of campaign tracks, campaign management actions, campaign messages, campaign scripts, and campaign checklists.

37. The campaign management system of claim 35, wherein said campaign tracks further comprises one or more categories defined by predetermined criteria.

38. The campaign management system of claim 35, wherein said campaign editor module further comprises one or more of a campaign master, a campaign version, and a campaign overview seminar.

39. The campaign management system of claim 35, wherein said campaign wizard module further comprises a campaign instance.

40. The campaign management system of claim 35, wherein said campaign manager module further comprises a campaign management action view.

41. The campaign management system of claim 35, wherein said campaign manager module further comprises a contact group view.

42. The campaign management system of claim 35, further comprising a contact management data interface for allowing the one or more users to implement contact management actions regarding the collection of contact groups therefrom, said contact management data interface comprising:
a scheduler module for scheduling contact management actions with respect to the collection of contact groups, including communicating said scheduled contact management actions to the one or more users;,
an info sheet module for providing basic data regarding the collection of contact groups;
a data maintenance module for providing detailed data regarding the collection of contact groups; and
a search module for allowing the one or more users to search for the collection of contact groups.

43. The campaign management system of claim 35, further comprising one or more of:
an address module for selectively identifying a preferred address for each contact group in the group of contact groups, said address module being suitable for use in enabling the one or more users to send a message to said preferred address;
an action button module for assisting the one or more users to automatically initiate management actions on one or more of the collection of contact groups;
a worksheet module comprising a worksheet, said worksheet comprising data imported from said database and data fields defined by the one or more users; and
a messaging module for sending correspondence from the one or more users to the group of contact groups through a predetermined channel of communication.
